(19) United States
(12) Patent Application Publication
(10) Pub. No.: US 2010/0185949 A1
(43) Pub. Date: Jul. 22, 2010

(54) Method for using gesture objects for computer control

(76) Inventor: Denny Jaeger, Oakland, CA (US)

Correspondence Address: ZIMMERMAN & CRONEN, LLP, 1330 BROADWAY, SUITE 710, OAKLAND, CA, 94612-2506, US

(21) Appl. No.: 12/653,056

(22) Filed: Dec. 8, 2009

Related U.S. Application Data
(60) Provisional application No. 61/201,386, filed on Dec. 9, 2008.

(51) Int. Cl. G06F 3/01; G06F 3/033

(52) U.S. Cl. 715/730; 715/863

(57) ABSTRACT

A computer control environment introduces the Gesture environment, in which a computer user may enter or recall graphic objects on a computer display screen, and draw arrows and gesture objects to control the computer and produce desired results. The elements that make up the gesture computing environment, include a gesture input by a user that is recognized by software and interpreted to command that some action is to be performed by the computer. The gesture environment includes gesture action objects, which convey an action to some recipient object, gesture context objects which set conditions for the invocation of an action from a gesture object, and gesture programming lines that are drawn to or between the gesture action objects and gesture context objects to establish interactions therebetween.

### CROSS-REFERENCE TO RELATED APPLICATIONS

This application claims the priority date benefit of Provisional Application No. 61/201,386, filed Dec. 9, 2008.

### FEDERALLY SPONSORED RESEARCH

Not applicable.

### SEQUENCE LISTING, ETC ON CD

Not applicable.

### BACKGROUND OF THE INVENTION

1. Field of the Invention

The invention relates generally to computer operating environments, and more particularly to a method for performing operations in a computer operating environment.

2. Description of Related Art

A newly introduced computer operating arrangement known as Blackspace™ has been created to enable computer users to direct a computer to perform according to graphic inputs made by a computer user. One aspect of Blackspace is generally described as a method for creating user-defined computer operations that involve drawing an arrow in response to user input and associating at least one graphic to the arrow to designate a transaction for the arrow. The transaction is designated for the arrow after analyzing the graphic object and the arrow to determine if the transaction is valid for the arrow. The following patents describe this system generally: U.S. Pat. No. 6,883,145, issued Apr. 19, 2005, titled Arrow Logic System for Creating and Operating Control Systems; U.S. Pat. No. 7,240,300, issued Jul. 3, 2007, titled Method for Creating User-Defined Computer Operations Using Arrows. These patents are incorporated herein by reference in their entireties. The present invention comprises improvements and applications of these system concepts.

### BRIEF SUMMARY OF THE INVENTION

The present invention generally comprises a computer control environment that builds on the Blackspace™ software system to provide further functionality and flexibility in directing a computer. This is the introduction and application of the Gesture environment, in which a computer user may enter or recall graphic objects on a computer display screen, and draw arrows and gesture objects to control the computer and produce desired results.

This invention defines the elements that make up the gesture computing environment, including a gesture input by a user to a computer that is recognized by software and interpreted to command that some action is to be performed by the computer. The gesture environment includes gesture action objects, which convey an action to some recipient object, gesture context objects which set conditions for the invocation of an action from a gesture object, and gesture programming lines that are drawn to or between the gesture action objects and gesture context objects to establish interactions therebetween.

One aspect of the invention describes the software method steps taken by the system software to carry out the recognition and interactions of gesture objects, contexts, and actions. The description below provides extensive practical applications of the gesture environment to everyday computer user functions and actions.

### BRIEF DESCRIPTION OF THE DRAWING

FIGS. 1-12 comprise block diagram flow charts depicting the software method steps for recognizing and managing the interactions of gesture objects, contexts, and actions.

FIGS. 13-16 illustrate examples of gesture object strokes, gesture context strokes, and action strokes.

FIG. 17 illustrates the use of gesture actions to invoke a text wrap action with respect to a picture and a text object.

FIG. 18 illustrates the use of the caret gesture object programmed in FIG. 14 to turn on a ruler and vertical margin displays in a VDACC text object, and FIG. 19 is the desired result.

FIG. 20 illustrates the use of the triangle gesture object programmed in FIG. 17 to carry out a text wrap function, and FIG. 21 displays the desired result.

FIGS. 22 and 23 depict menus for modifying the triangle gesture object of FIG. 17.

FIGS. 24-27 illustrate techniques for modifying the action that is programmed to a gesture action object.

FIGS. 28-32, 33A, 33B, 34-37 illustrate software recognition of user drawn line styles, and user modification of line styles.

FIGS. 38 and 39 illustrate user-drawn figures formed by complex gesture lines.

FIGS. 40-43 are a sequence of views depicting a method for creating a line style by incorporating hand-drawn graphic elements.

FIGS. 44-46 illustrate a vertical margin line formed of graphic elements, some being active assigned elements, and possible uses therefore.

FIG. 47 illustrates one example of a personal tools VDACC displaying a line style tools selection graphic.

FIG. 48 illustrates the use of a gesture line that invokes a search function to search a text block.

FIG. 49 illustrates an example of multiple assignments being made to various portions of a single text object using gesture methodology.

FIG. 50 illustrates a multi-function segmented gesture line.

FIGS. 51-53 illustrates the use of a gesture arrow to create a line style, and the resulting line style in expanded and contracted displays.

FIGS. 54-57 illustrate various methods for programming the line style of FIGS. 51-53 to become a segmented gesture object line.

FIGS. 58-61 illustrate various methods for applying the segmented gesture line of FIGS. 54-57 to practical computer tasks.

FIG. 62 illustrates a drag-and-drop technique used to duplicate and move log entries to a new VDACC.

FIG. 63 illustrates the use of a multi-segment gesture line, as shown in FIGS. 58-61, applied to the VDACC constructed in the method depicted in FIG. 62.

FIG. 64 illustrates the use of non-contiguous gesture lines to select items from a file list in a VDACC.

FIG. 65 depicts the drawing of a multi-segment gesture line and various techniques for displaying the line in various lengths and circumstances.

FIG. 66 illustrates the use of a programming arrow to assign an address list to a data base gesture line.

FIG. 67 illustrates a display technique for portraying multi-segment line styles in small radius curves using a segment replacement routine.

FIGS. 68-70 illustrate three different methods for removing data from a data list.

FIGS. 71-73 illustrate three different methods for adding data to a data list.

FIGS. 74-77 illustrate various methods for constructing and using folder objects for storage and transfer of data.

FIGS. 78-90 illustrate a slide show segmented gesture line, and various methods for constructing and applying the gesture line in different situations.

FIG. 91 illustrates a method for modifying the digital media content of a multi-segment gesture line using the media content of another multi-segment gesture line.

FIG. 92 illustrates a Personal Tools VDACC that displays a variety of line styles.

FIGS. 93-95 illustrate different methods for programming a line style as a gesture line that invokes a low pass audio filter.

FIGS. 96-98 illustrate a multi-segment gesture line that is comprised of active control knob segments, and various methods for employing that gesture line.

FIGS. 99-102 illustrate different line styles that have active fader or button controls as segments in a multi-segment gesture line.

FIGS. 103-106 depict various methods for assigning actions to line styles that have active fader or button controls as segments in a multi-segment gesture line.

FIGS. 107-112 illustrate further methods for assigning actions to active audio segments of a multi-segment gesture line.

FIGS. 113-115 illustrates a simple gesture line being programmed to invoke three different actions according to three different contexts.

FIG. 116 illustrates one method for using the gesture line programmed in FIGS. 113-115.

FIGS. 117-125 illustrate various techniques for aligning and making assignments between two multi-segment gesture lines.

FIG. 126 illustrates the use of manual flicking gesture to scroll through the length of a multi-segment gesture line, such as to view segments that are not currently displayed at the ends of the line.

FIG. 127 illustrates the use of a condition of the action of the object to define an action for a gesture object.

FIG. 128 depicts two methods for programming a selector (delay) function into the action of a gesture line.

FIGS. 129 and 130 illustrate methods for using a single contiguous line drawn to program a gesture object.

FIGS. 131 and 132 illustrates methods for modifying a gesture arrow to add context limitations to the action.

FIG. 133 illustrates a multi-segment gesture line and a method for displaying a clipped portion of the line.

FIG. 134 illustrates one method for adding a segment to a multi-segment gesture line, and the resulting augmented line.

FIGS. 135-137 illustrate various methods for using gesture methods and objects to work on a software code listing, and FIG. 138 is a functional block diagram of a computer system capable of providing the computer environment described herein.

### DETAILED DESCRIPTION OF THE INVENTION

The present invention generally comprises a method for controlling computer actions, particularly in a Blackspace computer environment. The following terms are relevant to the description below.

Definitions:

Gesture: a gesture is a graphic input that can be or equal or include a motion and/or define a shape by which the user indicates that some action is to be performed by one or more objects. Dragging an object can be a gesture.

Programming Gesture: there are four types of graphic inputs used for programming: context objects, action objects, gesture graphics, and selectors.

Drawing Gesture: a drawing gesture is a recognized symbol and/or line shape.

Movement Gesture: a movement gesture is the path through which an object is dragged.

Motion Gesture: a motion gesture is the path of a user input device (e.g., a hand movement or float of a mouse or pen device).

Voice Gesture: a voice gesture is one or more spoken commands processed by a speech recognition module so that, e.g., speaking a word or phrase invokes an action.

Rhythm Gesture: a rhythm gesture is a sequence of events: a mouse click, hand motion, audio peaks, or the like. An example of a rhythm gesture is tapping on a mobile phone with a specific rhythm pattern wherein recognition of the pattern has been programmed to cause some action to occur. The rhythm could be recognizable beat patterns from a piece of music.

Gesture Object: any object created by a user or in software, preferably an object that the user can easily remember. The characteristics of a Gesture Object (shape, color, etc.) may be used to provide additional hints as to the required Action. Gesture Objects may be drawn to impinge on one or more Context Objects to cause one or more actions that are defined by one or more Action Objects when the Gesture Object was programmed. The Gesture Object is programmed with the following:

1) Gesture Context Object(s)

2) Gesture Object

3) Gesture Action Object

4) Selector

Gesture Context Objects: the Gesture Context Objects are used to define a set of rules that identify when a Gesture Command should be applied and, equally importantly, when the Command should not be applied. Gesture Context Objects can also be the collection of objects selected by the gesture.

Gesture Action Object: a Gesture Action Object is an object that is used to determine the Action for the Gesture command. The Gesture Action Object is related to at least one of the Gesture Context Objects. When the action is applied, it is applied to the matching object in the Gesture Context Objects. For example, when setting the properties of the rulers belonging to a VDACC, the Rulers are the Gesture Action Objects. The Ruler properties will be applied to a VDACC by the Gesture Object. The state of the properties of the Gesture Action Objects is saved as the resulting action. If the Gesture Programming was initiated by a user command (such as a voice command to ‘set margin’), the Gesture Action Object is not required.

Gesture Programming Line: This is the one or more drawn or designated lines that are used to create (program) a Gesture Object. If an arrow is used as the programming line it is called the “Gesture Programming Arrow.” In the case where two or more programming lines are drawn to comprise a Gesture Command, these individual lines can be referred to as “Gesture Strokes,” “Programming strokes” “Gesture Arrow Strokes” or the like. These strokes could include the “context stroke,” the “action stroke” and the “create gesture object stroke.”

Gesture Script: if the Gesture Action Object contains an XML fragment, or C++ or Java software fragment or some other programmable object, the action is derived from this object. For example, an xml fragment might contain a font including family, size, style and weight. This fragment could be used to designate an action for a Gesture Object such that when that Gesture Object is used to impinge a text object, this will cause the text object to be changed to the font family, size, style and weight of the XML fragment.

Selector: a Selector is an optional Gesture which, when applied to the Context object, is used to trigger the Action on the Context object. If a Selector is not specified, the Action is invoked on the Context Objects when the Gesture Object is applied to them. If a Selector is specified, the Action associated with the Gesture Object is not invoked when the Gesture Object is applied to the Context Objects. Instead the Action is postponed and applied when the Selector is activated.

Action: an Action is a set of one or more properties that are set on one or more objects identified as Gesture Context Objects. An Action can include any one or more operations that can be carried out by any object for any purpose. An action can be any function, operation, process, system, rule, procedure, treatment, development, performance, influence, cause, conduct, relationship engagement and anything that can be controlled by or invoked or called forth by a context. Any object that can call forth or invoke an action can be referred to as an “action object.” The Action is either defined by the user to initiate the construction of a Gesture Object, or it is inferred from the Gesture Action Object. If multiple options for the Action are available, the user may be prompted to identify which properties of the Gesture Action Object should be saved in the Action.

Context: A Context can include any object, (e.g., recognized objects, devices, videos, animations, drawings, graphs, charts, etc.), condition, action that exists but is not active, action that exists and is active or is in any other state, like pause, wait, on or off. Contexts can also include relationships (whether currently valid or invalid) functions, arrows, lines other object's properties (color, size, shape and the like), verbal utterances, any connection to one or more networks for any reason, any assignment or anything else that can be presented or operated in a computer environment, network, webpage or the like.

Persistence: Applying a Gesture Object without a Selector can create an immediate relationship. Applying a Gesture Object with a Selector creates a persistent relationship. The relationship may be discarded once it is invoked, or it may be retained and the Action repeated each time the Selector is activated.

Arrow: an arrow is an object drawn in a graphic display to convey a transaction from the tail of the arrow to the head of the arrow. An arrow may comprise a simple line drawn from tail to head, and may (or may not) have an arrowhead at the head end. The tail of an arrow is at the origin (first drawn point) of the arrow line, and the head is at the last drawn point of the arrow line. Alternatively, any shape drawn on a graphic display may be designated to be recognized as an arrow. The transaction conveyed by an arrow is denoted by the arrow's appearance, including combinations of color and line style. The transaction is conveyed from one or more objects associated with the arrow to one or more objects (or an empty spaced on the display) at the head of the arrow.

Objects may be associated with an arrow by proximity to the tail or head of the arrow, or may be selected for association by being circumscribed (all or partially) by a portion of the arrow. The transaction conveyed by an arrow also may be determined by the context of the arrow, such as the type of objects connected by the arrow or their location. An arrow transaction may be set or modified by a text or verbal command entered within a default distance to the arrow, or by one or more arrows directing a modifier toward the first arrow. An arrow may be drawn with any type of input device, including a mouse on a computer display, or any type of touch screen or equivalent employing one of the following: a pen, finger, knob, fader, joystick, switch, or their equivalents. An arrow can be assigned to a transaction. A drag can define an arrow.

Arrow configuration: an arrow configuration is the shape of a drawn arrow or its equivalent and the relationship of this shape to other graphic objects, devices and the like. Such arrow configurations may include the following: a perfectly straight line, a relatively straight line, a curved line, an arrow comprising a partially enclosed curved shape, an arrow comprising a fully enclosed curved shape, i.e., an ellipse, an arrow drawn to intersect various objects and/or devices for the purpose of selecting such objects and/or devices, an arrow having a half drawn arrow head on one end, an arrow having a full drawn arrow head on one end, an arrow having a half drawn arrow head on both ends, an arrow having a fully drawn arrow head on both ends, a line having no arrow head, a non-contiguous line of any shape and arrowhead configuration, and the like. In addition, an arrow configuration may include a default, gap which is the minimum distance that the arrow head or tail must be from an object to associate the object with the arrow transaction. The default gap for the head and tail may differ. Dragging an object in one or more shapes matching any configuration described under “arrow configuration” can define an arrow that follows the drag path.

Gesture Line: a Gesture Line is a drawn line that is recognized by the system as a Gesture Object. The characteristics of the line are used to identify that the line represents and should be used as a Gesture Object. These may include:

1. Shape

2. Dimensions

3. Proportions

4. Path

5. Color

6. Line style

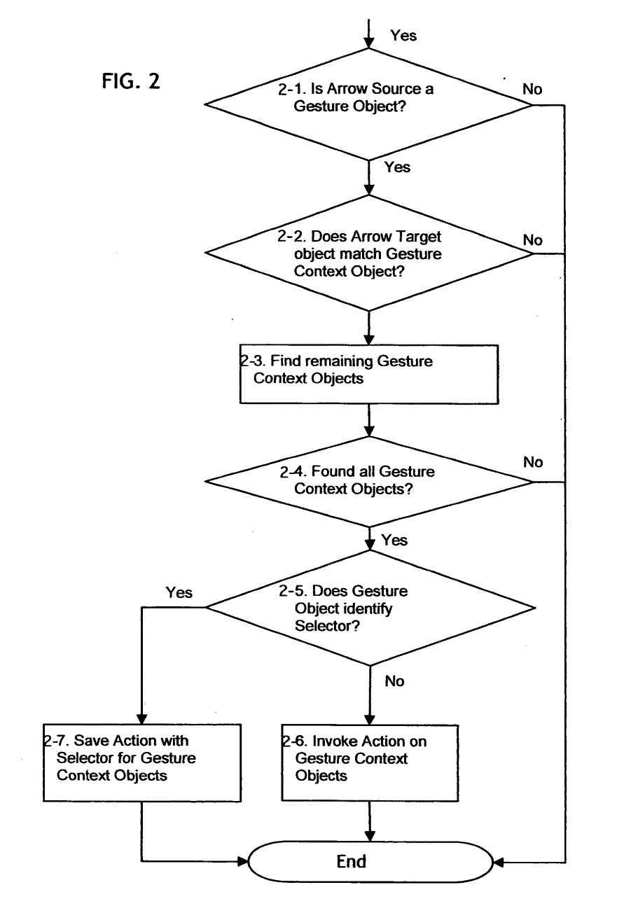

When the line is recognized as a Gesture Object, the system will apply the Gesture Object to the objects identified by the drawing of the line. The system will use the same rules as it would for applying an existing Gesture Object using an arrow. That is, gesture lines are arrows. See flowchart in FIG. 2, for example.

The system will use the objects intersected by the recognized line as the source and target objects of the arrow. In one example of this approach, the object underneath the end point of the recognized line will be the first object examined as a Gesture Context Object. (See step 2 of the flowchart). Therefore, the recognized line conforms to the definition of an Arrow and can be considered to be an Arrow. [Note: The order of objects examined is not set, this examination of objects can be in any order.]

The system attempts to recognize the drawn line as a Gesture Object when the line is completed, typically on the up-click of the mouse button or a finger or pen release. Once a Gesture Object has been recognized the system attempts to match the intersected objects to the definition of the Gesture Command, previously programmed in the Gesture Object. As soon as the Gesture Command is successfully matched it is applied (or postponed with a Selector). See step 4 of the flowchart. This is the same logical sequence of events for applying an Arrowlogic. The Action associated with the recognized Gesture Object is the logic for the Arrow.

Gesture Objects are not limited to lines. They can be any graphical object, video, animation, audio file, data file, string of source code text, a verbal utterance or any other type of computer generated or readable piece of data.

NOTE: a drag or a drawn line defines an arrow. In the case of a drawn line, the mouse down, or its equivalent, defines the start or origin of the arrow and the drawn line length defines the shaft of the arrow and the mouse up click (or its equivalent) defines the end of the arrow, its arrowhead. In the case of a drag (for example, the dragging of an object) the mouse down defines the origin of the arrow, the path along which the object is dragged, defines the shaft of the arrow and the mouse up click defines the end of the arrow, its arrowhead.

The following list defines possible relationships created by the drawing of a gesture line or the dragging of a gesture object, wherein the path of dragging a gesture object may itself be a gesture line.

Source objects: One or more objects adjacent to or under the tail of an arrow (the tail is at the point where the arrow is initiated, typically using a down click of a mouse button); or one or more objects intersected by the shaft of an arrow.

Target object: the object adjacent to or under the tip of an arrow (the arrowhead).

Arrow characteristics:

1. shape

2. path

3. recognition

4. color

The origin and target objects are special cases. They can either be considered to point to the canvas or to nothing if there is no other object underneath the arrow tail or head points. The arrowlogic can be applied in at least three ways:
1. Explicitly selected source objects are related to a single explicitly selected target.
2. Selected objects are treated as a single selection and then sorted into sources and target categories according to the characteristics of the arrow logic.
3. The source and/or target objects are determined by the type of arrowlogic represented by the arrow.

Thus the arrow source is the set of objects selected by the origin and shaft of the arrow. The arrowlogic source is the set of objects used to modify the target in some way. The arrow target is the one or more objects selected by the head of the arrow. The arrowlogic target is the set of objects affected by the arrowlogic sources in some way.

Therefore, in accordance with the present invention the arrowlogic concepts are applied herein as follows:
1. For an arrow used to program a gesture object (arrowlogic type:
   a. The Arrowlogic Source=Arrow sources=Context Objects
   b. The Arrowlogic Target=Arrow target=Gesture Object
   c. The Arrow Logic Action=Program Gesture Object
   d. Gesture Action=Action defined by user selection (voice command, action options selection box, arrow characteristics and the like)
2. For applying an existing Gesture Object (arrowlogic type 2):
   a. The Arrowlogic Source=Gesture Object
   b. The Arrowlogic Target=Gesture Context Objects
   c. The Arrow Logic Action=Apply Gesture Action (defined by the Gesture Object)
3. For applying an existing Gesture Line (arrowlogic type 3):
   a. Arrowlogic Source=Recognized Gesture Object
   b. Arrowlogic Target=Gesture Context Objects
   c. Arrow Logic Action=Apply Gesture Action (defined by recognized Gesture Object)

These relationships will be fully illustrated in the examples and description below. Note: the arrowlogic software may define that a line or a drag presented in a computer environment wherein the tail end and head end are free of any graphical indication of the designation of head or tail ends, can be recognized and function as an arrow. The tail end is the origin (mouse button down or pen down) of the line or drag and the head end is the termination (mouse button up or pen up) of the line or drag, and the graphical indications of head and tail are not necessarily required.

Dragging Gesture Objects: A Gesture Object can be applied by dragging it.

When a Gesture Object is applied by using the mouse to drag it, the path of the drag conforms to the definition of an Arrow. The path of the drag, defined herein as a movement gesture, may be represented graphically and is used to select the objects for inclusion in the set of arrow sources and targets. Thus gesture object drags are arrows. In one example of this approach, the object immediately underneath the Gesture Object at the end of the drag will be the first object examined as a Gesture Context Object. [Note: The order of objects examined need not be pre-determined, this examination of objects can be in any order.] The system attempts to match the intersected objects to the definition of the Gesture Command, previously programmed in the Gesture Object, when the line is completed, typically on the up-click of the mouse button. As soon as the Gesture Command is successfully matched it is applied (or postponed with a Selector). This is the same logical sequence of events for applying an Arrowlogic. The Action associated with the recognized Gesture Object is the logic for the Arrow.

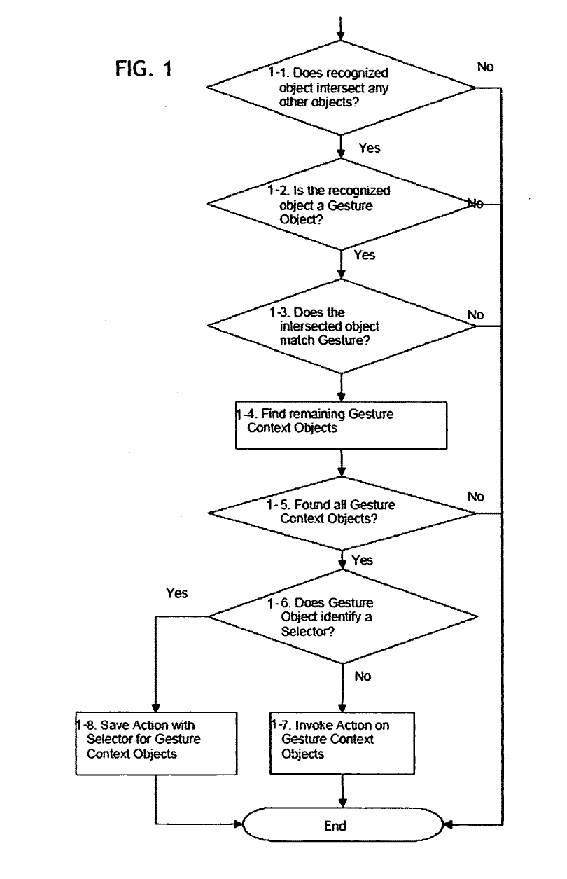

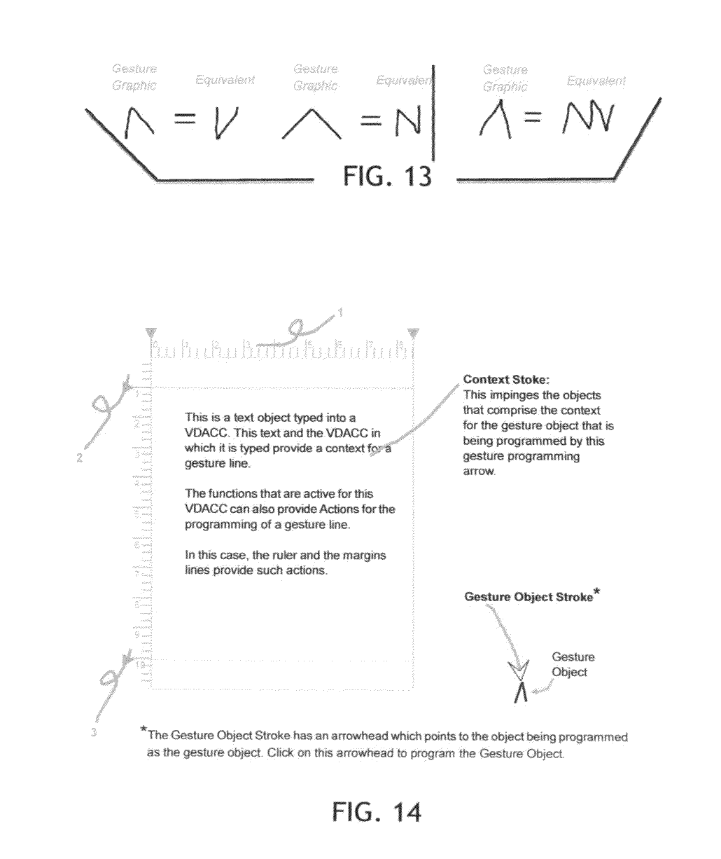

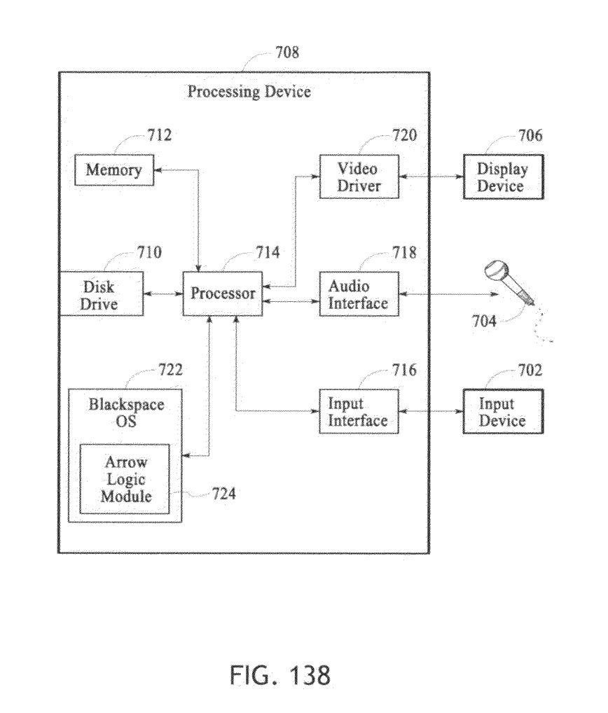

In the following description of the invention, FIGS. 1-12 illustrate the steps taken by the system software to carry out the recognition and interactions of gesture objects, contexts, and actions. A thorough presentation of examples of the uses of gestures and the gesture environment is given in FIGS. 13-137.

With regard to FIG. 1, the system software undertakes the following process when the user draws a line that is recognized by the software as a Gesture Object. (The software may comprise a graphical user environment for computer control, such as the Blackspace system.) In step 1-1, it determines if the recognized object has been drawn such that all or part of its outline intersects another object. In step 1-2, it determines if the recognized object has been programmed as a Gesture Object. Step 1-3 determines if the object immediately underneath the Gesture Object is the same type as one of the objects in the Gesture Context Object specification. The routine then finds the other objects in the Gesture Context Object specification (step 1-4) and determines that all Gesture Context Objects have been found (step 1-5). At each step, a negative result causes the routine to loop back to step 1-1.

In step 1-6 the routine determines if the Gesture Object identifies a Selector. If yes, (step 1-8) the Action is saved until the user performs a Selector gesture to one of the Gesture Target Objects. If no, then the Action on the Gesture Target Objects is invoked immediately.

FIG. 2 depicts a flowchart describing the processing that is performed when a user applies a Gesture Object using Arrowlogic. In step 2-1 the routine determines if a recognized object has been programmed as a Gesture Object. If so, in step 2-2 it determines if the object immediately underneath the Gesture Object has the same type as one of the objects in the Gesture Context Object specification. If yes, step 2-3 finds the remaining Gesture Context Objects. When all are found (step 2-4) the routine determines if the Gesture Object identifies a Selector (step 2-5). If so, in step 2-6 the Action is saved with the Selector for the Gesture Context Objects. If not the Action is invoked immediately on the Gesture Context Objects.

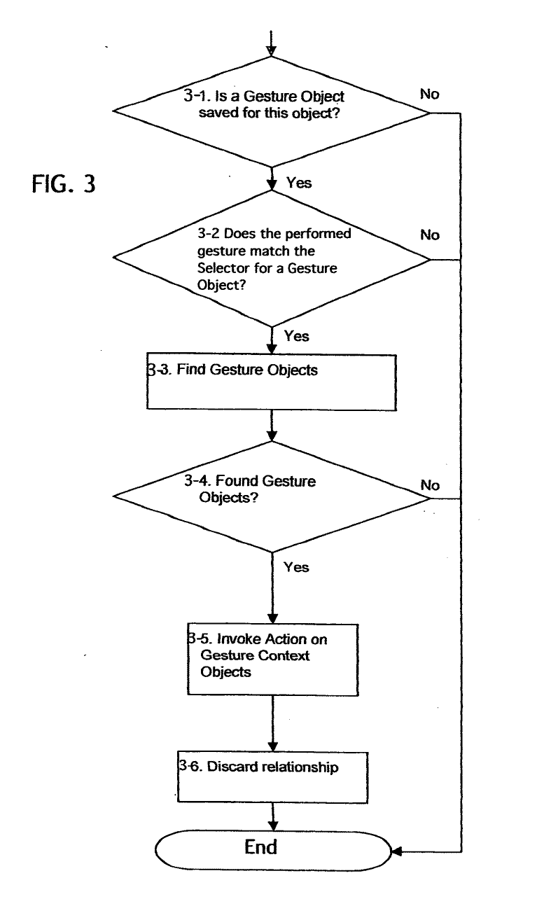

FIG. 3 depicts a flowchart describing the processing that is performed when a user applies a Gesture Object using a Selector. In step 3-1 the routine determines if there is a Gesture Object saved for this object; i.e., does the object on which the gesture was performed have any postponed relationships with the Gesture Object? If so, step 3-2 determines if the performed gesture matches the Selector gesture for any postponed Gesture Objects. If yes, the routine finds the required Gesture Object with a Selector that matches the performed gesture (step 3-3), and determines that all such objects have been found (step 3-4). In step 3-5 the Action associated with the Gesture Object is invoked on the Gesture Context Object. In step 3-6 the Gesture Object of the invoked Action is removed from the list of pending Gesture Objects, so that the relationship is discarded.

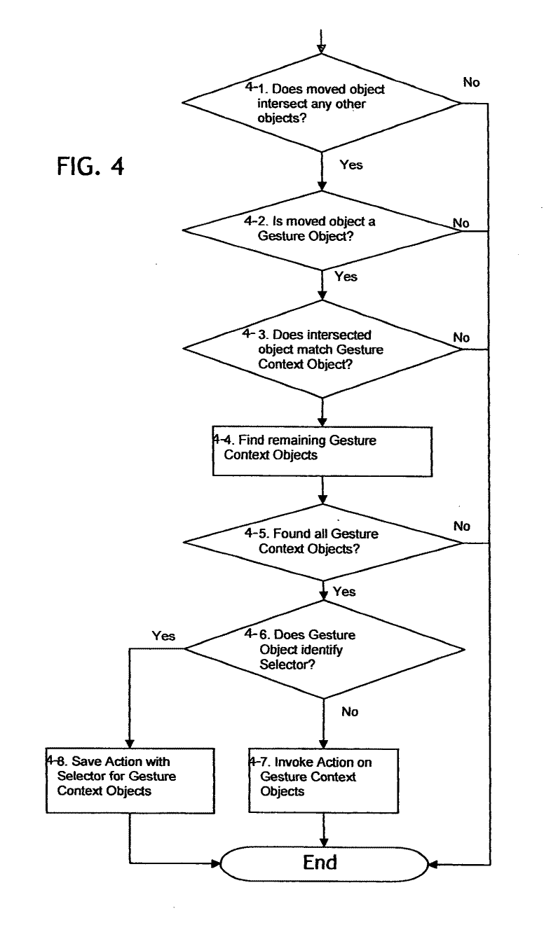

FIG. 4 depicts a flowchart describing the processing that is performed when a user drags a Gesture Object that has already been created and the Gesture Object is dragged onto the Context Object without passing over any other objects. Step 4-1 determines if the moved object has been placed such that all or part of its outline intersects another object. If yes, it determines (step 4-2) if the moved object has been programmed as a Gesture Object. If affirmative, the routine then finds (step 4-3) if the intersected object match (have the same type as one of the objects in) the Gesture Object specification. If there is a match, the routine then goes to step 4-4 and finds any remaining Gesture Context Objects, and in step 4-5 determines that all such objects have been found. Step 4-6 determines if the Gesture Object identifies a Selector, and if it does, step 4-6 saves the Action with the Selector and the Gesture Context Object. If no Selector is found, the Action is invoked immediately (step 4-7) on the Gesture Target Object.

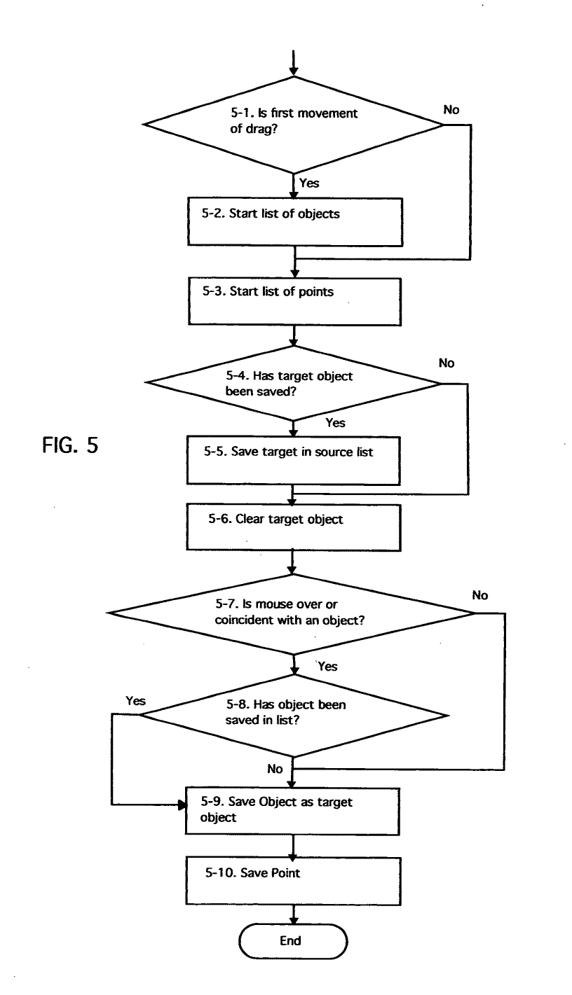

With regard to FIG. 5, a flowchart describes the processing that is performed with a user drags a Gesture Object that has already been created and the Gesture Object is dragged across a number of Objects. When the drag is started, the user clicks on a Gesture Object to ‘pick it up’ with the mouse. During the drag, each mouse movement is processed as follows. In step 5-1, the routine determines if this movement is the first movement of the drag. If so, it goes to step 5-2 and starts an empty list of source objects and an empty reference to a target object. In step 5-3 it then creates an empty list of points (on the display). The routine then determines in step 5-4 if the target object has been saved, and if not, in step 5-5 the target is saved in the source list. Step 5-6 clears the record of the target object. In step 5-7 the routine determines if the hotspot of the mouse is over or coincident with an object. If so, it finds in step 5-8 if the object has already been saved in the list of source objects. If so, the object is saved as the target object (step 5-9). Step 5-10 saves the position of the mouse hotspot.

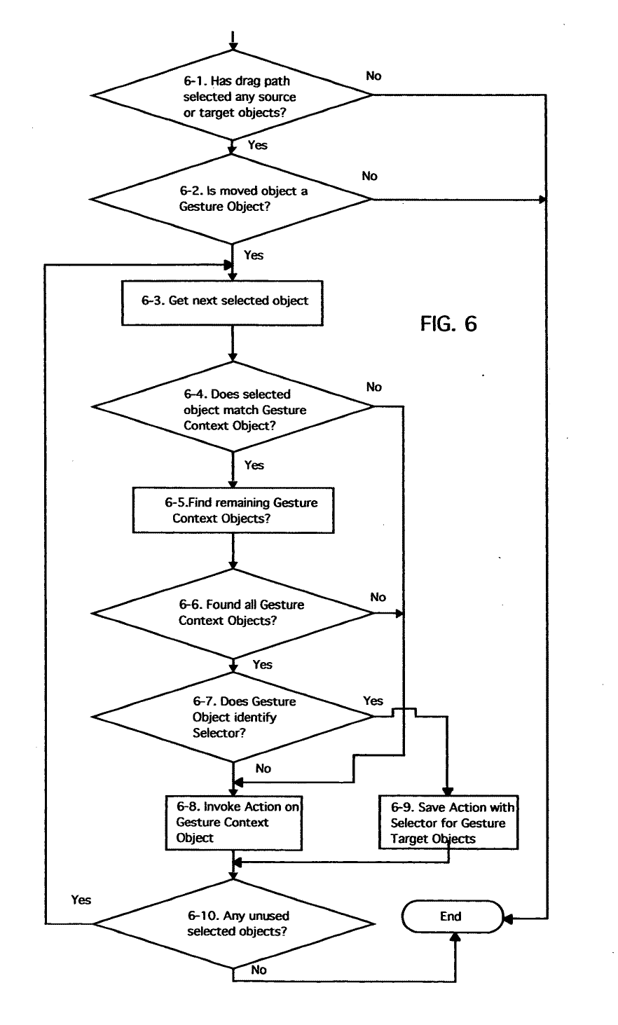

When the drag is completed, typically by the user releasing the mouse button, lifting a finger or pen from a touch screen, a vocal command or its equivalent, the following process is performed. With reference to FIG. 6, the routine determines in step 6-1 if any object (either target or source) has been selected during the drag. If yes, it finds (step 6-2) if the moved object has been programmed as a Gesture Object. If affirmative, step 6-3 gets the next unused object from the selected objects (either source or target). Step 6-4 determines if the selected object is the same type as one of the objects in the Gesture Context Object specification. In step 6-5 any remaining Gesture Context Objects are found, and the routine determines if all Gesture Context Objects have been found in step 6-6. When all such objects are found, step 6-7 looks for a Selector and, if it is found, step 6-9 saves the Action relationship between the Gesture Object and the Gesture Target Object. Lacking a Selector designation, step 6-8 immediately invokes the Action on the Gesture Target Object. If there are any unused selected objects, the routine loops to step 6-3 and reiterates from there.

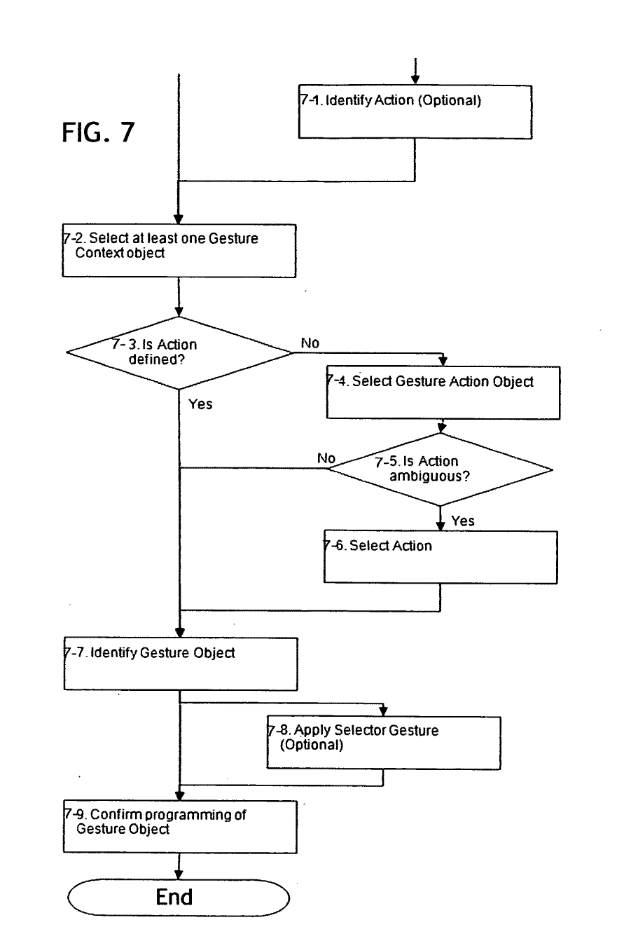

The process for programming a Gesture Object is depicted in FIG. 7. A User can begin the programming of a Gesture Object at step 7-1 by identifying a specific Action for which the Gesture Object may be used. This is optional. Otherwise, at step 7-2 a user draws an arrow shaft to impinge, enclose, surround or otherwise select one or more objects (the Gesture Context Objects). The Action will be applied to one or more of the Gesture Context Objects. In step 7-3 the routine determines if the Action is defined. If the user has already specified an action, the user moves to step 7-7. If no Action has been defined, in step 7-4 the user draws an arrow shaft with an additional recognized shape (such as a loop) to impinge on or otherwise select the Gesture Action Object that will apply to or that will define the Action or both. Step 7-5 determines if the Action is ambiguous. If so, an additional definition of the action is made in step 7-6. One such “selection” method would be to have the software show the user a list of properties to use in the Action. Multiple selections can be made. Other approaches may include having the user provide additional input, including one or more drawn objects, verbal statements, typed text or the like to further define an action.

Thereafter, in step 7-7 the user points the arrowhead, or otherwise identifies the object that will be programmed to become a Gesture Object. The user may apply a Selector gesture in step 7-8 to one of the Gesture Context Objects. This is optional. If not, the User in step 7-9 clicks on the arrow head, or otherwise confirms the creation of the Gesture Object.

Following the process of FIG. 7, the Blackspace code behaves as follows after the user clicks on the arrowhead that was drawn to create a Gesture Object. As shown in FIG. 8, the system finds and identifies all the Gesture Context Objects in step 8-1, and goes to end if none are found. Otherwise, in step 8-3 it is determined if the user is creating the Gesture Object for a predefined Action. If yes, the algorithm advances to step 8-6. If the determination is negative then the routine searches for Gesture Action Objects (step 8-4), and if at least one is found (step 8-5), in step 8-6 the Gesture Object is identified and tested to determine if an equivalent object has already been programmed. The routine proceeds through step 8-7 to find other Gesture Objects and thence to point 8-A.

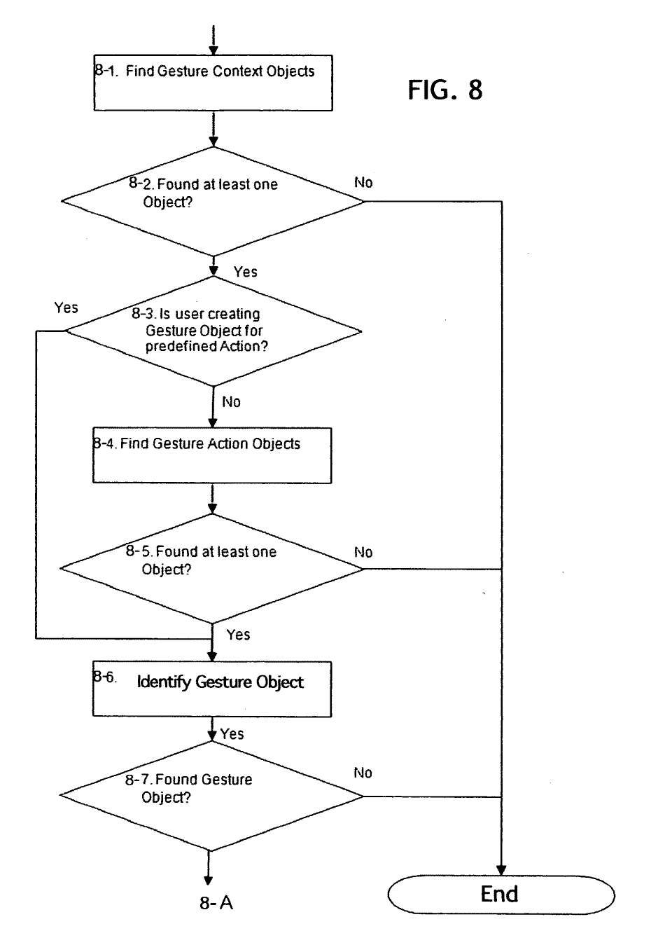

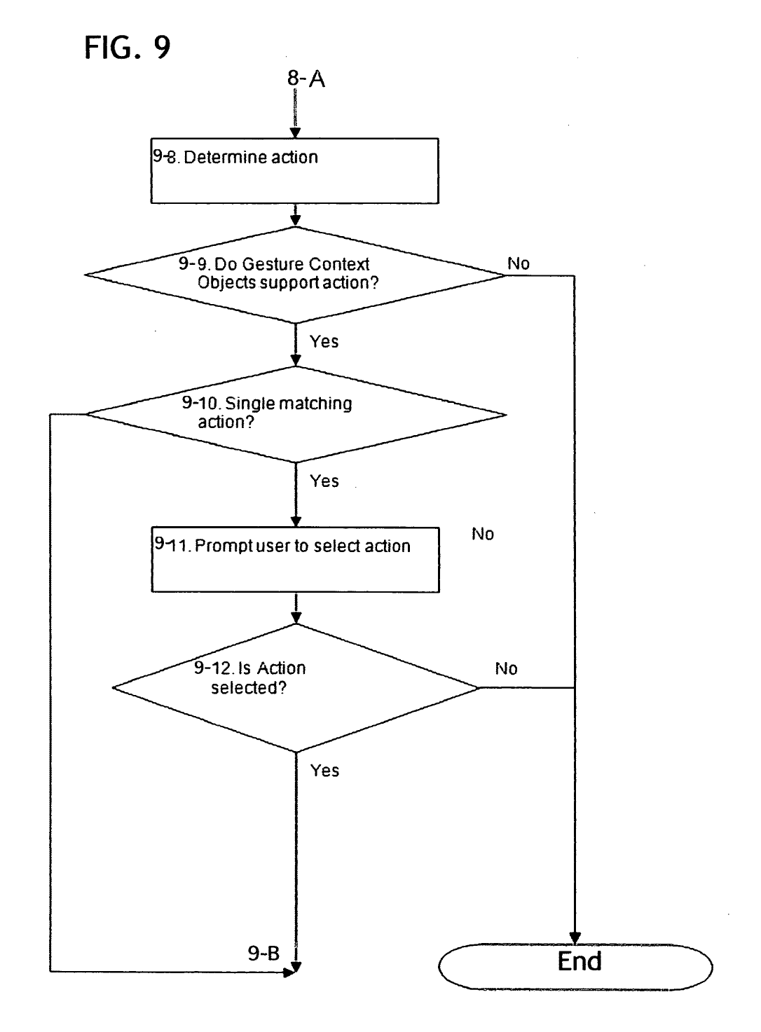

The process continues at point 8-A in FIG. 9, and thence to step 9-8, where the routine determines the Action that may be performed on the Gesture Target Objects. In step 9-9 it is determined if the Gesture Context Objects supports the Action determined in step 9-8. If affirmative, in step 9-10 it is determined if there is only one matching Action. If so, step 9-11 prompts the user to select the matching Action. If the Action is selected (step 9-12) then the routine proceeds to point 9-B.

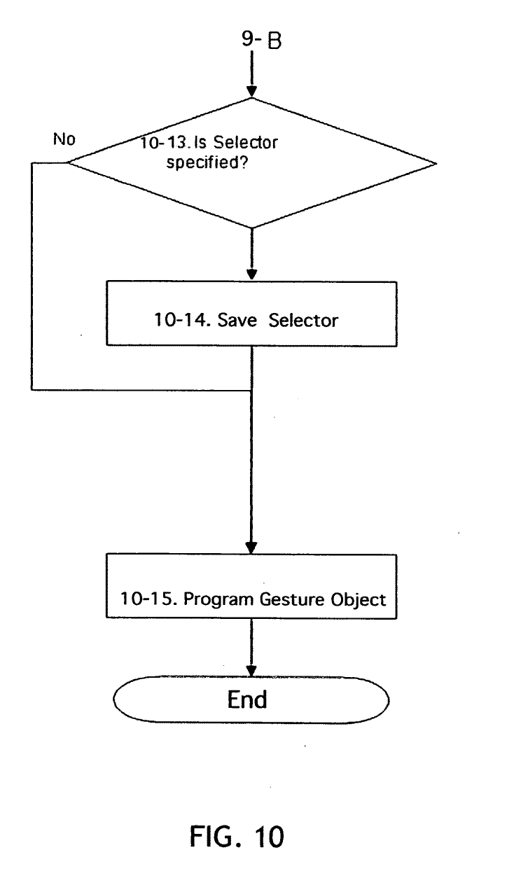

In FIG. 10 the process continues from point 9-B with step 10-13, which determines if the user has specified a selector or performed a selector gesture. If affirmative, the Selector gesture is saved. If negative, the routine goes to step 10-15 and programs the Gesture Object with the Gesture Source Objects, Gesture Target Objects, Action, and optional Selector. Thus this routine is ended.

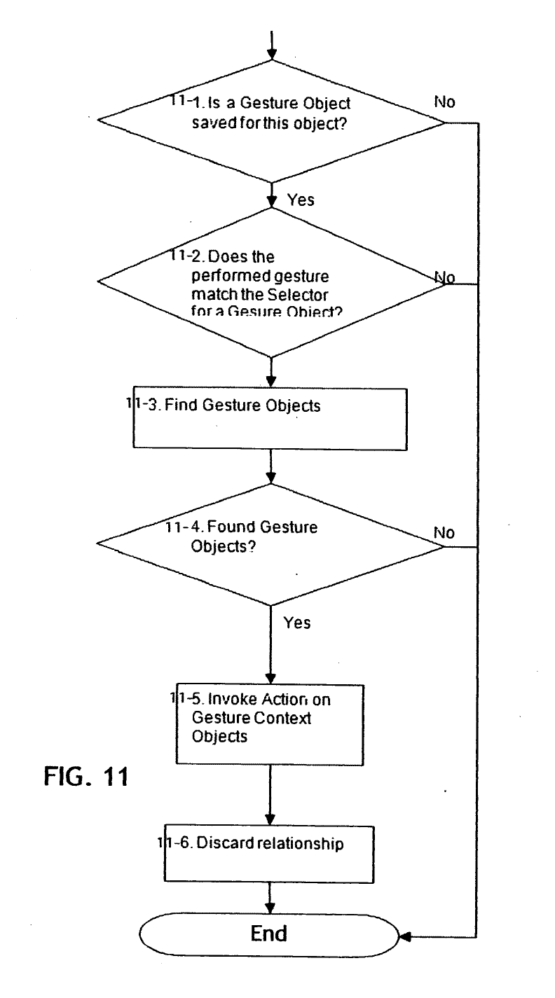

It is also possible to apply a Gesture Object by dragging or drawing a programmed Gesture Object so that it impinges on an object that matches the type of object in the Gesture Context that is saved for the impinging Gesture Object. With reference to FIG. 11, step 11-1 determines if the object on which the gesture was performed has any postponed relationship with Gesture Objects. If affirmative, step 11-2 finds if the gesture performed matches the Selector gesture for any postponed Gesture Objects. A positive response leads to step 11-3 to look for the required Gesture Object with a Selector that matches the performed gesture. If the corresponding Gesture Object is found (step 11-4) the next step (11-5) invokes the Action associated with the Gesture Object on the Gesture Context Objects. In step 11-6 the Gesture Object is removed from the list of pending Gesture Objects for the selected object, the relationship is discarded, and the endpoint is reached. Likewise, a negative response to any of the steps leads directly to the endpoint.

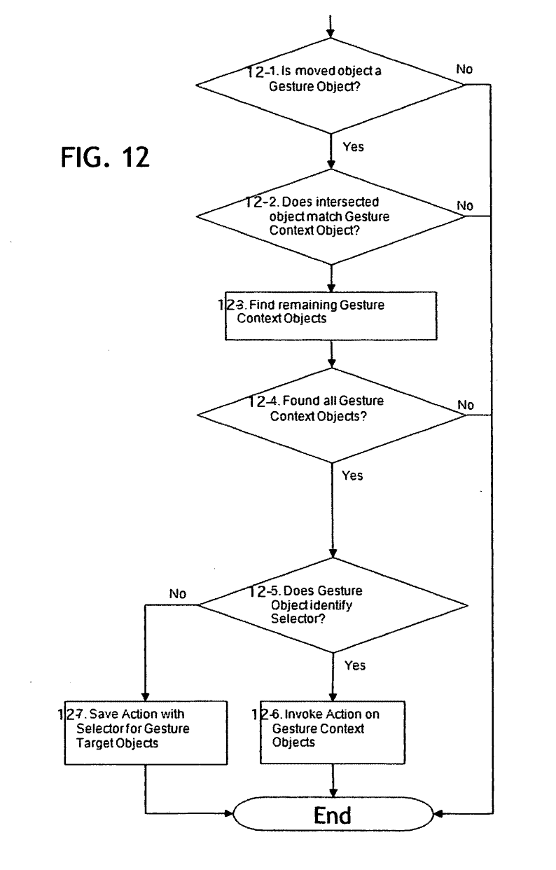

When a user applies a gesture to an object, the process depicted in FIG. 12 is performed. In initial step 12-1 it is determined if the user has moved an object that has been programmed as a Gesture Object. If yes, step 12-2 determines if the object immediately underneath the Gesture Object has the same type as one of the objects in the Gesture Context Object specification. If affirmative, step 12-3 looks for that same type object in the Gesture Context Object specification. Step 12-4 determines that all the matching Gesture Context Objects have been found. Following that, step 12-5 looks for a Selector gesture associated with the Gesture Object. If a Selector is found, step 12-7 saves the Action with the Selector for the Gesture Object and Gesture Target Object for later implementation. If no Selector is found, step 12-6 invokes the Action on the Gesture Target Object(s) immediately.

With regard to FIG. 13, it is possible to create equivalents for known gesture graphics. For example, the leftmost gesture graphic, an inverted V (caret) gesture with an acute included angle, may be set to correspond to an upright V symbol. In the middle gesture graphic, a broad inverted V gesture is set to be equivalent to an “N” shaped input. At the rightmost, an inverted V caret gesture is set to be equivalent to an M-like scribble gesture. This equivalence feature will be elucidated in the examples below.

In one example of the Gesture environment, depicted in FIG. 14, a Blackspace VDACC is shown with rulers spanning the top and left side edges and vertical margin lines enclosing a text object. The VDACC and the text object are designated as context objects, and the ruler and vertical margin lines are designated as action objects. A looped stroke is defined here as an action stroke, and there are three action strokes in use: Stroke 1 is a looped stroke that impinges on the ruler for the VDACC. Strokes 2 and 3 are looped strokes that impinge on the top and bottom vertical margins respectively. The objects impinged on by strokes 1-3 are the action objects for this gesture programming arrow. A context stroke (defined here as a non-looping stroke) impinges on both the VDACC and text object contained in it, thereby defining a VDACC containing a text object as the context for the gesture object that is being programmed. A drawn caret symbol is designated as the gesture object by the user drawing a gesture object stroke, here defined as a non-looping stroke having a drawn arrowhead that is recognized by software and replaced by a machine-drawn white arrowhead. Clicking or touching the white arrowhead sets the action and context, making the caret a gesture object.

The utility of the process depicted in FIG. 14 lies in the ability of the user to drawn the caret gesture object at any time thereafter, and impinge on a VDACC and its text object in order to implement the action: add the rulers and vertical margin lines of FIG. 14 into the impinged VDACC.

Note that if the equivalents of FIG. 13 are implemented, a user may draw any of the equivalent gestures, and use any one of them as described above to apply rulers and margin lines to any VDACC containing a text object.

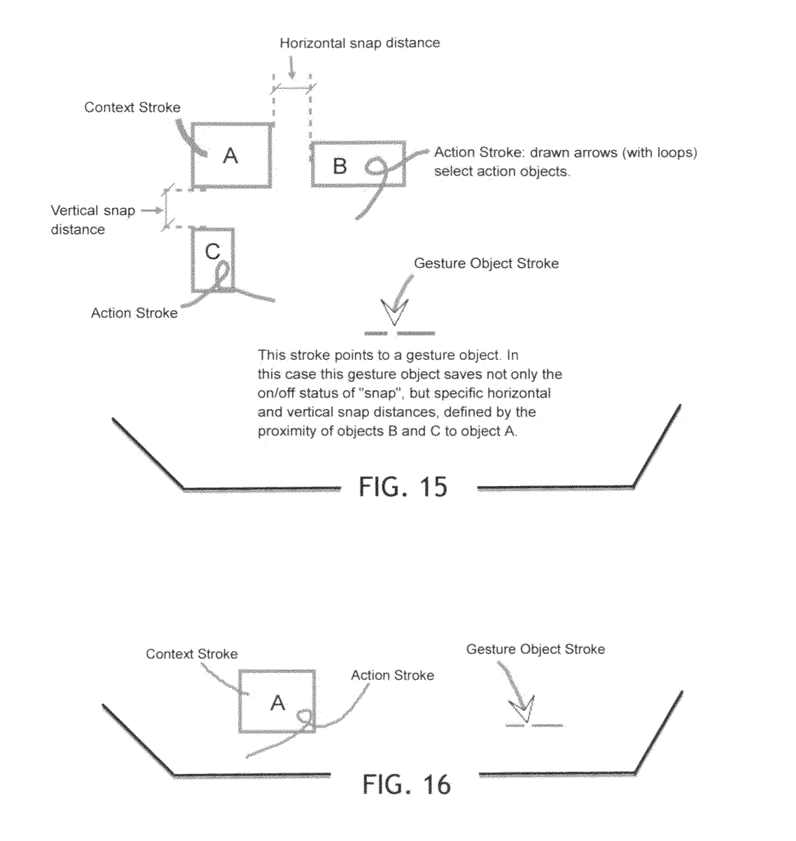

Another example of the gesture environment, depicted in FIG. 15, programs a Gesture Object for setting a snap distance (that is, a “snap to object” function). Three objects A, B, and C, are placed on the drawing surface, each being a rectangular element. Object A is spaced horizontally from object B, and object C is spaced vertically from object A. Looped action strokes are drawn to impinge on elements B and C, and a context stroke is drawn to impinge on element A. In this example the “snap to object” function is turned on for object A, and the result is that any rectangular object dragged to impinge on object A will be snapped to object A according to snap conditions existing as settings for object A. This activated snap function, plus the object type for which it is activated (a rectangular object) provides a context. Accordingly, in this example object A is the context object.

To enter object A in a mode where it can have its horizontal and vertical snap distances user-defined, a user could make a verbal utterance. e.g., “set snap distance” or “program snap.” In lieu of a vocal utterance; a user could press a key or some other action, which represents “program snap.” Once “program snap” is engaged for Object A, a user may drag another object, Object B, to within a horizontal distance from Object A and perform a mouse upclick to set the horizontal snap distance for Object A. Then object C would be dragged in a likewise manner to within a certain vertical distance from Object A to set a vertical snap distance for Object A. In this example objects B and C are the action objects. A Gesture Object stroke is drawn to a dashed blue horizontal line having alternating long/short dash segments, and clicking on the white arrowhead creates and saves the Gesture Object.

The benefit of this gesture routine is to create a gesture object, the unequal broken blue line, that may be drawn at a future time and used to set “snap to object” distances (vertically and horizontally) for any other onscreen object.

It is also possible to program a gesture for snap without using the setup depicted in claim 15. If a snap object's snap settings are acceptable, then it is not needed to reprogram them to create a gesture object. In other words, with regards to the previous example, if the horizontal and vertical snap distances that already exist as settings for Object A are what is desired to be programmed as the actions for a snap gesture object, only Object A is necessary for creating that gesture object. In FIG. 16 the context object and the action object are the same, Object A. The action is the snap settings for Object A. So in this case, the Context Stroke and the Action Stroke are both drawn to impinge on Object A. The Gesture Object Stroke is the same as it was for the previous example. It is pointing to the dashed blue line. When the white arrowhead of the Gesture Object Stroke is clicked on, the dashed blue line is programmed as a gesture object. To use the dashed blue gesture line, draw it or drag it to impinge any rectangle object and that rectangle object will be programmed with the snap settings of Object A.

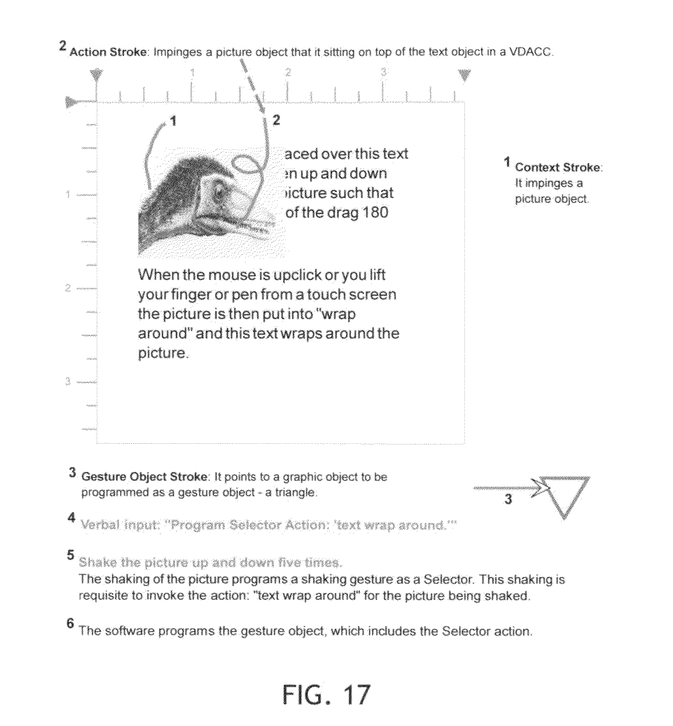

With regard to FIG. 17, this example illustrates creating a gesture object for invoking the action “text wrap” around some other object. With gesture programming a user can utilize existing objects and the relationships of these objects to each other to define the context and action(s) that are to be programmed for a gesture object. Thus a user can program a context, as defined by one or more “context” objects, and program one or more actions, as defined by one or more “action” objects. Also a selector can be used to require a user input in order to invoke the action(s) of a gesture object. A selector can also be used to define a new action(s), modify an existing action(s), or present a condition for the utilization of an existing action(s). In FIG. 17 one object is used to define a context: a picture that impinges a text object that is contained by a VDACC object. One object is used to define the Action. That object is the same picture that is sitting on top of the text object in the VDACC. The text is not wrapped around the picture, but the function “shake to invoke text wrap” is turned on for the picture. Both the context stroke and Action stroke are drawn to impinge on the image. The graphic being programmed as a gesture object is a triangle, and the gesture object stroke is drawn to the triangle. The Selector in this example is not an object but an action: “shake the picture.” There are different possibilities for programming a Selector. One would be to make a verbal utterance before the white arrowhead for the Gesture Object Stroke is clicked on, e.g., “program Selector action” or “Selector action.”

An order of user events for programming the triangle gesture object may be: draw the Context Stroke, the Action Stroke, the Gesture Object Stroke, and then say: “program Selector action.” Then “shake” the picture up and down, for example, by clicking on the image and dragging up and down, then perform a mouse upclick or its equivalent. The triangle object will be programmed as a gesture object, which includes the Selector action. Note that he picture is the “main context” for the gesture programming arrow. But it also includes an “inherited context” that is also programmed as part the context for the gesture object. This “inherited context” is the placement of the picture over a text object that is within a VDACC object.

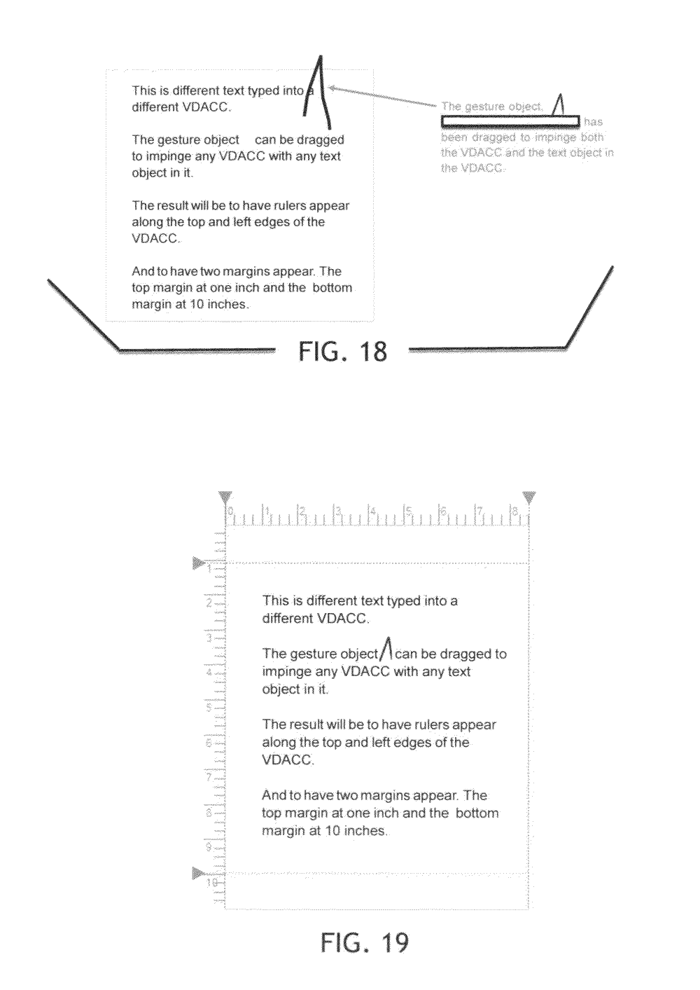

The following examples illustrate the use of Gesture Objects in computer operations. With regard to FIG. 18, the gesture object of FIG. 14 was programmed to turn on a ruler and vertical margins and place the margins at certain locations for a VDACC containing a text object. One utilization of this gesture graphic is for a user to draw it or drag it to impinge the “context objects” that were programmed by the Context Stroke of the gesture programming arrow. Note: the context for the gesture object is any VDACC with any text object in it. In FIG. 18 the gesture object has been dragged to impinge on a VDACC and a text object in the VDACC. This impinging causes a ruler and two vertical margins to appear for the VDACC. The vertical margins are placed at 1 inch and 10 inches along the ruler for the VDACC, just as they were when they were programmed for the gesture object. Thus the VDACC of FIG. 18 is transformed and appears as shown in FIG. 19.

In this process the Gesture Object (the caret) is drawn to impinge on the two context objects (the VDACC and the text object contained therein) required to establish a valid context for the Gesture Object. The dragging of the Gesture Object to impinge on the valid context causes the ruler and margins to appear. The positions of the vertical margins are the same as they were when the Gesture Object was programmed. The characteristics of the ruler, such as red lines, Arial 8pt type, measurement in inches, etc., are the same as in the programming object. Thus a significant advantage of the gesture environment is that such details are automatically programmed for the Gesture Object and embodied therein.

One advantage of using a gesture programming arrow for programming gesture objects and lines is that the user does not have to “program” actions by writing computer software code. Instead, the user simply “selects” the one or more actions that are desired to be invoked by a gesture line. This selection process is done by impinging one or more action objects with one or more “Action Strokes”. These Action Strokes can be distinguished from the other strokes of a gesture programming arrow, by including a recognized shape in the shaft of the one or more action strokes. Other methods of distinguishing them would include: any graphical, text, verbal or gesture means. This would include modifier lines, graphics, gesture objects, pictures, videos and the like which impinge the action stroke.

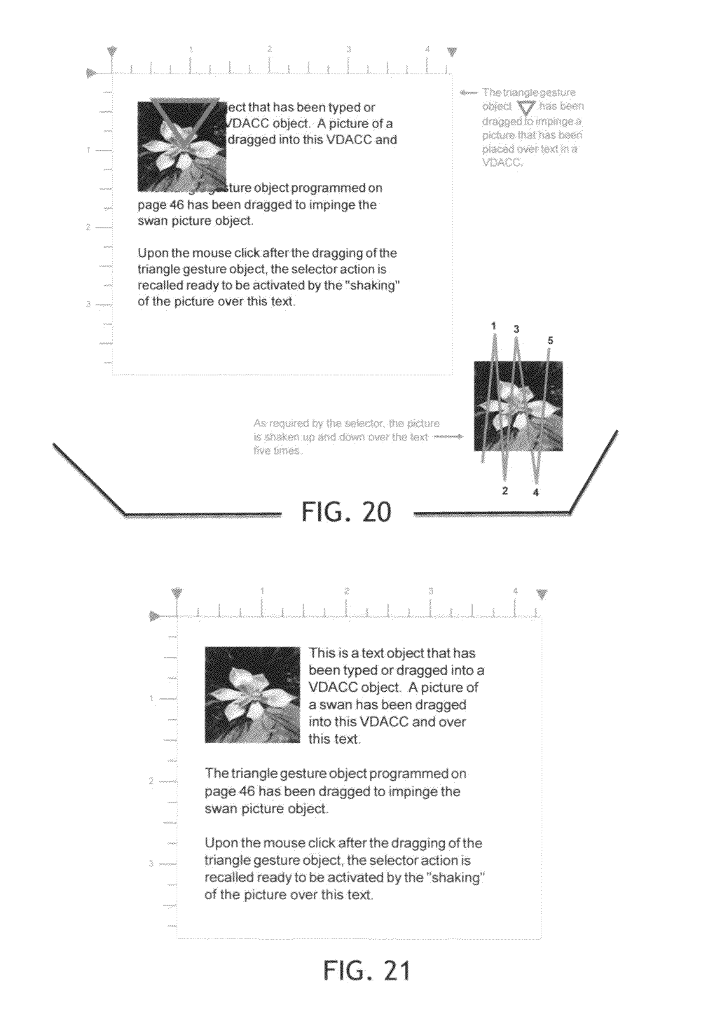

With regard to FIG. 20, another example of the use and advantages of the gesture environment involves the use of the triangle Gesture Object depicted in FIG. 17 and programmed to carry out a text wrap function. The triangle Gesture Object, created by the user, may be used to impinge on any picture or graphic object which has an “inherited context” defined as: “The placement of a picture over a text object that is contained in a VDACC.” This includes any VDACC containing any text object. The Gesture Object may be created in any proportion or size, unless otherwise specified in its programming. In FIG. 20 the triangle Gesture Object has been dragged to impinge on a picture that has been placed atop a text object in a VDACC. The act of dragging the triangle onto the picture activates the selector for this Gesture Object. (Note: the Selector had been programmed to invoke the action only after the picture is shaken.) The user then shakes the picture up and down five times, as depicted in the lower right corner of FIG. 20, and the action is then invoked. That is, the text wrap function is carried out, and the VDACC with picture object and text object appears as shown in FIG. 21. In the process of completing the action, the Gesture Object disappears from the display.

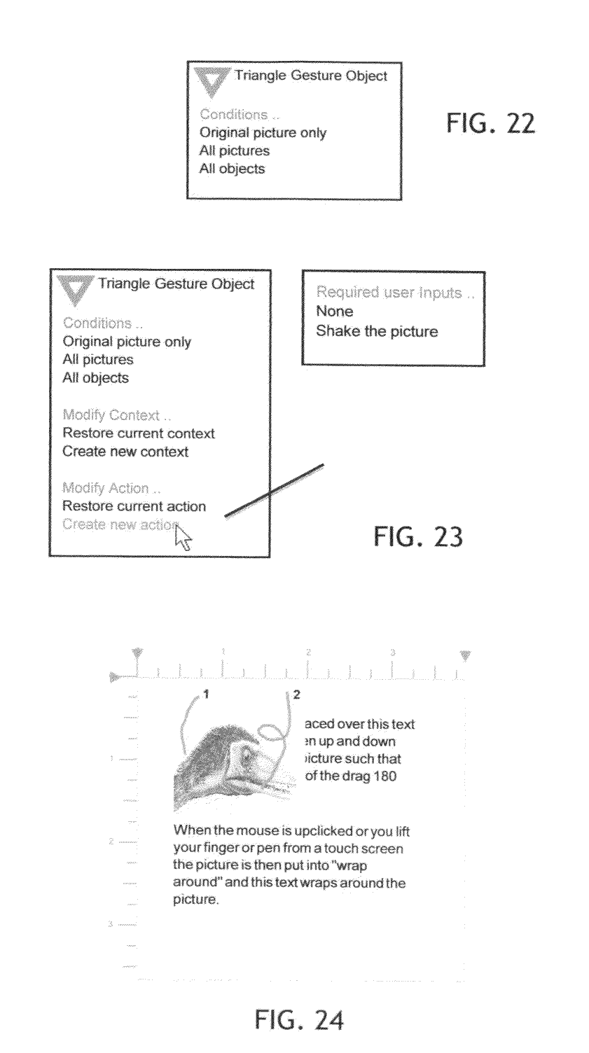

A user may wish to modify an existing Gesture Object, and there are provided various methods for carrying out modifications. Changes may entail limiting or increasing the scope of the actions that the Gesture Object conveys. One way to modify a gesture object is to provide it with a menu or Info Canvas. One example, shown in FIG. 22, relates to the triangle gesture object that invokes the action “text wrap around” by requiring a selector action: “shake a picture over a text object.” The Info Canvas shown in FIG. 22 enables a user to choose whether the action recalled by the drawing or dragging of this triangle gesture object to impinge on a picture applies only to the picture that was used when the triangle gesture object was programmed, or alternatively to all pictures or to all objects. A user may select various conditions for a gesture object. In the menu of FIG. 22 a user could select: “Original picture only” to limit the use of the gesture object to one picture. That would not be practical for the triangle gesture object. The user could select: “all pictures” which is the condition of the example illustrated in FIG. 20. In this case, any picture could be impinged by the triangle gesture object, but this picture would have to meet the criteria of the “inherited context” programmed for the triangle object. Note that the inherited context that was programmed for the triangle was: “the placement of a picture over text that is within [contained] in a VDACC object.”

A user may wish to expand the applications of the Gesture Object by not limiting its “inherited context”, or by using the Gesture Object on any picture in any location, not just pictures that are sitting on top of a text object contained in a VDACC. As shown in FIG. 23, the menu or Info Canvas for the triangle Gesture Object may provide more choices for the user, include selections headings Modify Context and Modify Action for the Object. There may also be provided a pop section from the menu that permits a user to enter a required user input. The depicted pop section provides two choices, none or “shake the picture” to invoke the text wrap action.

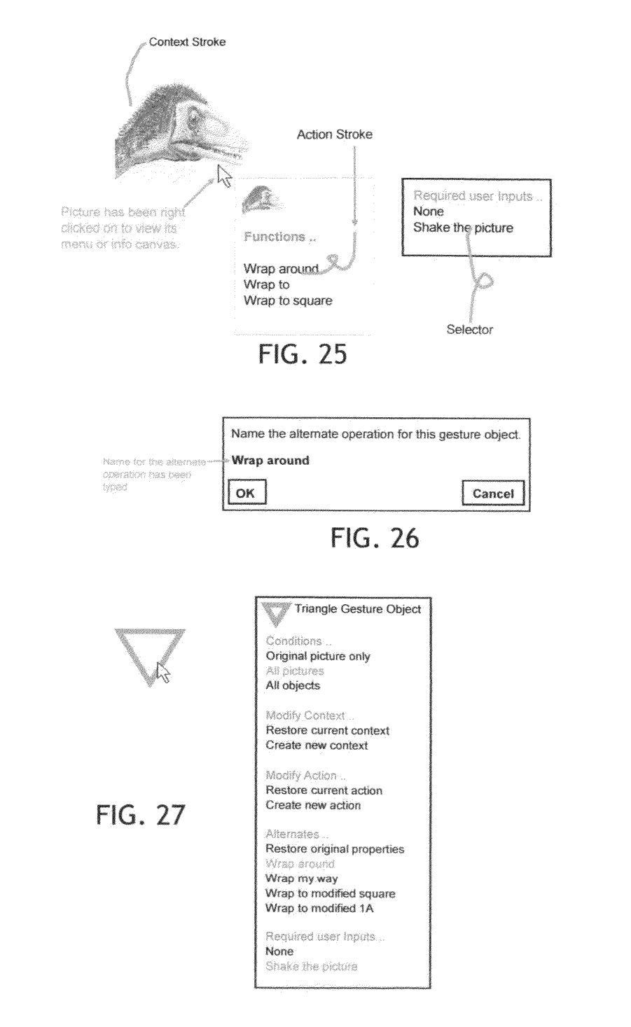

When the “Create new action” choice is selected from the menu of FIG. 23, the software presents the user with the original conditions and objects to program the action for the triangle Gesture Object, as shown in FIG. 24, including the VDACC, text object, picture, context stroke and action stroke. Presented with these original elements, the user may change them to create a new action. For example, as shown in FIG. 25 the picture has been dragged out of the VDACC and it no longer impinges on a text object. The context stroke and action stroke remaining impinging on the picture. In this set of conditions, the “inherited context” for the picture is gone. If the user wishes to update the action for the triangle gesture object or create an alternative action, one could use a verbal utterance, such as “update” or “save as alternative”, or activate a graphic to invoke this action.

If the verbal entry is made (or whenever a user right clicks on the triangle object), then a popup menu appears, as shown in FIG. 26, to enable the user to enter a name for the saved alternative operation for the triangle gesture object. The popup is an extended version of the triangle Gesture Object menu of FIG. 23, and has added to it Alternates entries and Required user inputs. In the above example of a menu the alternate “Wrap around” has had its color changed to green to indicate that it is the current selected alternate for the triangle gesture object. Also under “Required user inputs” the entry “Shake the picture has been highlighted in green. (FIG. 27) To make another selection, the user clicks on any entry under the category: “Alternates.”

With the alternate “wrap around” active for the triangle gesture object, this triangle gesture object can be drawn to impinge on any picture and the action “wrap around” will be recalled, but not invoked, for that picture. When the picture is shaken this will invoke “text wrap around” for the picture object. Any of the above described menu selections could be replaced by various vocal utterances. Instead of entering or selecting lines of text in a menu, this text could be uttered verbally or some equivalent thereof. An object that represents a condition, action, relationship, property, behavior, or the like, can be dragged to impinge a gesture object to modify it. As an alternate an arrow or another gesture object or gesture line could be used to add to or modify a condition, action, behavior, etc., of the gesture object or context could modify a condition.

One advantage of dragging a gesture object, rather than drawing it is that a gesture object may be dragged through a number of objects all at once in order to program them. To accomplish this a user would drag a gesture object to impinge multiple objects and then upon the mouse upclick, or its equivalent, the gesture object's action would be invoked for all of the objects impinged by it. If a selector has been programmed for the gesture object, then the gesture's action(s) would be invoked on the objects impinged by it after the input required by the selector has been satisfied.

The invention further provides many embodiments of line styles and gesture lines to implement the gesture environment for computer control, and it distinguishes the types of lines from each other. Other embodiments include various forms of gesture objects and gesture line segments and their applications in a computer environment.

Further Definitions

Dyomation—an animation system which exists as part of Blackspace software.

Line Style—a defined line, which could be user defined, consisting of various one or more elements which could include: a line, drawing, recognized object, free drawn object, picture, video, device, animation, Dyomation, in any dimension, e.g., 2-D or 3-D.

Impinge—intersect, nearly intersect, encircle, enclose, approach within a certain proximity, have an effect of any kind on any graphical object, device, or any action, function, operation or the like.

Personal Tools VDACC—a collection of line styles, gesture objects, gesture lines, devices and any other digital media or data that a user desires to have access to.

Computer environment—any digital environment, including desktops, personal telecommunications devices, any software application or program or operating system, video games, video and audio mixers and editors, documents, drawings, charts, web page, holographic environments, 3-D environments and the like.

Known word or phrase—a text or verbal input that is understood by the software, so that it may be recognized and thereby result in some type of computer generated action, function, operation or the like.

Stitched or (“stitching”) line or arrow—using a single line or arrow to select multiple source and/or multiple target objects.

Line or arrow equivalence—a line can act as an arrow. When a line acts as an arrow, the action or logic of the arrow can be enacted automatically, not requiring the tip of the line to be changed. If the line's arrow logic or action is not carried out automatically, but instead a user action is required, then some means to receive that user action is employed. On such means would be to have the end of the line appear as a white arrowhead that would be clicked on by a user to activate the line's action, arrow logic or the like.

Assigned-to object—an object that has one or more objects, devices, videos, animation, text, source code data, any other data, digital media or the like assigned to it.

One notable feature of gesture lines is that a user may define their own gesture lines by drawing lines and having the computer recognize and designate the drawn lines as gesture lines. This can involve one or more of the following procedures:
1) Hand draw line styles and have them recognized by the software and automatically converted into gesture lines.
2) Program one or more contexts, actions and selectors for a line of any color, style, or any other object property.
3) Enabling a user action, like dragging, clicking, a verbal input or selecting in some other fashion a line and then automatically activating that line as a gesture line.

A fundamental aspect of the Blackspace computer environment is computer recognition of free drawn line styles. Taking advantage of this feature, the invention enables a user to free draw a series of line strokes onscreen and then the Blackspace software analyzes the free drawn strokes, recognizes the one or more patterns of the free drawn lines and converts them to a usable line graphic (line style). This line style can then be programmed by a user to function as a gesture line. Therefore, the drawing of this programmed gesture line enables the one or more actions programmed for the gesture line to be applied to one or more context objects.

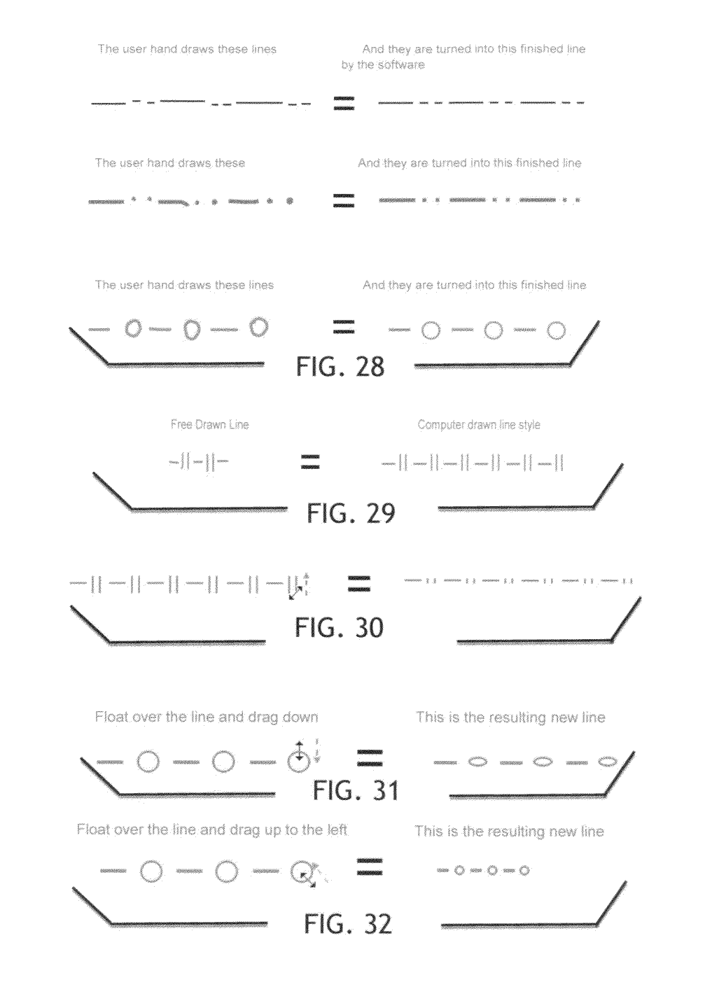

With regard to FIG. 28, there are shown some examples of hand drawn lines and the resulting machine-drawn line that is displayed after the Blackspace software recognizes the drawn inputs. In the top example, the user draws a dashed line having a repeated pattern of one long and two short dashes; in the middle example, the user-drawn dashed line has a repeated pattern of one long dash and two dots; in the bottom example, the user draws a broken line consisting of a repeated pattern of on dash and one small circle. In each case the machine-rendered line repeats the elements and their pattern, though it is rendered much more uniformly.

With regard to FIG. 29, a user may change the width of the elements or spacing of a line style. The user floats the cursor over the drawn line with NP turned on in the line's Info Canvas, and dragging laterally causes the computer-rendered line to stretch linearly in the lateral direction. Likewise, FIG. 30 depicts a user changing the height of the elements of a line style by floating the cursor over the drawn line and dragging downwardly, resulting in compression of the height of the elements. The same process is applied in FIG. 31 to diminish the height of the circle elements in that line style. In FIG. 32 the circle-dash line style is altered by floating the cursor over it and dragging up and to the left, resulting in a line style that is compressed both vertically and horizontally.

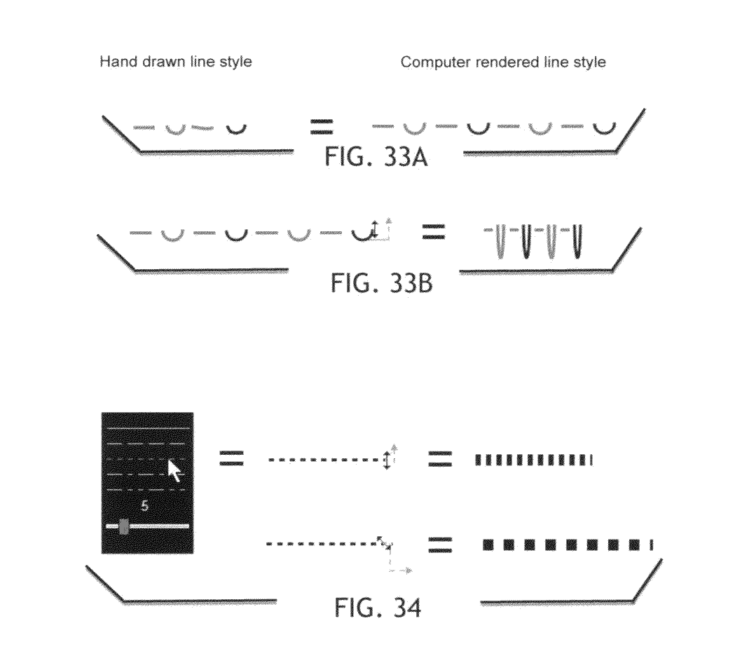

Further examples of line style drawing and manipulation are shown in FIGS. 33 and 34. In the former the hand drawn line style is a repeated pattern of dash and semicircle opening upwardly. The computer rendering is linear and uniform. In FIG. 33B, the line style is altered by floating the cursor over it and dragging up to expand the height of the semicircles and form deep V shapes. FIG. 34 depicts a different approach to creating a line style: selecting a line style (here, a broken line of uniform dashes selected by clicking the white cursor arrow on that choice). The choice is called forth, and the movement arrows in the upper line shown that floating and dragging upwardly on the chosen line expands the vertical dimension of the dashes to become upright rectangles. The movement arrows on the lower line indicate floating and dragging diagonally to expand the height and width of the dashes to form a line of square objects.

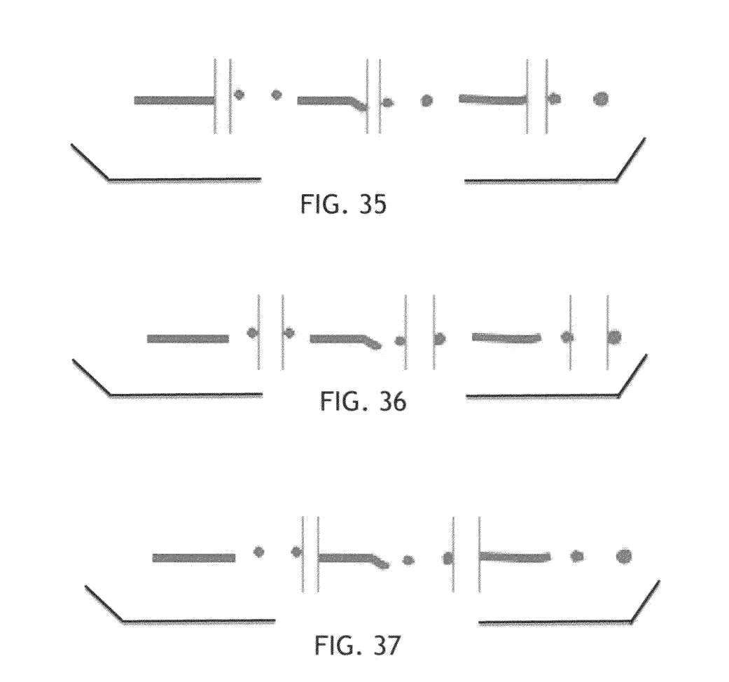

The recognition of a “straight line” is well known in many software systems, including Blackspace. The Blackspace software recognizes the contiguity of adjacent points in a linear arrangement to define a line. Furthermore it recognizes the horizontal distance between segments of a free drawn line. FIGS. 35-37 present an example of a free drawn line. In this line are three different horizontal spatial relationships. If a user draws a set of line segments that have no definable pattern, the resulting line style would be to repeat the string of segments drawn by the user as a line style. Generally, users will need to take some responsibility for the line styles they create. If they want a definable repeatable pattern, they need to draw it as such and not create wildly complex line patterns that would be hard to draw again from a user's memory.

Referring again to the three horizontal examples of FIGS. 35-37, to know that there are three different horizontal line spaces will require a type of pattern detection. One approach may be that if the software cannot find a repeatable pattern in free drawn lines, the series of hand drawn lines are “rejected” (not recognized) as would a poorly drawn geometric object. Regarding the utilization of horizontal spaces, the software measures the spacing between the dash and the first dot of each repeated sequence (FIG. 35), and the spacing between the two dots (FIG. 36) and then the spacing between the second dot and the dash of the next sequence. However many horizontal spaces of a certain type (spaces that fit a recognized pattern location) that are found in a user drawn line, their length is averaged and the resulting “average” becomes the length for the spaces in the resulting computer generated line style.

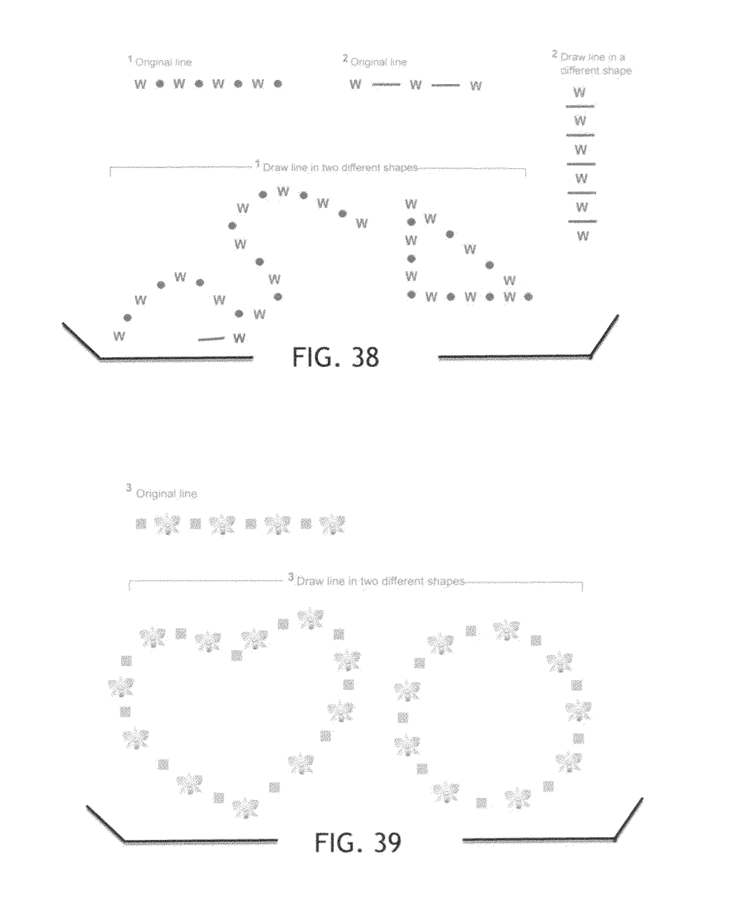

As depicted in FIG. 38, a line style may be drawn originally using alphanumeric characters, here a W alternated with a dot. The line style may then be used to draw various shaped, such as an S-like curve, or a triangle object. Likewise, FIG. 39 depicts an original line style formed of square dots alternated with a floral symbol, and this line style may then be used to draw the heart shape or circle as shown.

The system includes at least five approaches to converting a free drawn line style to a computer generated line style.

1) Activate a Line Recognition Switch (LRS) and then free draw a line as shown above. Upon the mouse upclick or its equivalent, the free drawn line and its segments are analyzed by the software and a recognized line style is presented onscreen as a computer generated graphic, replacing the original free drawn line style.

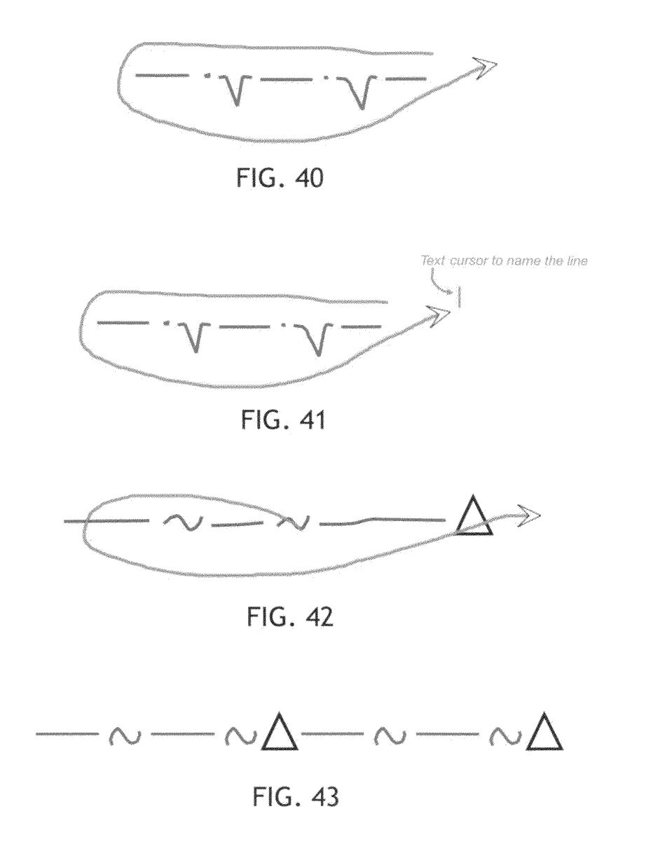

2) Draw an arrow (FIG. 40) around line style segments that the user wants included in a new line style. Upon the mouse upclick or its equivalent the arrowhead of the drawn arrow turns white and is then clicked on. The line style is drawn in blue the red arrow encircling the line style acts to both start the recognition process and save the result. The line style is then analyzed by the software and a recognized line style is presented onscreen as a computer generated graphic. This does not require a modifier arrow, because the action of encircling or intersecting one or more drawn segments onscreen (including pictures or recognized objects or even videos or animations) serves as a recognizable context for the action described in this paragraph. A text cursor (or popup) may be presented (FIG. 41) near the white arrowhead to enable the user to enter a name for the new line style.

With reference to FIG. 42, a free drawn line style is comprised of three straight horizontal lines with two ripple line interposed between the line segments, and a triangle at the right end. If the user wishes to use some but not all of these elements, a red arrow is drawn to encircle or intersect those elements that are chosen. Here the rightmost line segment is not encircled nor intersected, it will not be included in the resulting line style. Thus the line style recognized and rendered by the computer (FIG. 43) includes two line segments, two ripples, an the triangle in a repeated pattern.

3) A verbal command may be used to save a line style, after the user selects the segments included in the line. If the entire group of drawn segments were to be converted to a line style, then a verbal command may work more effectively.

4) Automatic Recognition of a line style could be used as follows. A user draws a series of line segments and then places objects within a minimal accepted distance of the drawn lines (these objects could include pictures, recognized objects, drawings, devices, and the like), and then double clicks on any of the items lined up as a line, the software would then analyze the row of objects and create a new line style. If any of the objects cannot be recognized, the software would report a message to the user. The user could then redraw the “failed” objects or remove them from the line.

5) Utilizing functional or operational (“action”) objects in a line style The idea here is for the user to be able to create different line styles that utilize objects that have assignments made to them or that cause one or more actions to occur, like playing a video or an animation or causing a sequence of events to playback or playing a Dyomation or performing a search or any action or function or operation (“action”) supported by the software. This embodiment utilizes one or more objects as segments of a line, where these object segments can cause an action.

Utilizing “action” objects in line styles opens up all sorts of possibilities. For example, a line style may be created using multiple action objects, wherein each object causes a specific action to occur. This construction enables two layers of operation to be carried out. In one layer, the drawing of the line itself in a certain context may cause an action or series of operations to occur as a result of that context. Drawing the same line in another context will cause a completely different set of actions of operations to be carried out.

Clicking on, touching, gesturing or verbally activating any “action” object contained within a line style can cause the “action” associated with that object to become active. This may result in any action supported by the software, including the playback of a series of events, or the playback of an audio mix or a video, a Dyomation, an EVR, or the appearance of objects assigned to the “action” object, the start of a search and the like.

A line style that contains a string of action objects can itself cause an action to occur. For instance, drawing a line that is made up of a series of objects may cause a margin function to become active for a VDACC. Or the drawing of this line could insert a slide show into a document.

Help Dyomations in a Margin Line: Given a string of videos comprising a margin line in a text document, the string of videos IS the margin line which functions to position text in a document. If it is the top vertical margin line for a document, a user may click on any one of the objects that represents a video in this margin line, and the video will play. This line may contain any collection of videos, like a set of instructional videos. As a further example, using such a line, “help” files could be contained within the margin lines for any text document.

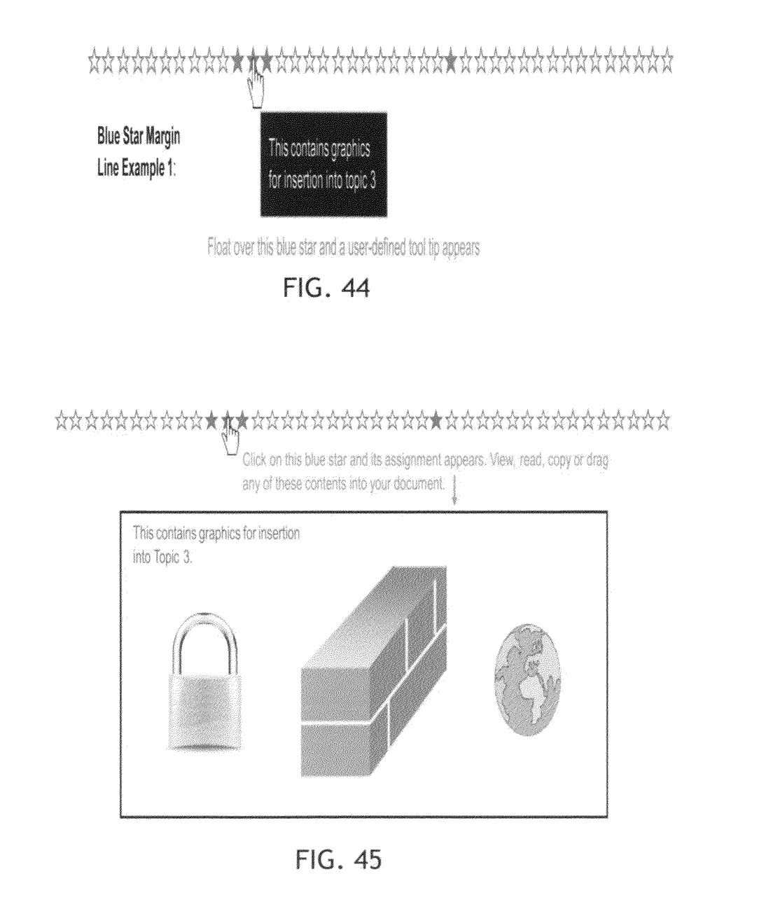

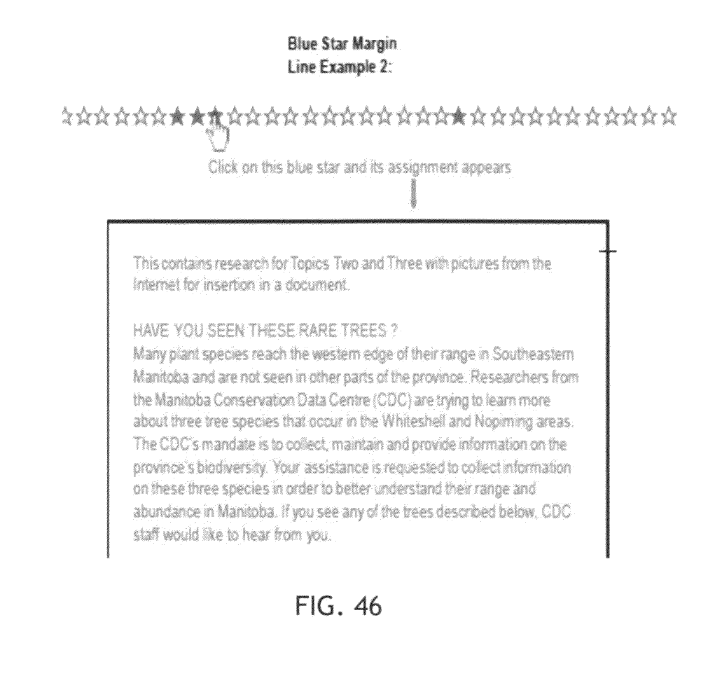

With regard to FIG. 44, there is shown one example of the margin line described above, in which a horizontal line of blue stars comprise the top margin of a text block. If this line of blue stars is moved down, the text moves down with it. Any of the blue star objects may have any kind of data assigned to it, including charts, documents, graphical data, videos, animations, and the like. Each star may contain different information assignments, or different versions of the same information. This information can be easily accessed by a person working on the text document. As shown, the user may float the cursor over a particular star object, and a user-defined tool tip appears. Clicking on the object calls forth the information stored in that star object. Thus, as shown in FIG. 45, clicking on a blue star calls forth its assigned data, and any of this data may be viewed, and any portion may be copied or dragged into the text document. Or, as shown in FIG. 46, clicking on another blue star object may call forth a display of a treatise on rare trees.

A master list of all the tool tips for each object in a line may be created automatically by the software. This master list may display the contents of each object in linear order or some other suitable arrangement.

Users can utilize the margin line “action” objects to retrieve research information, pictures, audio, video and the like. Different margin line styles can be created that contain different types of information. These different line styles can be drawn in a Personal Tools VDACC as simple line examples. To utilize these lines a user may click on any line and then draw it in a context. In the case of the blue star line, it may be drawn horizontally across the top of a document. This context is programmed into the line style so there is nothing for the user to do, but click on the line in their Personal Tools VDACC and then draw the line in a certain context.

Once the object is drawn in a context, the action(s) for the line are activated. With regards to a line containing assignable objects, this line could be used as the same or as a different margin line on every page in a document. If it is the same margin line, then when a user scrolls through their document the same action items in the margin line would be accessible from any page. If the margin line were different on each page, then for each page in a document the items that are accessible could be different.

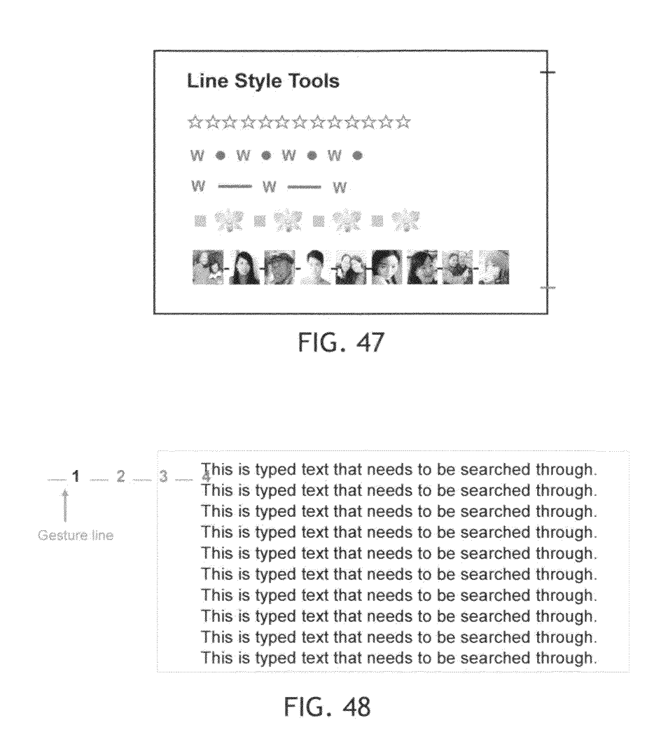

An example of a personal tools VDACC is shown in FIG. 47. It consists of a simple list of line styles that depicts the basic visual elements of each line style. To use any of these lines, the user simply clicks on the line and then draws it where the user wants to employ it in the onscreen display.

Line styles are a potentially very powerful medium for programming in a user environment and for achieving great flexibility in functionality. The following description provides some examples of line style uses. In FIG. 48, there is shown a text block that a user wishes to search. The user may click on the line in the personal tools VDACC, the line having an assignment that carries out a text search. The user then draws the selected line style in such a manner that it intersects the text object to be searched. Once the search line style has impinged on the text object, the search function will be initiated. This action may result in a series of highlighted “found” text words or it may result in a popup menu to guide the user in the search process.

Any line style could have a “show” or “hide” ability that is user selectable. This could be an entry in an Info Canvas, “hide”, where if “hide” is not activated, then the object remains visible onscreen. Regarding the “search” line style shown above, it is practical to let the line style remain visible onscreen because the segments within the line can then be clicked on to modify the search function of the line.

An assignment can be made to any letter or word or sentence in any text object. One method of doing this would be to highlight or otherwise select a portion of a text object to which a user desires to make an assignment, and then draw an arrow to that highlighted text portion from an object to be assigned to it. An alternate method would be to drag one or more objects to impinge a selected portion of a text object after an “assignment mode” was activated. This activation could be done by verbal means, drawing means, dragging means, context means or the like. A further alternate to making such assignment would be to use a verbal command or a gesture line programmed with the action “assign” or its equivalent. Note: Highlighted text should not disappear when a user activates an arrow by any means (e.g., select an arrow mode), or when a user clicks onscreen to draw an arrow.

Accordingly, multiple assignment arrows could be drawn from any number of items where the arrow's tips are pointing to any number of highlighted portions of a text object to assign various items to that text object. By this and other methods described herein, a user could make multiple assignments to different portions of a single text object, rather than having to cut the text object into independent text objects before making an assignment.

FIG. 49 illustrates an example of multiple assignments being made to various portions of a single text object. As described in that text object, any character, word, phrase or collection of characters, words and phrases may be assigned to by highlighting the portion of text to which an assignment is desired and then drawing an assignment arrow or dragging an object to impinge on the highlighted or otherwise selected text. As an alternate, an arrow could be drawn or an object dragged to a word or phrase that is not selected and still complete an assignment. Thus the red star, the Google™ word search, the ship image, or another text object may be the recipients of assignments.

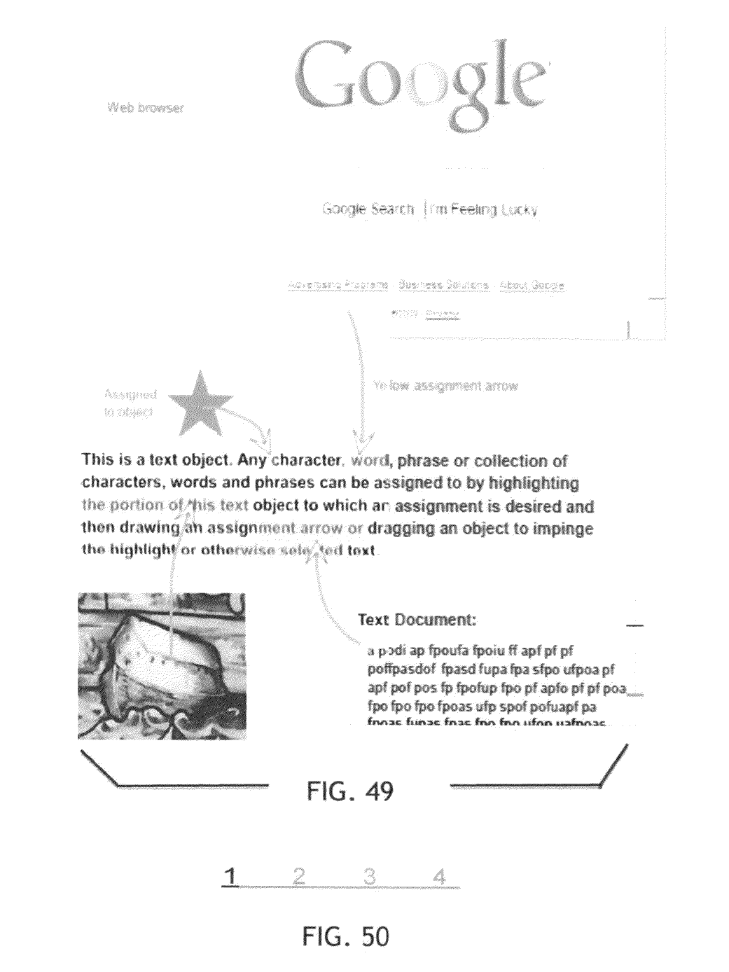

Referring to FIG. 50, each of the numbers in the search gesture line may have a different search function associated with them. By drawing the line as shown, one type of search function may be initiated; i.e., this would be the search function programmed for the overall line style. If the user clicks on the number 1 in the line style, for instance, this could modify the search function. The number 1 may change the search from being a search for a specific word to being a search for a specific type of recognized object, like a star or a triangle, etc. Alternatively, clicking or touching the number 2 changes the search function to look for an adjective associated with a word, like “blue cars”, instead of just “cars.” The concept illustrated here is that each object contained within a line style (in this case a gesture line) can contain a different action or a modifier action that can be applied to the action caused by the drawing of the gesture line in a context. Thus by drawing a simple “gesture” line that impinges an object or objects in a computer environment, an “action” can be applied to that object(s). Furthermore, additional actions or modifications to the gesture line's action, can be called forth and implemented by activating individual segments in the gesture line. This activation of individual gesture line segments can be accomplished by many different means, including clicking, verbal means, drawing means, dragging means and the like. In FIG. 50, a user may draw a “search” gesture line to impinge on a document or object in a digital environment. This would cause a search in that item according to the type of search that was programmed for the gesture line. Then the line segment objects (in this case the numbers 1, 2, 3, and 4) in the “search” gesture line could be used to modify the search or qualify the search according to additional criteria. This search of course, would not have to be in a text object, it could be in a data base or in VDACC filled with objects, in one or more recognized objects or videos, animations, charts, graphs, holographic projections, 3-D images, etc.

Blackspace email supports the ability to draw arrows from objects that contain data to one or more email addresses to which this data is to be sent. The utilization of line styles or gesture lines or gesture objects opens up many interesting email possibilities.

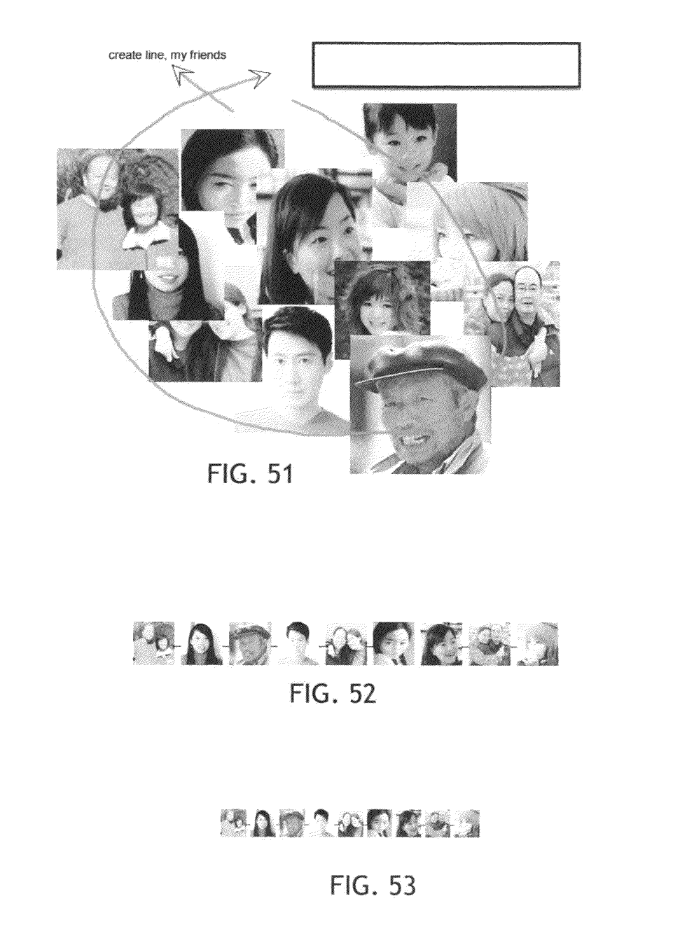

An arrow may be used to create a line style that is not a gesture line. With reference to FIG. 51, an arrow (line) is drawn around a group of pictures, then the arrow is intersected with another line and a modifier is typed, like “create line,” or “make line”, or “line.” This is followed with a name for the line style to be created, like “my friends.” Then the user clicks on either white arrowhead and the pictures are automatically built into a line style. Onscreen the user will see the pictures lined up in a row as a line. The size of the pictures will remain as each picture was, or a default picture size could be applied automatically rescale the pictures to a smaller size. In that case, the size of each picture may be governed by a default setting for a line style picture size.

Once the line style of FIG. 51 has been created, the software will create a linear line from the pictures as shown in FIG. 52. Then the line may be resized to reduce the line width and height, as shown in FIG. 53. The line style thus constructed has no functionality assigned to itself nor to any of the individual pictures, thus it is not a gesture line, but rather only a graphical line style.

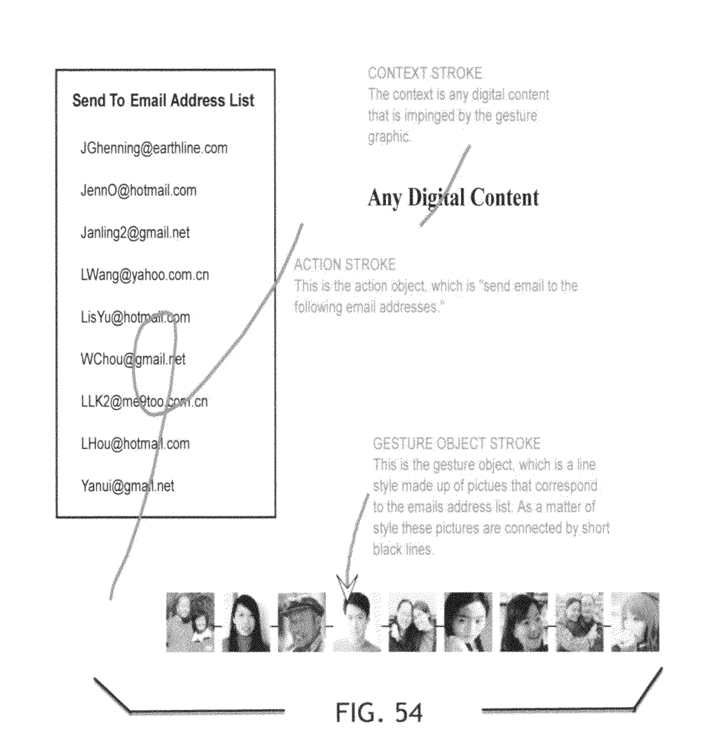

The invention provides many different ways to program a line style to be a gesture line. In the example shown in FIG. 54, “context object(s),” “action object(s),” and a “gesture object” are clearly set forth. The context is defined by a known phrase: “Any digital content.” The action is “send mail to a list of email addresses.” The gesture object is a line style containing a group of pictures.

The VDACC object containing addresses that match the pictures may be created by dragging entries from an email address book into a VDACC or into Primary Blackspace or onto a desktop. In one embodiment as the addresses are dragged from the address book they are duplicated automatically.

The programming of the gesture line has three steps: (1) a Context stroke—a first part of a non-contiguous arrow (line) that is drawn to impinge a known phrase: “Any Digital Content.” (2) an Action stroke—this second portion of a non-contiguous arrow has some type of recognizable shape or gesture in its shaft or its equivalent. Here a loop is used, but any recognizable shape or gesture could enable the software to identify this part of the arrow. This stroke selects the action for the gesture line. (3) the Gesture Object stroke. This programs the gesture line. This part of the arrow can be drawn as a plain line with no arrowhead or it can be drawn with an arrowhead. In either case, once the line is recognized by the software, either the programming will be automatically performed or some designation will appear at or near the tip of said line (like a white arrowhead) to permit a user action (like clicking on the arrowhead) to cause the programming of the line style to become a gesture line. The end of the line points to a line style to be programmed as the gesture line. This Gesture Object Stroke programs the overall line, not the line's individual segments, namely, its individual pictures. So in this case, said gesture line that is created has one action which is: take whatever digital data that is impinged by the drawing of the gesture line and send it to the nine email addresses selected by the looped “action” arrow stroke. NOTE: these three arrow strokes can be made in any order.

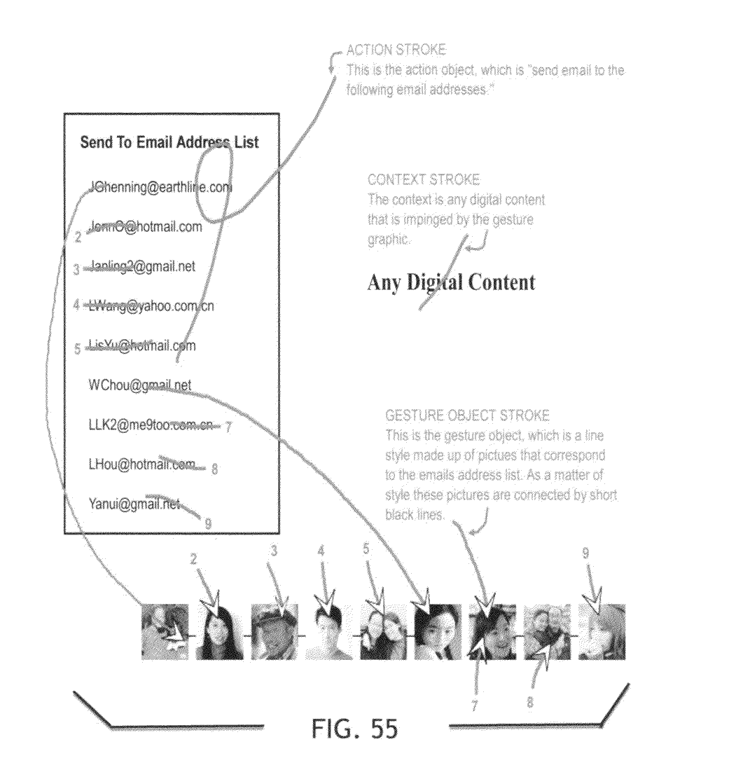

As programmed above, drawing said gesture line such that it impinges any digital content will result in sending that digital content via email to 9 email addresses. This is the overall action for said gesture line. If the user wants each of the pictures in said gesture line to represent each one of the listed emails respectively, such that the correct email address is associated with the respective person's picture in said gesture line, the user adds lines to the layout of FIG. 54 to construct those association, as shown in FIG. 55. These lines can be contiguous or non-contiguous. For instance, a contiguous arrow may be drawn such that it impinges on one email address and points to the picture of the person that belongs to that email address. An alternative is to use a non-contiguous arrow. In this case a first arrow stroke would be drawn to impinge an email address and then a second arrow stroke would be drawn to impinge the picture of the person that belongs to that email address. There are various ways of approaching this process. One procedure is to create pairs of strokes in order, e.g., a first stroke impinges an email address and a second stroke impinges a picture and then repeat this process for all nine email addresses. Another method is to create nine first strokes, impinging each of the nine email addresses in an order. Then create a second group of nine arrow strokes (note the numbered strokes in the layout of FIG. 55) in the same order that impinge each of the nine pictures respectively. A third way would be to draw a first single stroke that impinges on the nine email addresses in a particular order, then draw a second single stroke that impinges on the nine pictures in the same order such that said second stroke has an arrowhead or it is automatically activated, thus requiring no additional user action to program the picture segments.

It is important to note that the NBOR arrow patents provide for an arrow to be a line. The start of the line is the origin of the arrow and the end of the line is the tip of the arrow (its arrowhead). Note: In these examples, the context for the gesture line is created by using a known phrase “Any Digital Content” that is impinged by the first stroke of a noncontiguous arrow.

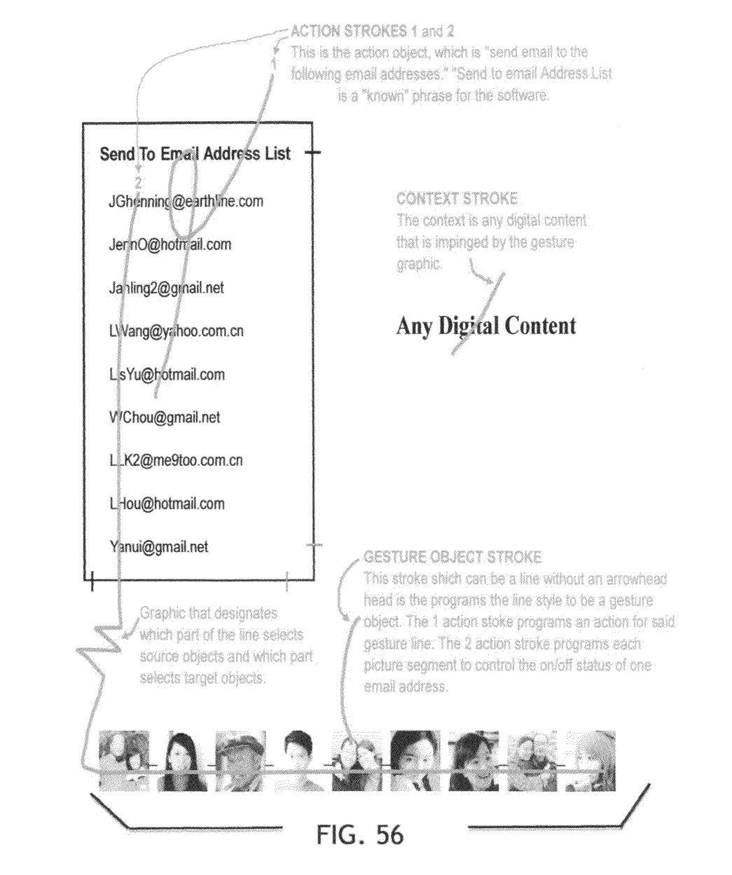

Another example of programming a line style to become a gesture line is shown in FIG. 56. In this case, a single “stitched” line is used to assign individual email addresses to individual picture segments in a line style. The line impinges on the list of email addresses in a particular order and then includes an object or gesture in its shaft. As shown in FIG. 56, the gesture is a scribble having 4 segments in an “M” shape that is recognizable by the software. The part of the line before the gesture selects source objects for the “arrow” and the part of the line after the gesture selects target objects for the arrow.

Note: the action stroke only needs to impinge the VDACC object, not the action text, “Send to Email Address List,” and the list of nine emails addresses. Since this VDACC object is managing the this action text, “Send to Email Address List” and the nine email addresses, impinging the VDACC with a “loop” arrow stroke selects all of the objects the VDACC manages.

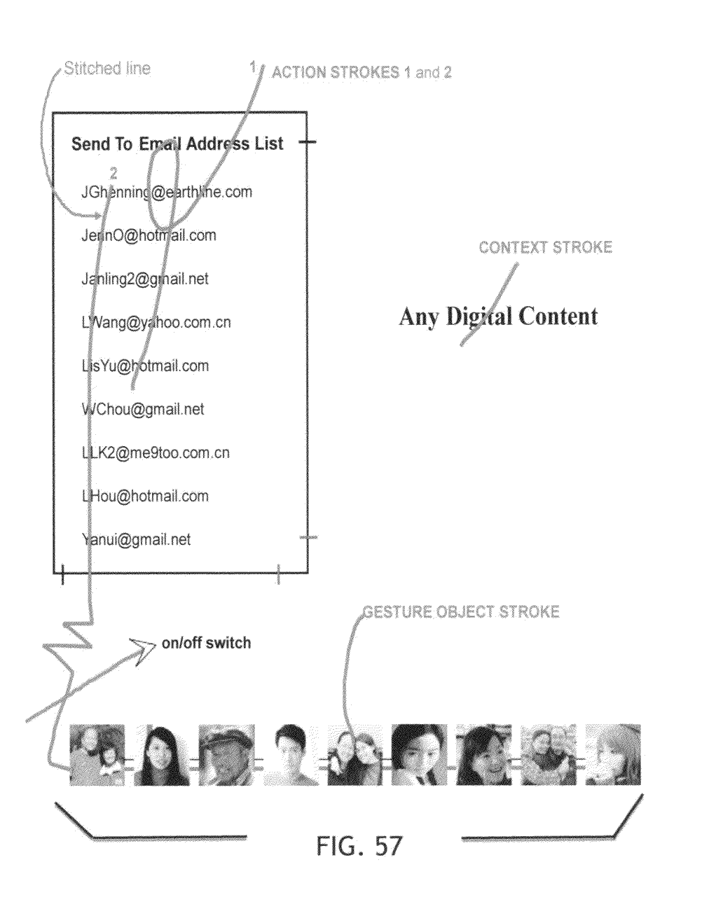

With regard to FIG. 57, a further example illustrates programming of a the same gesture line as the previous example. Again, each of the individual picture segments are being programmed to associate each with one email address by the drawing of a stitched line. One method for controlling how each picture affects the email address to which is associated is to draw a modifier line or arrow to intersect the stitched line that impinges on the list of email addresses and row of pictures. Thus some input programmed to the modifier arrow is employed to further define an action for the first drawn (stitched) line. In FIG. 57, the text “on/off switch” has been typed at the head of the modifier arrow, and this programs the picture objects to become on/off switches. This function enables any picture in the gesture line to be clicked on to turn on or off the email that is associated with it. In this manner a user may control which of the nine email addresses are recipients when the gesture line is drawn to impinge on some digital content.

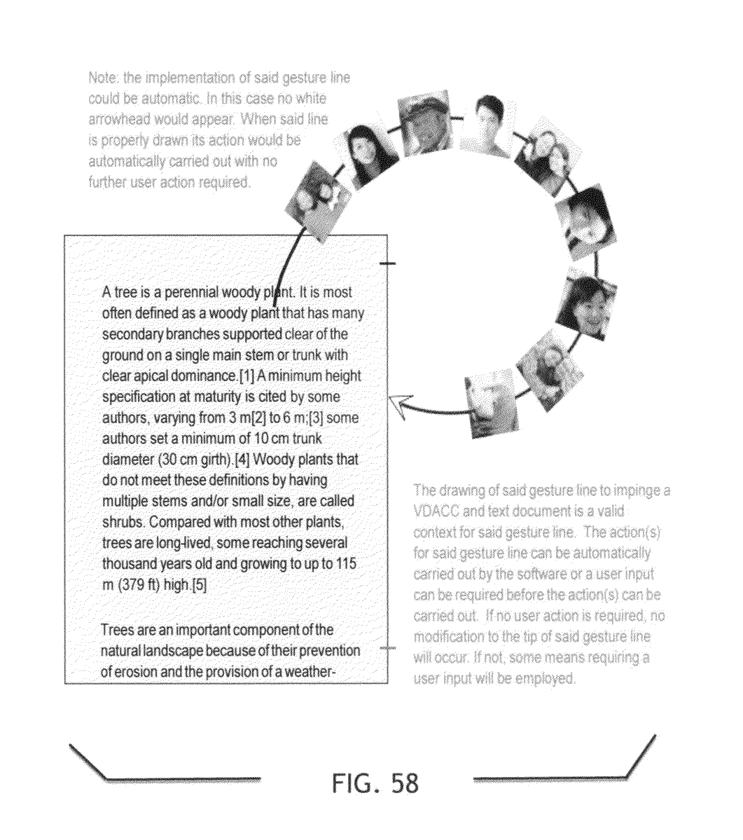

With reference to FIG. 58, the gesture line programmed as in FIG. 57 is drawn to impinge on a piece of digital media. The context stroke, shown on the previous page, designates “any digital media” as the target for the gesture line. The programmed action for the gesture line is “send an email to nine listed email addresses.” the gesture line contains nine segments which are represented as nine pictures. When the gesture line is drawn it acts like an arrow. But it can be drawn without hooking back at the end of the drawing stroke to create an arrowhead. It can be drawn just as a line with no arrowhead. In either case, if the gesture line impinges on the correct context object(s) that were programmed for it (in this case “Any digital media”), then a white arrowhead or some other suitable graphic may appear at the tip of the line to indicate that the software has properly recognized the drawing of the gesture line. Thereafter the user clicks on the white arrowhead or its equivalent, and the action that was programmed for the gesture line is carried out by the software. In this case it is the action: “send the impinged digital content to nine email addresses. Note that this task may be carried out using a single user input: drawing the preprogrammed gesture line, and clicking on the white arrowhead.

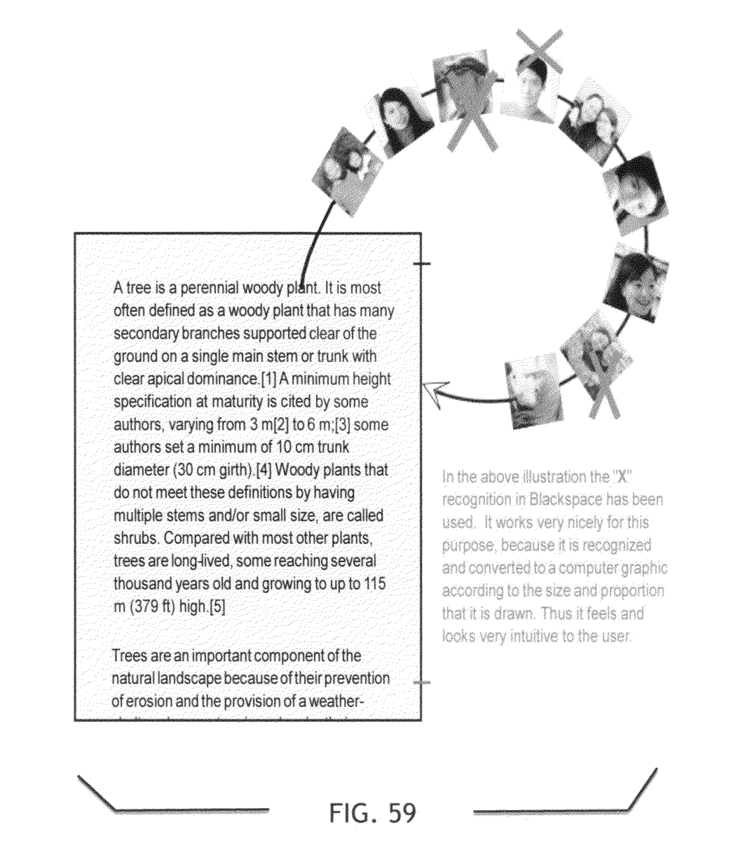

With regard to FIG. 59, the previous example is repeated in terms of the same gesture line used with the same text object. In the description above with regard to FIG. 57, it was pointed out that each of the pictures in the gesture line may be made into on/off switches that are toggled by directly clicking on each picture. If that function has not been programmed, a user may nonetheless select individuals represented in the gesture line as email recipients or non-recipients. One method of making that on/off selection is to click on a picture segment and enter a verbal command, such as “inactive” or “turn off” or the like. A second method is to draw a graphical object, such as the X shown in FIG. 59, directly over any of the pictures in the gesture line to deselect that individual. In both methods, the digital content impinged on by the gesture line will not be sent to the email address associated with the respective deselected picture. In this example, three individuals have been deselected, and six emails will the sent by the gesture line.

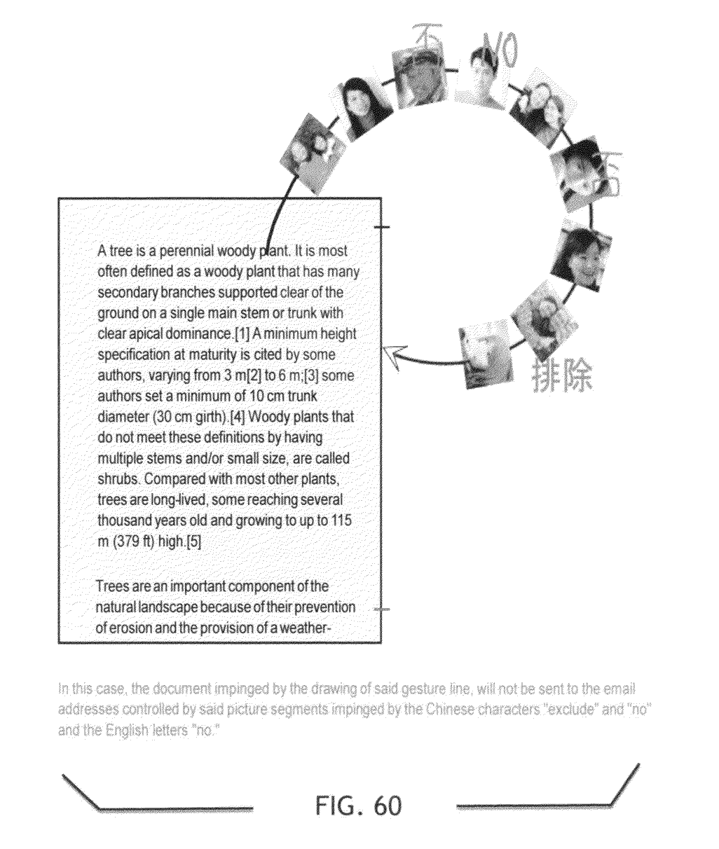

With reference to FIG. 60, in a further illustration of the gesture line of the example of FIG. 59, a text graphic is used to deselect individuals from the picture line style constructed previously. Here the examples of text graphics include Chinese characters or English characters stating “No”, or whatever text input is preset by the user for this purpose. Thus four individuals are excluded as recipients of the email in the layout of FIG. 60.

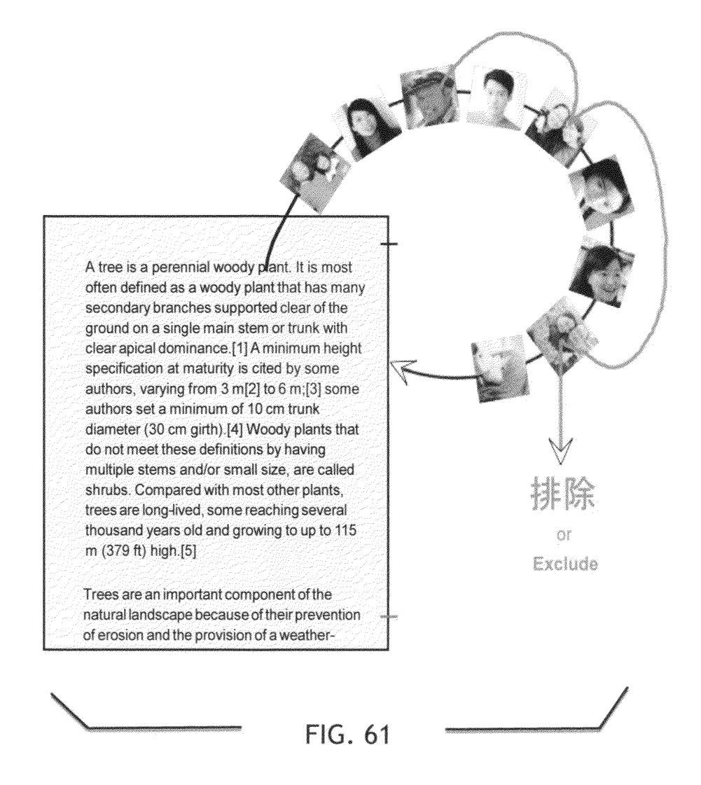

As shown in FIG. 61, another method for excluding (deselecting) an individual from the email process is to use a stitched line. Unlike the stitched line shown in FIG. 56 or 57, the stitched line starts from one picture and loops to impinge on selected other pictures, so that three of the nine pictures are selected. A text cursor appears at the end of the arrow's tip upon mouse upclick or equivalent. Then the user enters a word or phrase to denote exclusion (here shown in Chinese and English characters). The user action to activate the email transmission then comprises clicking on the white arrowhead of the stitched line or the white arrowhead of the gesture line; alternatively, a verbal command may be entered to complete the action. The result is that the text is emailed to the six non-excluded individuals.

With regard to FIG. 62, a further example of gesture line applications describes emailing one or more logs (Blackspace Environments), with the email addresses controlled by the picture segments in the gesture line. This example takes advantage of a powerful feature of Blackspace: the ability to duplicate any one or more “Load Log” entries from a Blackspace load log browser and drag them into either one or more VDACCs or into Primary Blackspace. The key here is that these duplicated entry objects are fully functional, namely, when activated they load a log.

In previous examples, when a user duplicates a load log entry and then clicks on it, the current log is replaced with the log that has been clicked on. This is not desirable, because if a number load log entries have been duplicated, the first click on one of these entries may cause the list to be lost when a new log is loaded. What is needed is the ability to selectively load partial digital content from one log into another.

To email multiple logs to all of said email addresses represented in said gesture line a user would do the following: draw the gesture line to impinge multiple log names that have been duplicated and dragged to the original Load Log Browser, a desktop, a VDACC object, to Primary Blackspace or the like. The advantage of dragging duplicate names into a VDACC is that this VDACC can be used over and over again as a convenient manager of Log Data. Another advantage of this VDACC approach involves a practical issue of drawing a complex line style containing segments that are not particularly small.

If the user desires to stitch with a line that is the size of the picture segments shown in the gesture line in the above examples, the line (a three pixel wide line) which connects the picture segments is not optimal for stitching log entries, which are small text objects sitting closely over each other in a list. If the user creates the list, the user may separate the individual log names to better facilitate stitching them with a very wide line. But it would be far better to just impinge any part of the VDACC containing the list of logs that will be emailed and that would include all of the contents of the VDACC.

The impinging of the VDACC with the line style may be eased without concern for the width of the line style segments. As shown in FIG. 62, multiple LOG names that have been duplicated and dragged from a Load Log Browser into a separate VDACC object. (Note: the drag path is depicted by a blue dashed line.) One advantage of this approach is that the list of logs in the VDACC is free form. They are put wherever a user wants to put them with no organizational requirements. So a user can just keep dragging new log load entries into this VDACC as desired and continue to put them anywhere, even on top of each other. Also, it is very easy to delete any entry or temporarily remove one or more entries from the send email routine just by dragging them out of the VDACC (at the right in FIG. 62) into Primary Blackspace.

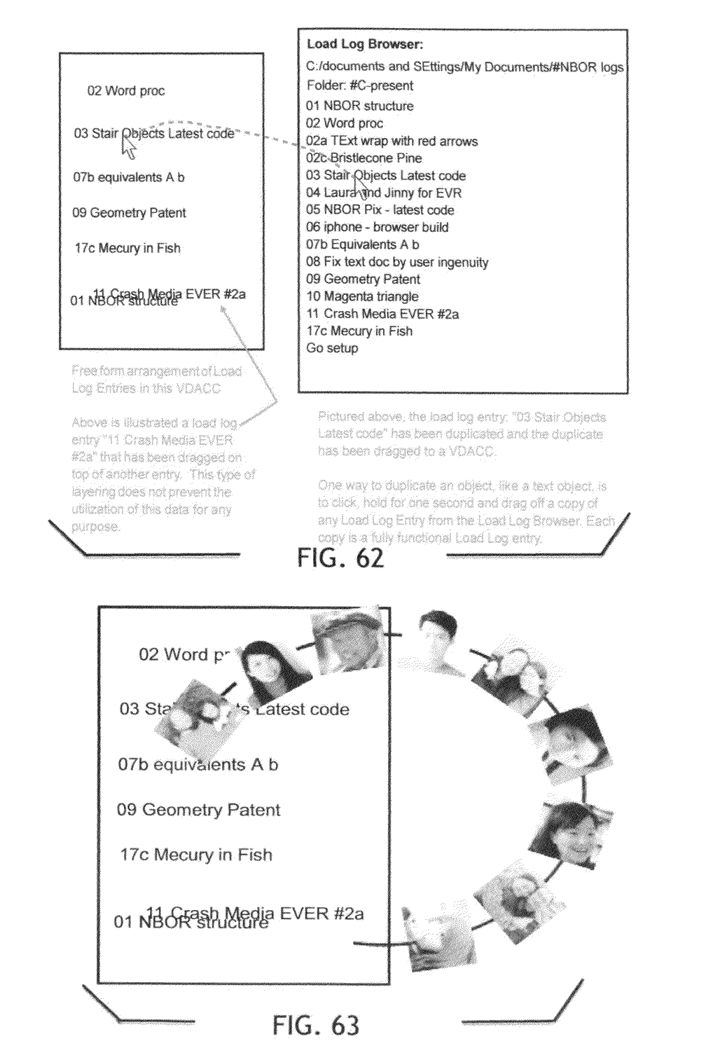

Continuing from the example of FIG. 62, the picture gesture line used previously has been drawn to impinge on a VDACC which contains seven duplicated load log entries, as shown in FIG. 63. No further user action is required, therefore no white arrowhead or its equivalent appears at the head end of the gesture line. Upon the mouse upclick or the like, the following steps occur: all of the contents of the VDACC, including all seven logs and their contents, and links to servers for digital content addressed by the logs, are emailed to the email addresses controlled by the gesture line.

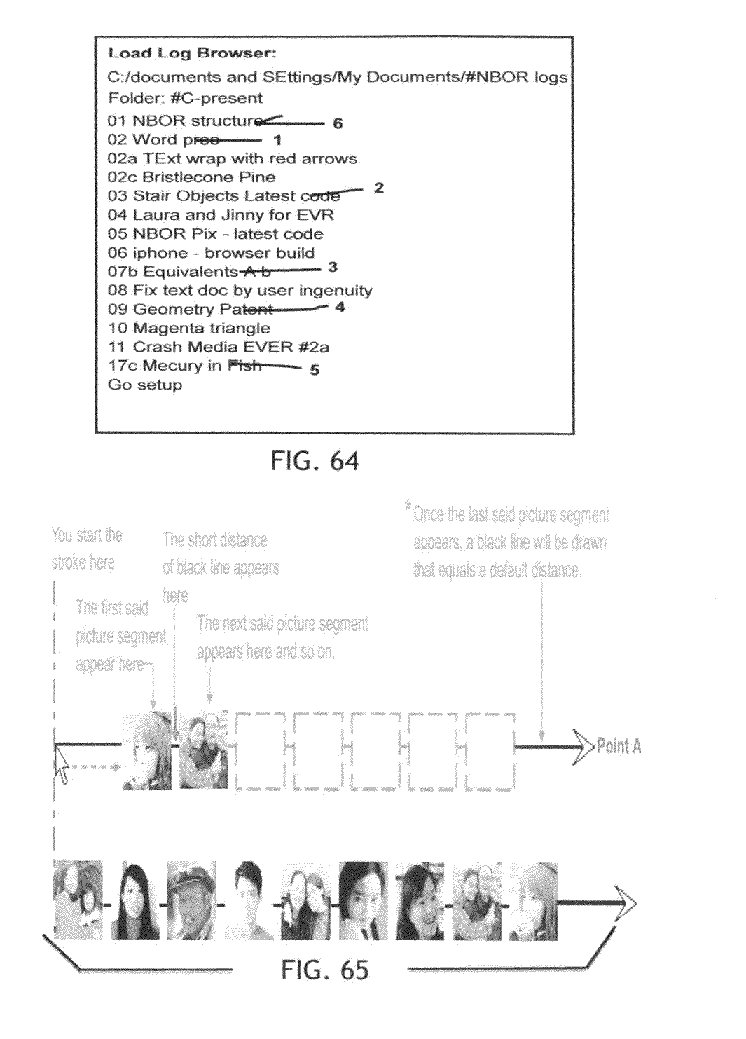

In some circumstances the gesture line of the previous examples may be too high (too wide in terms of point size) to be used effectively in selecting individual entries in a load log browser. The gesture environment provides a tool for addressing this situation. With regard to FIG. 64, the gesture line preferences may be set so that when a gesture line is first drawn it will appear without the segments (the pictures in the examples above) for a preset distance, such as an inch or so. That is, the gesture line appears as a simple black line without pictures, and may be only one or two points wide. In this case, as shown in FIG. 64, gesture lines (e.g., selected from a personal tools VDACC) may be used to select individual load log entries in the Load Log Browser of FIG. 64. A series of non-contiguous gesture lines are drawn, each impinging on a respective Load Log entry in the Browser.

To indicate to the software that the last non-contiguous stroke of the gesture line is drawn with an arrowhead, as shown by the gesture line 6 of the Load Log Browser. If the software has been set to automatically recognize that drawn arrowhead as the prompt to activate the gesture line, then without any further user input the impinged log entries will be sent to the email addresses controlled by the picture segments of the gesture line, as depicted in previous Figures.

With regard to FIG. 65, there is illustrated an example of a user-drawn gesture line that extends beyond a user-defined distance. After that user-defined distance is exceeded the first said picture segment will appear and then the next and so on until all of the segments have appeared (if the gesture line stroke is long enough). NOTE: if the drawn the gesture line stroke is really long, there are many options. Two of them are: (1) The picture segments can repeat again after a length of black line that equals the length of the opening part of the stroke is drawn after the last of the first set of said picture segments. Then the 9 picture segments are repeated. (2) The 9 picture segments do not repeat and just a black line continues as the stroke continues (illustrated in FIG. 65). The length of the black line between each said picture segment can be a set according to a default in a preferences menu, a verbal command, or any other method described herein or known in the Blackspace computing environment.

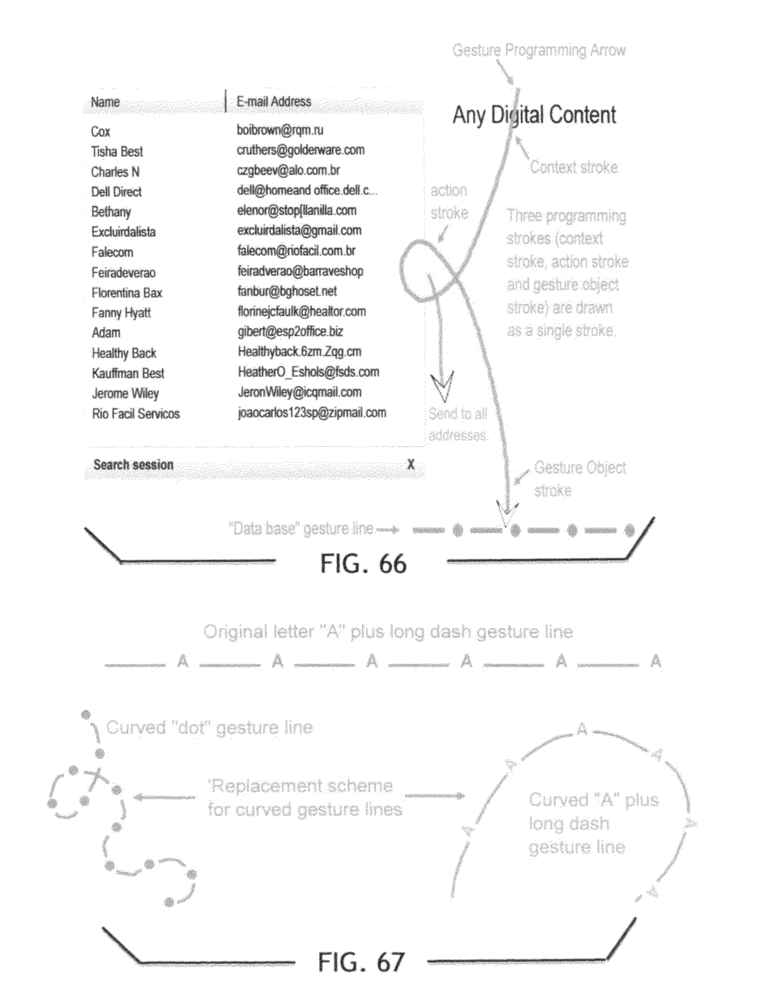

With reference to FIG. 66, in some circumstances a user may desire to create a large “send to” address list, and this entire data base may be assigned to a gesture line as shown in this example. A name/email address list is displayed, and a programming arrow is drawn to impinge on the “context” (in this case “any digital content”). The arrow shaft is drawn to include a loop that impinges on an action (in this case “send to” for an email address book), and to point to a gesture line (in this case a simple line style with no picture segments. Note: it would be possible to draw or otherwise present all three programming strokes as a single stroke. FIG. 66 shows a single “arrow” which has been drawn that includes all three programming strokes for creating a gesture line. The first part of the arrow impinges a context object, the next part of the arrow includes a loop graphic (denoting action) and impinges a VDACC containing an email data base (action directed at VDACC gesture target), and the last part of the arrow points to a graphical line, which is being programmed as a Gesture Line.

The software may not necessarily know to send the Digital Data impinged by the gesture line to all email addresses in the data base. This action could be set in a preferences menu, but that is not intuitive. One approach is to use a verbal command. Another method is to impinge the gesture programming arrow with an assigned-to graphic or another gesture line or the like.

An alternate approach is to impinge the loop part of the gesture programming arrow with a modifier line and type or say: “send to all addresses” or “send to all”, etc. NOTE: one way for the software to know that the data base above is an email address list, is to set the property of a Blackspace address book to be that it can be recognized as an object and utilized for the programming of gesture lines and objects.

Given the illustrations above of gesture lines comprised of a series of pictures, letters and stroke combinations, and the like, it is clear that these gesture lines may be drawn through any arc or curve. However, bending the picture or character components of a gesture line may distort their appearance to the point of being disfigured and disturbing and, ultimately, non-recognizable. Thus there is a need for portraying a complex gesture line (or the progenitor line style) in a manner that enables the user to visualize the elements of the complex line, even when the line describes sharp curves or twists.

With regard to FIG. 67, one example of a process for addressing this issue is to carry out a replacement routine. Given a gesture line comprised of a repeated pattern of the letter “A” and a preceding dash, a large radius curved line (on the right in FIG. 67) may be portrayed without significant distortion of the alphanumeric portions of the line. However, if the line is drawn with multiple small radius curves, as at the left in FIG. 67, the software will substitute dots for the “A” characters to eliminate the severe distortion that would otherwise result.

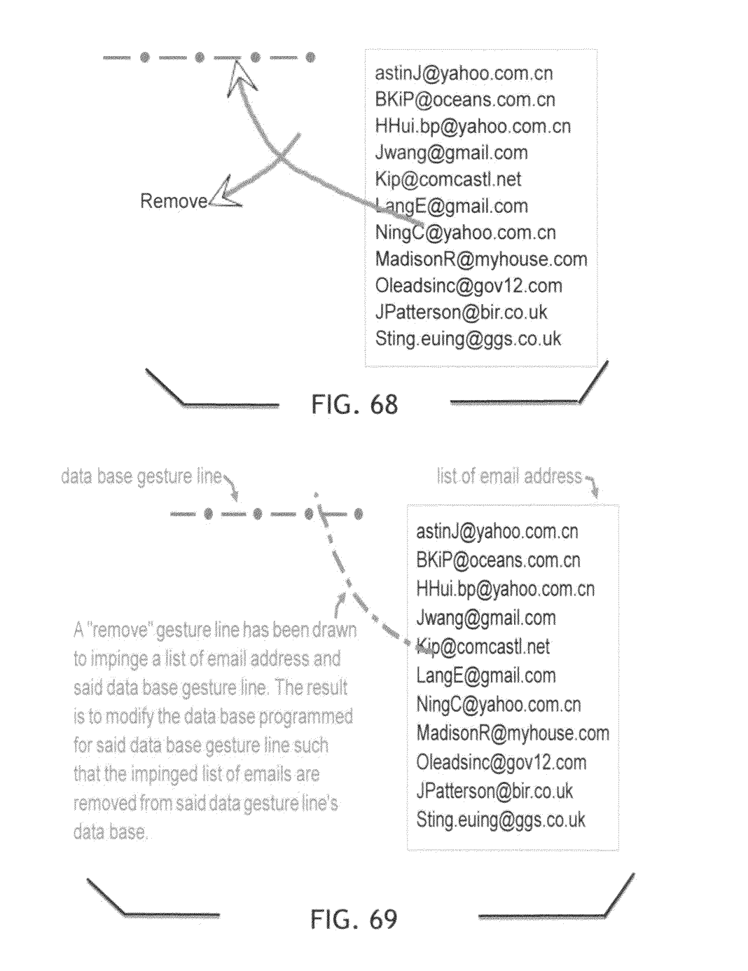

Another method within the gestures environment that may be used for removing digital data that is controlled by a gesture line is simply to drag the individual entries from the data base or address book into a separate VDACC or into primary Blackspace or a desktop or its equivalent. This would involve the click, hold, and duplicate functions. Once the entries are removed from the data base, the user may draw a gesture line that has been programmed to send digital data to everything in a data base or address book; for example, the repeated dot/dash line of FIG. 66. As shown in FIG. 68, the user then draws a modifier line that impinges on both the data base gesture line and the list of data base entries to be removed. This list could be in a VDACC. The user then has two options: 1) draw a second modifier line to impinge on the first modifier line and type “Remove” or “Delete” at the arrowhead, or 2) program the VDACC object with the action “remove” so that anything in the VDACC has the action remove applied to it. Clicking on either white arrowhead invokes the action.

In another illustration of removing data from a planned action, shown in FIG. 69, the same list of email addresses as in the previous Figure is depicted, as is the dot/dash data base gesture line. In this example the user programs the gesture line by drawing a “remove” gesture line (the short/long dashed line) that extends from the list of email addresses to the data base gesture line. The action for this remove gesture line is “remove the impinged digital data listed or contained in this digital object from one or more impinged gesture lines.” The result is to modify the data base programmed for said data base gesture line such that the impinged list of emails is removed from the data base associated with the data base gesture line.

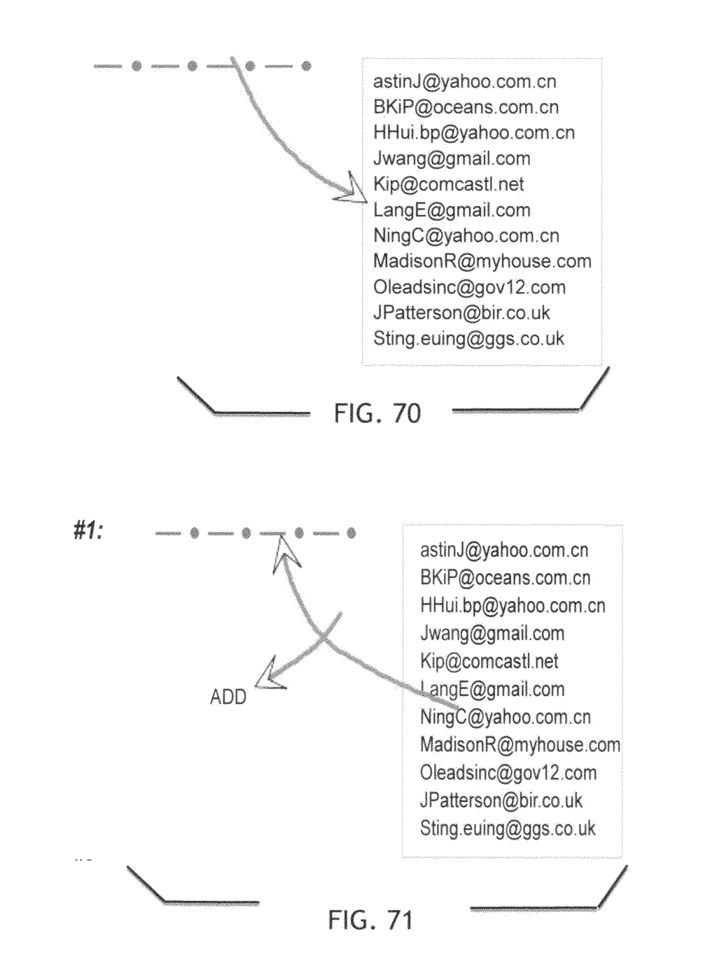

The same result may be obtained by use of a modifier arrow, as shown in FIG. 70. The arrow is drawn from the data base gesture line to the list of email addresses as shown in the previous example. A local or global context may be programmed for the data base gesture line such that any line acting as an arrow that is drawn to impinge on the line and point to any digital content that exists in the data base associated with the data base gesture line shall be recognized and interpreted to remove the impinged digital content from the list of data controlled by the data base gesture line. Other similar techniques known in the Blackspace computer environment may be employed to achieve the same result.

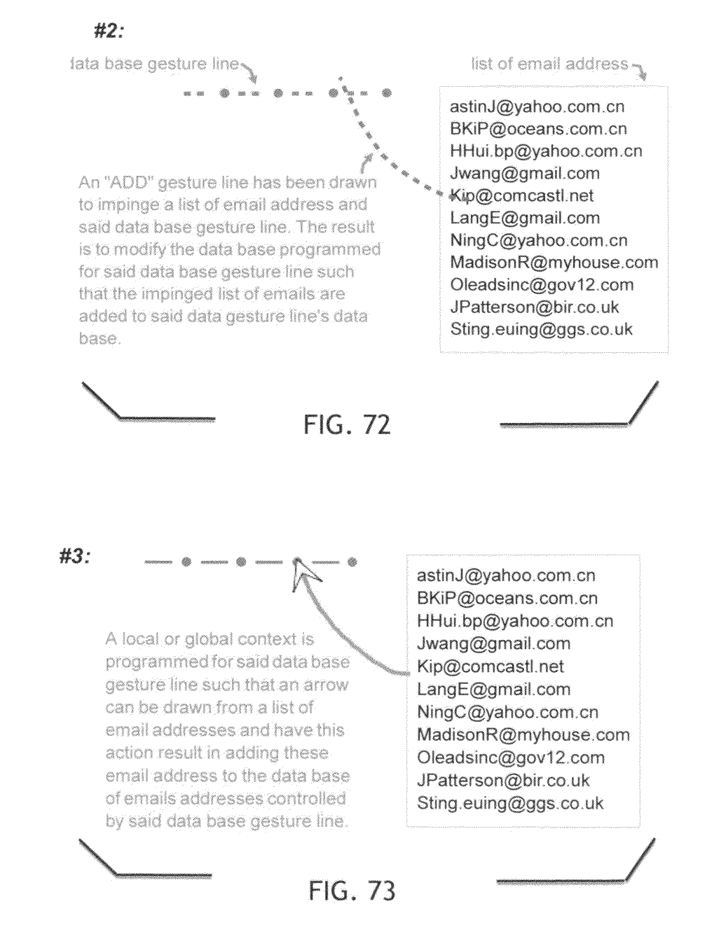

Likewise, it is equally easy to add digital data to the data associated with an existing data base gesture line. Three examples are depicted: in example 1, FIG. 71, a modifier arrow is drawn to extend from the email list to the data base gesture line. The modifier arrow is itself subject to a second modifier arrow drawn through the first with a command “ADD” typed or spoken to program that function for the first modifier arrow. Thereafter clicking on either white arrowhead causes the list of addresses to be added to the data base associated with the data base gesture line. In example 2, FIG. 72, an “ADD” gesture line (here connoted by the short-dash line) has been drawn to impinge on the list of email addresses and the data base gesture line. The result is to modify the data base associated with the data base gesture line by adding the contents of the email list to the gesture line's data base. In example 3, FIG. 73, a local or global context is programmed for the data base gesture line such that an arrow may be drawn from the list of email addresses to the data base gesture line and have the resulting action defined to be the addition of the email list to the data base associated with the data base gesture line.

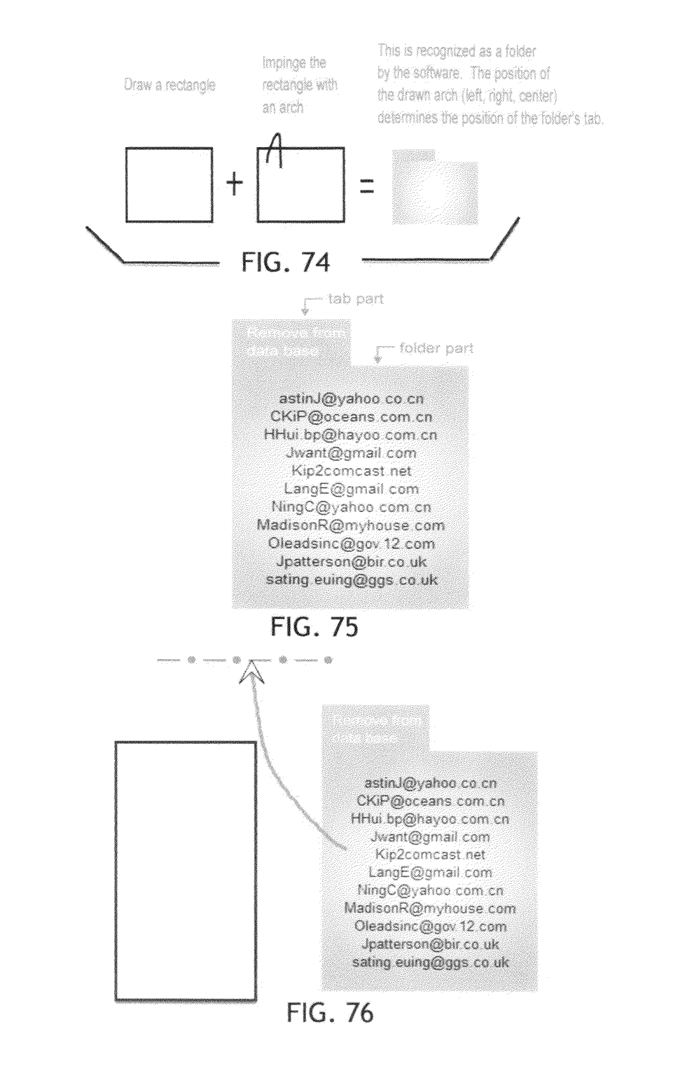

Another approach altogether to the task carried out above is to utilize folder objects. In Blackspace folders can be drawn as recognized objects. These exist as folders with left tabs, center tabs and right tabs. All three of these objects can be drawn as shown: draw a rectangle, intersect an arch figure on the rectangle, and the software recognizes the combination as a folder. As shown in FIG. 74, the position of the arch (left, right, or center) determines the position of the folder's tab, which is then recognized by the software and presented as computer generated graphics. A text cursor may be used to enter text in the tab (or text may be dragged into the tab) to assert actions for the objects that are contained within the folder. The items stored within the folder are shown as a list in the rectangular portion, and may equivalently be shown as pictures, icons, symbols, or the like. The cursor may also be used to enter text or data in the rectangular portion.

Thus, as shown in FIG. 75, The rectangular portion of the folder contains an email list (generically, a data base) and the tab portion has been given an action by receiving the text “Remove from data base”. Thereafter, as shown in FIG. 76, a red arrow may be drawn from the folder to the data base gesture line. Since the arrow is pointing to the data base gesture line the email entries contained in the folder are removed from the data base associated with the data base gesture line. And, clearly, adding an email list from a folder would involve only typing a new action in the folder tab: “ADD” or “Add to data base”, and then proceeding with the red action arrow as before.

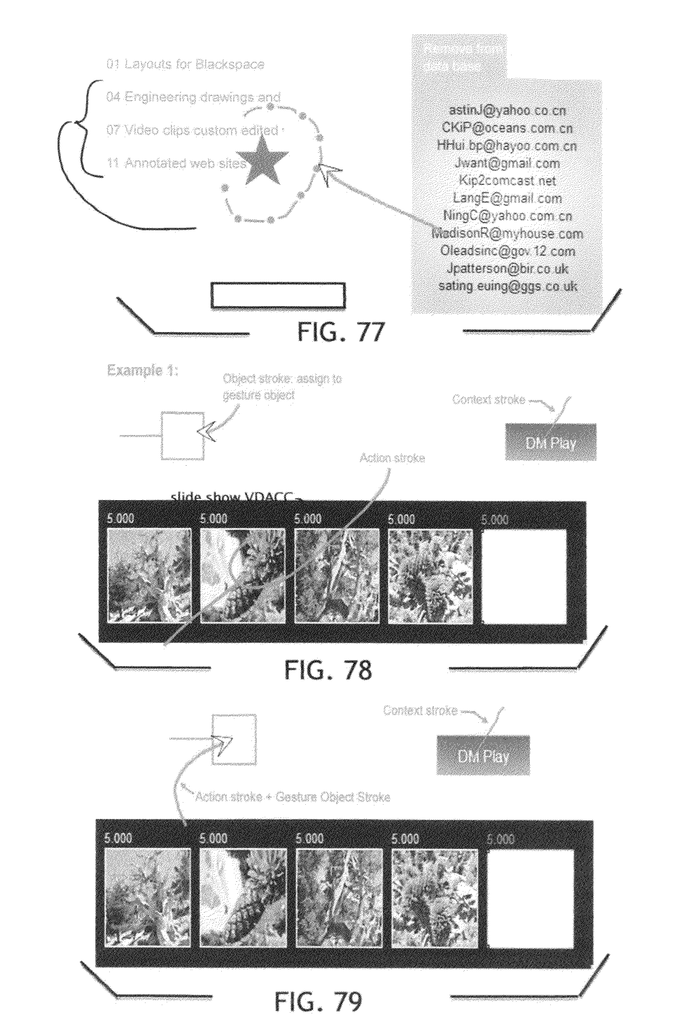

With reference to FIG. 77, there is illustrated one technique for undertaking multiple operations at once using a gesture line. A folder containing an email address list is tab-labeled with the action “Remove from data base”. A green star is also displayed, and it has four pieces of purple text assigned to it that are various Blackspace environments. A user may encircle the dark green star with the data base gesture line to command that all of the digital content contained in the four purple text Load Log entries will be emailed to all email addresses in the data base associated with the data base gesture line. The user then draws a red arrow from the folder contents to the data base gesture line to command that the “Remove from data base” action of the tab is applied to the data base of the data base gesture line, with the result that the folder's email list is removed from the data base of the gesture line. The email procedure then is carried out.

In a further example of gesture line utility, shown in FIG. 78, a slide show has been assigned to a gesture line. An arrow is drawn to impinge on the slide show VDACC, and the loop in the arrow enables software to recognize it as an action stroke. The context stroke (connoted by color, etc.) is drawn to impinge on a Dyomation Play switch. The action stroke is drawn to impinge on the active slide show as presented in the slide show VDACC. Then an object stroke is drawn to point to a gesture line that is comprised of a horizontal line and an image box. Then when the user clicks on the white arrowhead of the object stroke, the action is implemented and the slide show is assigned to the line/picture box line style.

A further refinement of this technique is shown in FIG. 79, where the slide show VDACC and gesture line style are the same as previously. In this procedure, the user may draw an arrow from the slide show VDACC only (not impinging on any slide pictures in the VDACC). This arrow assigns all of the contents of the slide show VDACC to the gesture line. Then when the user clicks on the white arrowhead of the action stroke, the action is implemented and the slide show is assigned to the line/picture box line style.

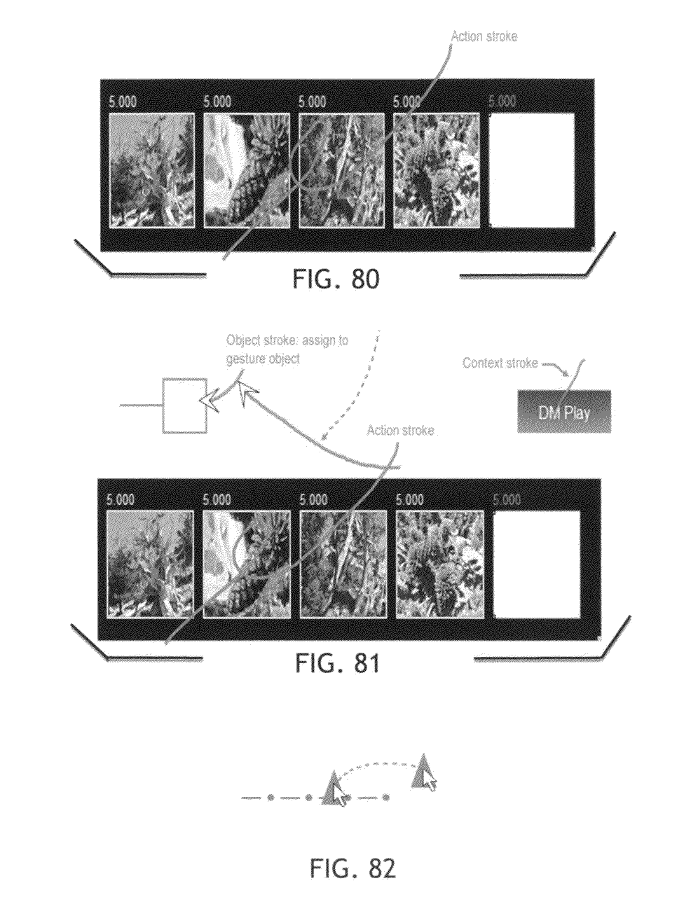

In the illustrated methods of FIGS. 78 and 79, they both make use of a special recognized object, the line/box line style. This object may have one or more behaviors programmed for it, which may include one or more actions and one or more contexts associated with those actions. Thus any one or more of this object's actions may be invoked when this object is utilized in a particular context; that is, a context that causes one or more of the actions programmed for this object to be called forth or invoked. With regard to FIG. 80, one such context may have two parts. A gesture programming arrow's action stroke is drawn to impinge on at least one object that defines an action causing a sequential action of two or more objects. In FIG. 80 the action stroke traverses three slides in the show, and these three will be shown in the sequence they were contacted by the action arrow.

The second context associated with this complex object may be set by an object stroke, as depicted and described in FIG. 78. The object stroke points to the composite object having one or more behaviors assigned to it, which can include one or more actions and one or more contexts associated with those actions. The consequence of the utilization of the above described composite object in the presence of context one and two as described above, is that the list of slides in the Slide Show VDACC are presented as a string of gesture line picture segments. As part of a Global or local setting or individual object setting, a 3 pixel wide black line will be used to connect the picture segments in the slide show gesture line. In this regard the gesture line has the appearance of the email address/picture gesture line of the examples in FIGS. 51- 65. The object stroke combined with a gesture object may be seen as a more general case of the earlier picture gesture line.

One or more Global Gesture Line settings can exist which can govern the layout, behavior, structure, operation or any other applicable procedure or function or property for a Gesture Line. These settings can determine things like, the type of line that connects gesture line segments. If a gesture line has been programmed to be a certain type of line, i.e., a dark green dashed line, then if segments are added to this gesture line, the connecting line will continue to be what was originally programmed for the gesture line, in this case, a dark green dashed line. But if a composite object is used as the target for the Gesture Object Stroke of a gesture programming arrow, then a Global, local or individual setting may be needed to determine what properties should exist for the line connecting the segments in the resulting programmed gesture line. In this case, to set a global, local or individual setting, a user could select from a range of choices in a preferences menu or use a drawing, verbal, context or other suitable means for defining such settings for a gesture line to be programmed.

Returning to FIG. 78 and the process of programming the composite object to become a gesture line, the following are two conditions that can be implemented.

1. The number of slides that exist in the slide show VDACC that was impinged by the action stroke of the programming gesture line will be presented in a single gesture line.

2. Each picture existing in the Slide Show VDACC, impinged by the action stroke of the gesture programming arrow, will be presented as separate picture segments in the gesture line.

Each of the gesture line picture segments may have an action, function, operation, association, or the like, that is implied, user-designated by some user input or action or controlled via a menu, like settings or preferences menu.

Such actions or functions, etc. may include but are not limited to any of the following: the playing of the slide show, enabling any alteration in the audio for one or more slides in the slide show, enabling any change in the image for any one or more slides in the slide show, enabling the insertion of another slide into the slide show gesture line (which could insert that picture in the slide show controlled by the gesture line), deleting any one or more slides in the slide show gesture line (which could delete one or more slides from the slide show controlled the slide show gesture line), creating an association between any one or more picture segments in the slide show gesture line and another object, like a web page or picture or document, video, drawing, chart, graph and the like.

With regards to a gesture line that controls, operates or otherwise presents (“presents”) a piece of digital media, that gesture line can be linked to the media it presents. With this relationship, if at any time the digital media “linked” to a gesture line is changed, the gesture line can be updated accordingly. For instance, if a gesture line is “presenting” a slide show and the number of slides in the Slide Show is added to, altered or changed in any way, this could likewise change the gesture line that has been programmed to “present” that Slide Show. For instance, if the number of picture slides is increased in the slide show, then the number picture segments in the gesture line presenting that slide show could be increased by the same amount, and the new pictures would be added to the gesture line as new picture segments.

As a further example of the description above, FIG. 81 repeats the layout of FIG. 80 and depicts one method for programming a link between digital media and/or data and a gesture line. A modifier arrow is drawn from the action arrow to the object stroke that impinges on the gesture object. The modifier arrow creates a link between the digital content (in this case the slide show) and the gesture line. The modifier that has been drawn in this context may create the link without further user input. Alternatively, some type of user input may be employed, such as typed text (“link” or “link to digital media”, etc.) In another alternative, a graphic object such as another gesture line may invoke the action, link, or the like.

As shown in FIG. 82, a graphic object or gesture object may be dragged to intersect a gesture line. The graphic object is set to invoke the action “link to digital media” or the equivalent. Note the simplicity of this technique, in which a single drag and drop completes the entire process of linking the slide shown to the gesture line.

In the illustrations above showing the programming of a slide show gesture line, the context object is the DM (Dyomation) Play switch. This requires that in order for the slide show gesture line to present its digital media it must be drawn to impinge a DM Play Switch. One reason for this is that a user may have a number of different slide show gesture lines in their Personal Tools VDACC. The user may click on one of these slide show gesture lines and draw it to impinge a DM Play switch and that would validate the gesture line—it would be ready to be used or could automatically be activated by its drawing to impinge its target object—the DM Play Switch. NOTE: the use of a gesture line that calls forth a slide show or any media or presentable computer item (i.e., video, animation, charts, interactive documents, etc.) can be activated by the impinging of any suitable context that can be programmed for that gesture line.

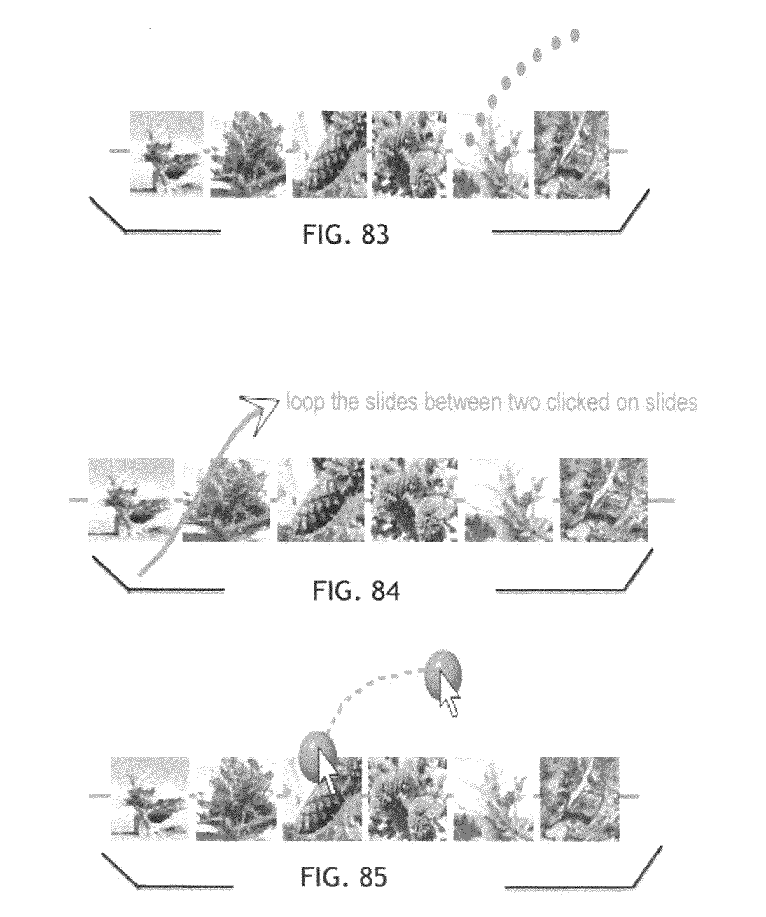

Once a gesture line is created, there are many techniques for modifying its context. In one example, shown in FIG. 83, a gesture line, comprised of a series of closely spaced dark green dots, is drawn to impinge on a slide show gesture line. If the action for the green dot gesture line is “change the context of a gesture line to ‘anywhere in blank space’”, then the green dot gesture line will change the context of the slide show gesture line to “anywhere in blank space”. Thereafter this particular slide show would no longer need to be drawn to impinge on a DM Play switch. Rather, it may be drawn anywhere in a digital environment where it does not impinge on an object and it is a valid action, invoked immediately.

A gesture line may be selected by any means and then a verbal command may be uttered, recognized by software, and, if it is a valid command for changing the context of the gesture line, entered at the appropriate cursor point of the gesture line.

As shown in the example of FIG. 84, a modifier arrow can be used to modify a gesture line in an almost endless number of ways. For example, a modifier arrow is drawn to impinge on a slide show gesture line. After the arrow is drawn, a text cursor appears automatically, and the user types modifier text or enters the text verbally or by some other suitable means. Here the slide show gesture line has been modifier enabled to loop the slide show between two clicked on slides. The user then clicks on any two slides visible as picture segments in the gesture line and the loop will be created. Then when the slide show plays it will loop between the selected slides.

FIG. 85 depicts a further example for modifying the context of the slide show gesture line. It takes advantage of the fact that an object can be used to modify a gesture line. Here, a teal colored gesture object (a ball) has been programmed with the action “create one second cross fades between all slides”. The ball is dragged to impinge on a slide show gesture line. Upon the mouse upclick or upon impinging one of the slide show gesture picture segments, the teal ball gesture object's action will be applied to the slide show gesture line and to the slide show that it presents. Thereafter the side show will incorporate a one second cross-fade between sequential slides.

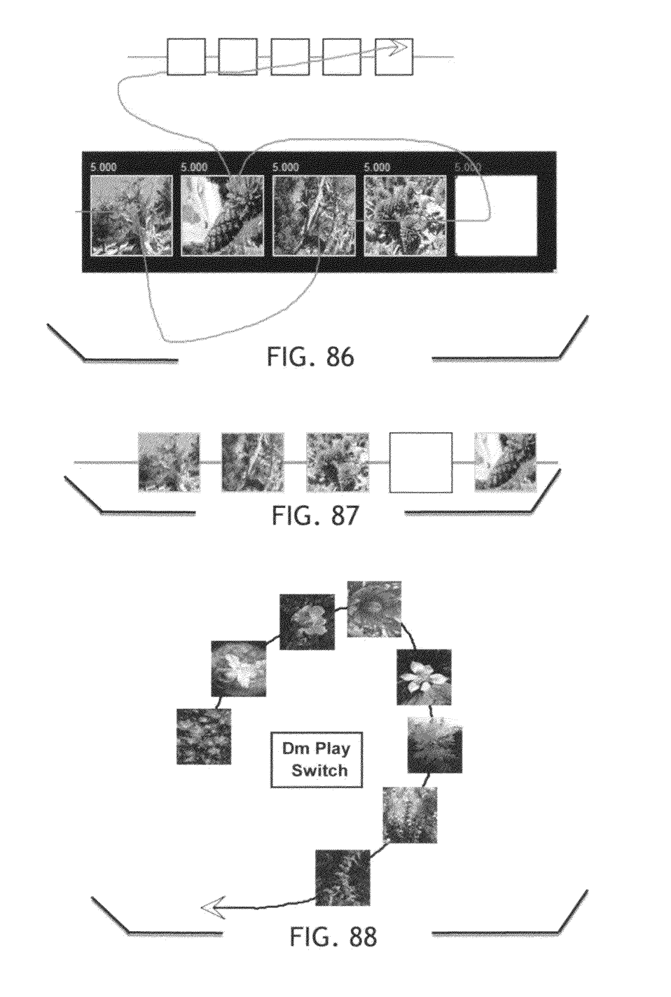

With reference to FIG. 86, a gesture line is shown that is comprised of a plurality of line segments separating adjacent boxes that each represent a VDACC. A single action arrow is drawn by the user to have inflection portions (sharp changes in direction) that each impinge on a respective slide in the slide show gesture line. The head end of the action arrow passes through all of the boxes in the gesture line. The result of this single arrow is that the slides impinged on by the inflection portions are selected in the order they are encountered by the line, and these selected slides are assigned in their specific order to the VDACC segments of the gesture line. The resulting gesture line, shown in FIG. 87, clearly displays the slides in the selected order.

In the example of FIG. 88, a line style comprised of a series of picture segments joined by line segments is not programmed as a gesture line. In this case, however, the line style is drawn to impinge on a DM Play switch by substantially surrounding the switch. This situation is a particular context that may be a setting in a Global preferences menu or the like stating that if a line style containing multiple picture segments is drawn to impinge a DM Play switch, the picture segments in that line style are to be presented as a slide show. In this case, the simple act of drawing a line style in this context (impinging a DM Play switch) causes the drawn line style to be programmed with an action. This programming may be automatic, i.e., upon a mouse up click or its equivalent, the action is programmed for the line style, or some user input may be necessary in order to apply the action to the line style. One such condition could be having a white arrowhead appear on the end of the line style, after it has been drawn in the context shown below. The user would then need to click, touch or the like on the white arrowhead to activate the action for the line style.

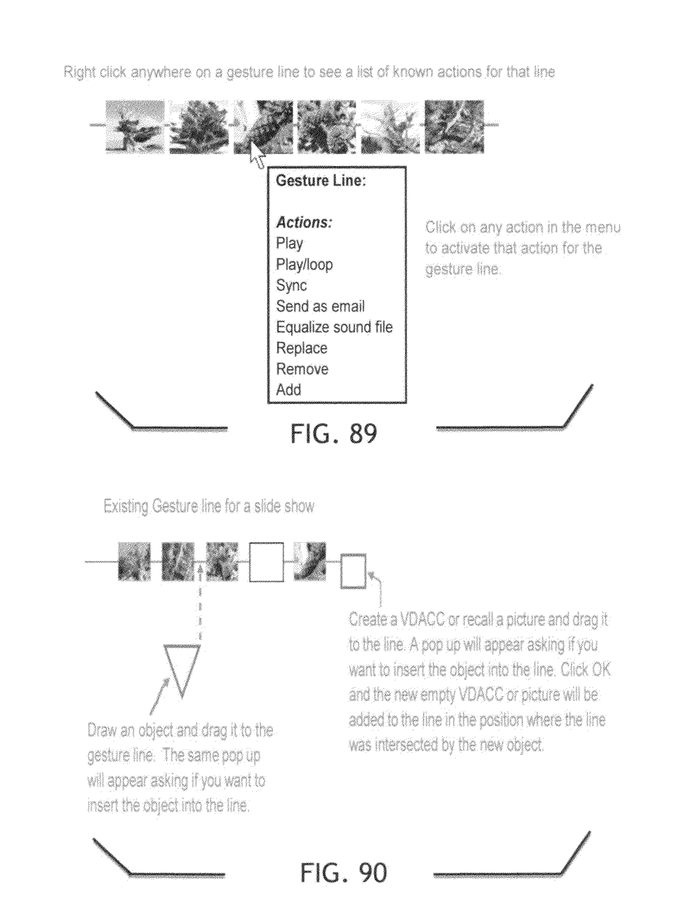

A gesture line may also be modified through the use of a menu, as shown in FIG. 89. A user may right click (or double click) or otherwise cause a gesture line to call forth a menu (an Info VDACC) or other visual representation that lists known actions for that gesture line. Thereafter clicking on any listed action invokes that action for the gesture line. It is possible that a gesture line may include a large list of actions, and the Info VDACC may be too large to be practical. A solution to this could be a modification to the Info Canvas which would provide an IVDACC that could address an entire data base of options. Then a user could right click on any gesture line and access any number of actions that could be categorized and searchable.

An action for a gesture line may be set by dragging an object that is an equivalent of an action to impinge on a gesture line. Any text object or recognized graphic object or even a line that has a specific type of functionality assigned to it could be used for this function. The resulting action from the dragging of the object depends upon what was programmed for the object being dragged. To tell if the drag was successful, one approach would be to have the dragged object snap back to its original position before being dragged upon a mouse upclick or its equivalent. If the dragged object does not snap back as just described then its programming was not successful. The resulting action for the gesture line would, of course, depend upon the nature and type of action programmed for the object being dragged to the gesture line.

The gesture environment also provides various techniques for modifying the digital media presented by a slide show gesture line. One technique involves automatic updating of the slide contents. When a user adds more slides to the slide show that can be presented by a slide show gesture line, the new slides or any changes to the existing slide show get added to the gesture line automatically. One way to accomplish this is to use a preference menu. Such a preference menu entry may be: “Any change to slide show will automatically update the gesture line presenting that slide show.” This updating of the gesture line could be in two categories: (a) visible changes made to the gesture line's segments, e.g., add or subtract picture segments and/or make changes to existing picture segments, and (b) update the presenting of the digital media by the slide show gesture line, e.g., present more or less slides in the slide show or present different slides or music, or any other change made to the slide show. This automatic update feature may be applied to the gesture line in other ways. This includes but is not limited to: via a verbal statement, i.e., “turn on automatic update,” by dragging a text object, e.g., “automatic update” to impinge a slide show gesture line, or by drawing a modifier arrow pointing to a slide show gesture line and typing “automatic update” or “auto update” as a definition for the modifier arrow. These techniques have been elucidated in the previous examples.

Another method for modifying the digital media content of a gesture line is illustrated in FIG. 90. An object (here a green triangle) is drawn by the user and dragged to impinge on the gesture line of the slide show of FIG. 87. The same popup menu as in FIG. 89 is invoked, offering the user the opportunity to insert the object into the gesture line. Alternatively, the user may draw or recall a VDACC or recall a picture and drag it to the line. The same popup menu is displayed to enable the user to insert the object into the gesture line. Clicking OK invokes the action and the new object or VDACC or picture is added to the gesture line in the position where the line was intersected by the new object.

With reference to FIG. 91, another method for modifying the digital media content of a gesture line is illustrated. A gesture line can be used to insert objects into another gesture line. To accomplished this a user draws the “insert” gesture line from any one or more objects and uses the “insert” gesture line to impinge on another gesture line at any point where an insertion is desired. By this method a user may insert many objects all at once into a gesture line. A convenient way to have access to multiple gesture lines as tools is to keep them in a personal object such as a VDACC that has each gesture line draw in it, similar to the Line Style Tools VDACC shown in FIG. 47. To use any of the gesture lines, click on it and then draw. The modes necessary for drawing the gesture line will be automatically turned on to enable immediate drawing of the gesture line. In FIG. 91 an “insert” gesture line, connoted here by the dot/dot/dash blue line) is drawn to stitch four picture objects (arrayed horizontally along the top) into insertion positions in a slide show gesture line. These insertions act to add picture segments to the slide show gesture line and add slides to the slide show presented thereby. The insertions are invoked when the user clicks on the white arrowhead of the insert gesture line.

FIG. 92 illustrates a Personal Tools VDACC (“PT VDACC”) that displays a variety of line styles. A user may touch any line in the PT VDACC and it is selected and ready to be drawn by the next user input stroke. In addition, the PT VDACC displays a pink sphere that is an assigned-to object, wherein an action list (shown at the right of the Figure) is associated with the pink sphere. In one technique, an assigned-to object (like the pink sphere in the example above) can be used for recalling a list of actions that are known to the software and that can be used to program a gesture line or a line style. In one embodiment, to select an action in this list the user clicks on the action and the name of the action will turn green (“on”). In FIG. 92 the entry “insert” has been turned on by this method. This “insert” action will then will be automatically applied to any gesture line (or line style) that is selected. Alternatively, the user may type the name of any known action in blank Blackspace and drag it to intersect any selected line style in the Personal Tools VDACC. Or, after selecting a line style, the user may verbalize the name of the action to be applied to that line style. Another option is to drag the name of a known action to intersect a gesture line or line style in a computer environment. The dragged name will snap back to its original position if it is a valid action for the line it has impinged and has successfully programmed the line style with an action.

It is also possible to duplicate an existing slide in a gesture line by using the standard Blackspace duplication technique: click on the slide, hold, and drag a copy to another location in the line (or anywhere in Blackspace). The copied slide will be inserted at the dragged-to position.

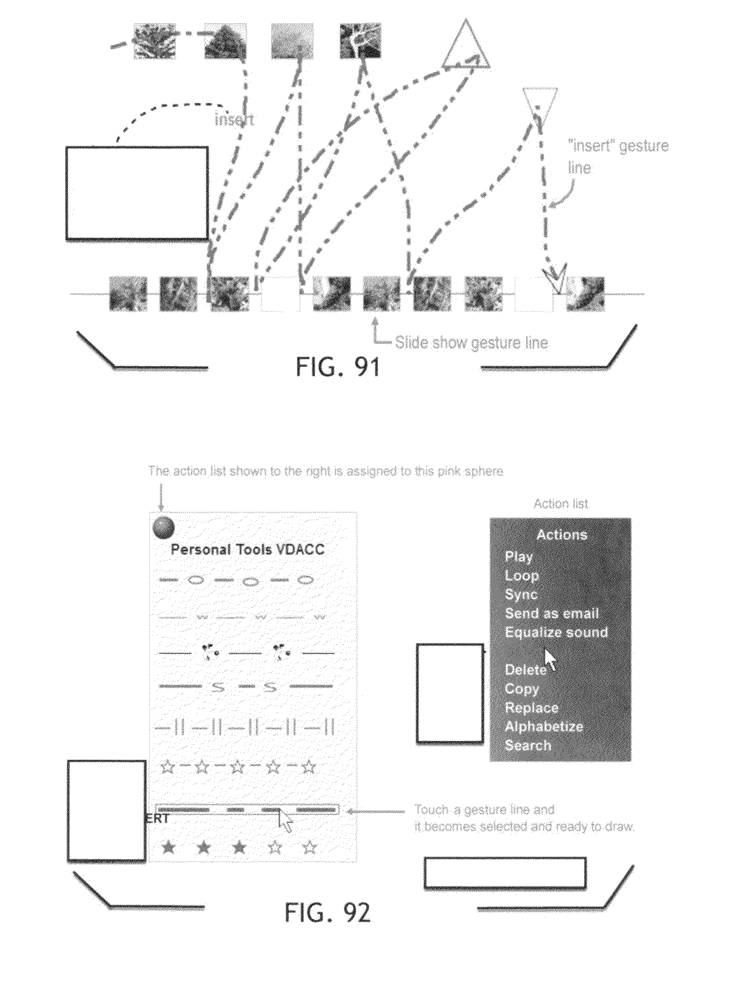

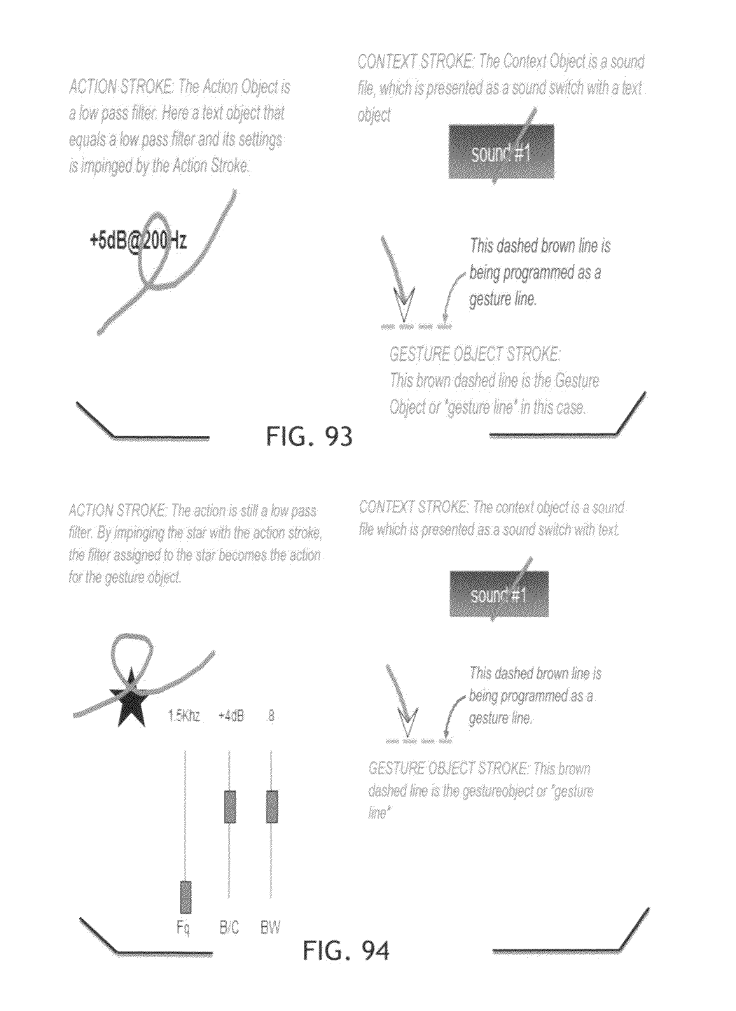

Gesture lines are also extremely effective for handling actions involving audio files. Gesture lines may be used to present all types of audio configurations, including mixers, DSP devices, individual input/output controls, syncing, adding audio to pictures, slide shows animations, diagrams, text, and the like. With regard to FIG. 93, one example includes an action object, in this case a text object stating a low pass filter parameter and its setting. The context object is a sound file (sound #1), and the brown dashed line is the gesture object or gesture line in this case. The user draws an action stroke to impinge on the low pass filter, the action stroke being identified by the loop in the shaft thereof. A context stroke is drawn through the sound#1 object, and the gesture object stroke impinging on the brown dashed line programs the dashed line as a gesture line. The result of these user actions is that the brown dashed line is programmed to be a low pass EQ gesture line.

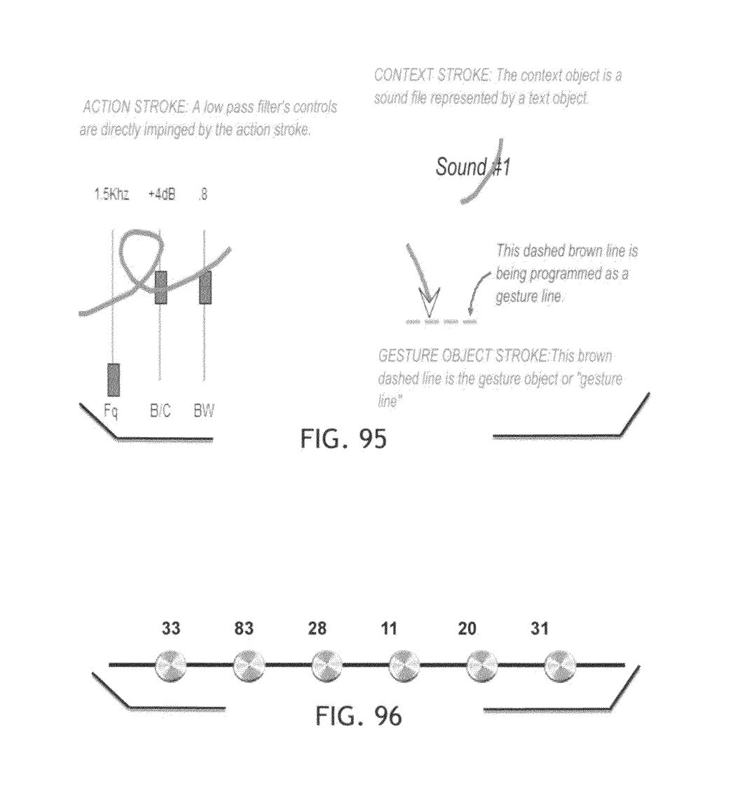

In the audio example of FIG. 94, the action is once again a low pass filter, and the context stroke and gesture line are the same as the previous example. Here the user draws or recalls a black star adjacent to the low pass filter fader settings layout, and draws the action stroke through the black star. The result of this is that the filter assigned to the black star becomes the action for the brown dashed gesture line. A similar technique is illustrated in FIG. 95, where the action stroke is drawn through the low pass filter fader settings, and the context stroke is a text object labeled “sound#1”. The result of these user actions is that the brown dashed line is programmed to be a gesture line that invokes a low pass EQ wherever it is drawn to impinge an audio file.

A visually interesting example of a gesture line in an audio use, shown in FIG. 96, is a line comprised of a plurality of knobs joined by line segments to form a line. Referring to the three audio examples above, rather than programming a dashed line, a line with knobs as its segments is drawn or recalled and programmed as the low pass EQ gesture line. In this low pass EQ gesture line the knob segments are operational controls for the low pass EQ. To use this gesture line, a user draws the EQ gesture line to impinge on any sound file and the EQ controlled by the gesture line would be applied to that sound file. Furthermore, the knobs in the EQ gesture line are active controls and may be used to adjust the low pass EQ's settings at any time, and these altered settings alter the

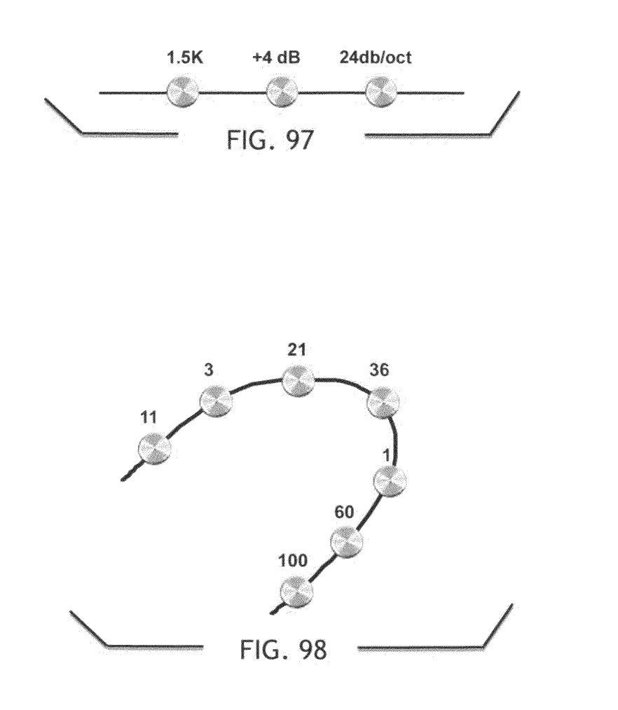

EQ that is applied to the sound file impinged by the EQ gesture line. The EQ gesture line may appear as shown in FIG. 97. Each knob is used to adjust an EQ parameter (frequency, boost/cut, and slope).

With reference to FIG. 98, having knobs in a gesture line lends itself well to drawing a curved gesture line. Note that the knobs maintain perfect vertical orientation regardless of the curvature of the gesture line in which they are segments. This permanent vertical orientation enables the user to read the settings easily and manipulate the knobs to change the settings as desired. Any function may be assigned to any of the knobs, so that they may control DSP, video, picture editing, positioning or anything that may be controlled with a number setting.

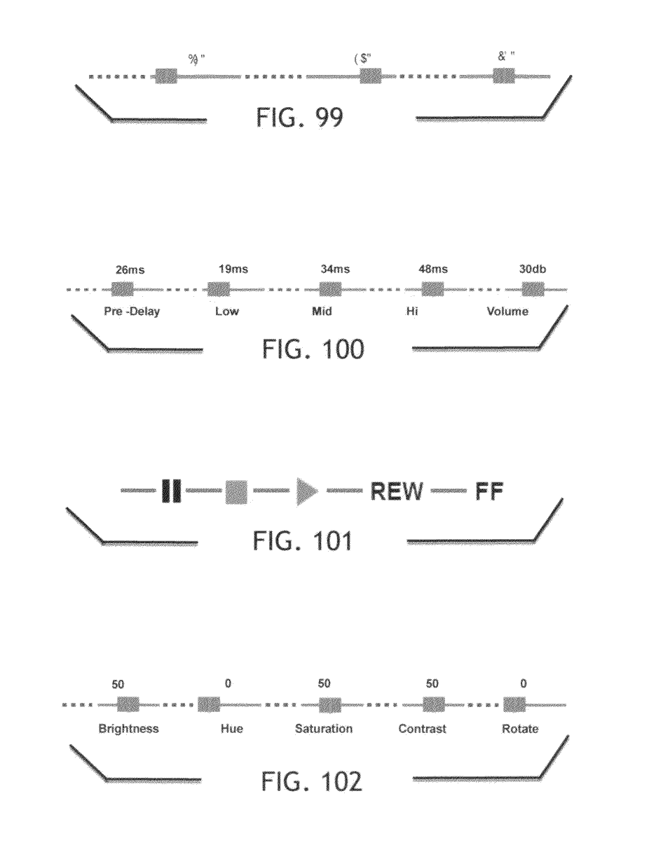

Continuing in the audio environment, gesture lines may incorporate as segments a plurality of fader controls, as shown in FIG. 99. Unlike the knobs examples above, fader controls to not lend themselves well to curved drawn lines, and are therefore best suited for vertical and horizontal lines. A user may store a variety of knob and fader gesture lines (“device lines”) in or assigned to an object, like a Personal Tools VDACC or a star. Then a user may click on the “device line” they wish to use and draw it such that it impinges on one or more objects and/or digital media and/or devices (“objects”). Upon doing so, the actions, functions, operations, and the like controlled by the devices in the device line just drawn are applied to the objects impinged on by the gesture line.

With regards to audio, one could have any type of EQ, echo, compressor, limiter, gate, delay, spatializer, distortion, ring modulator, and so on controlled by any number of gesture lines, whose segments are devices. In other words, entire DSP controls may be presented in a single gesture line. To EQ a group of audio inputs, for instance, one needs only to draw an EQ device gesture line to impinge on one or more of these audio inputs. Then the EQ controlled by the knobs, faders, joysticks, etc., in the line will be applied to the audio inputs. If one wished to adjust the settings of the EQ controlled by the drawn gesture line, the controls in the line could be adjusted to accomplish this. NOTE: Line styles can also be used with device segments. But line styles generally have no actions associated with them, so the devices contained within such line styles would need to be assigned or programmed to control digital media, via a voice command, one or more arrows, gestures, contexts and the like. With these added operations, such line styles could be used to modify digital media, data, graphic objects and the like.

The numerical parameters for these line segment devices may be shown above the devices as illustrated in FIGS. 99 and 100. Or these numerical parameters may be presented in a menu, i.e., Info Canvas, for each device or they may be shown or hidden by some method, like double clicking on the device or on the line to show the numerical parameters and then repeating the process to hide them.

One gesture line can have multiple actions and visual representations depending upon its use in different contexts. The same gesture line can be programmed to have different actions when it is drawn in different contexts. For example a simple solid green line may be programmed to control echo when it impinges a sound file, become play controls for video when it impinges a video, and become picture controls when it impinges a picture. Also, the gesture line changes its shape and/or format based upon the context in which it is drawn. For instance, when a simple green gesture line impinges a sound file, it changes to a different looking gesture line, which includes a set of echo controls as shown in FIG. 100.

A simple green gesture line that has audio action may change appearance to that shown in FIG. 101 when the gesture line is drawn to impinge on a video file, so that it displays line segments that comprise active video controls (pause, stop, start, rewind and fast forward). However, if the same green gesture line is drawn to impinge on a picture, its appearance changes, as shown in FIG. 102, so that the line segments comprise active picture parameter controls, such as brightness, hue, saturation, contrast, and rotation.

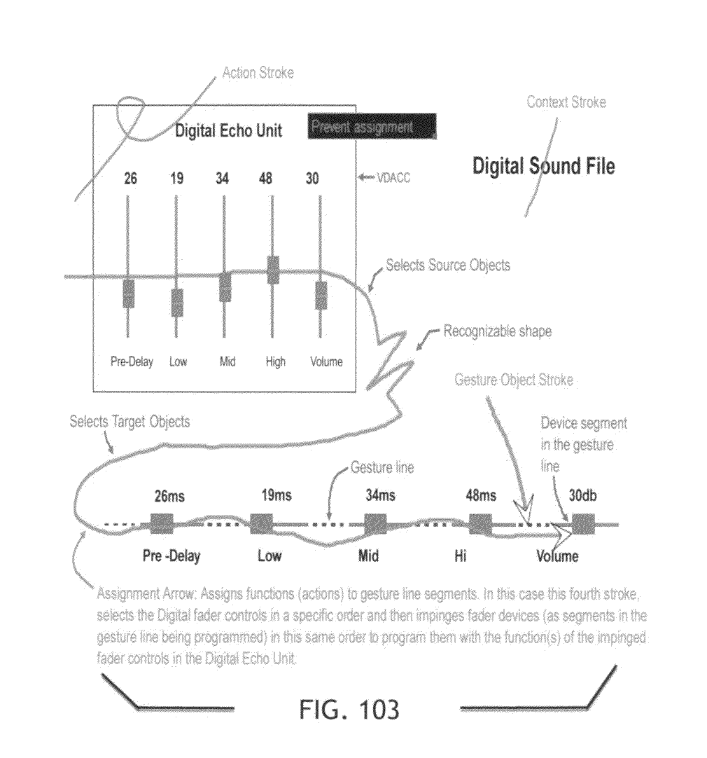

In the audio environment example of FIG. 103, there is displayed a

Digital Echo Unit having five fader controls to control the echo effect. The context is a text object stating “digital sound file”, though it could be a sound file list, a sound switch or an equivalent. The user draws an action stroke, denoted by the loop in its shaft, to impinge on the digital echo unit, and a context stroke to impinge on the context “digital sound file”. A gesture object stroke is drawn to impinge on the fader element gesture line. The user also draws a gesture target stroke that extends from the digital echo unit and is provided with a recognizable graphic element (here, the scribble element “M”) before it passes through the fader control segments of the gesture line. The scribble element is recognized by the software to separate the source objects of the arrow and the target objects of the arrow. The gesture target stroke commands that the digital echo unit fader control parameters are applied to the fader controls of the gesture line, in the same order as they are contacted by the gesture target stroke. When the white arrowhead of the gesture object stroke is clicked on, the gesture line is thereafter programmed with the digital echo faders and settings. Of course, these faders are active control elements and may be varied by the user.

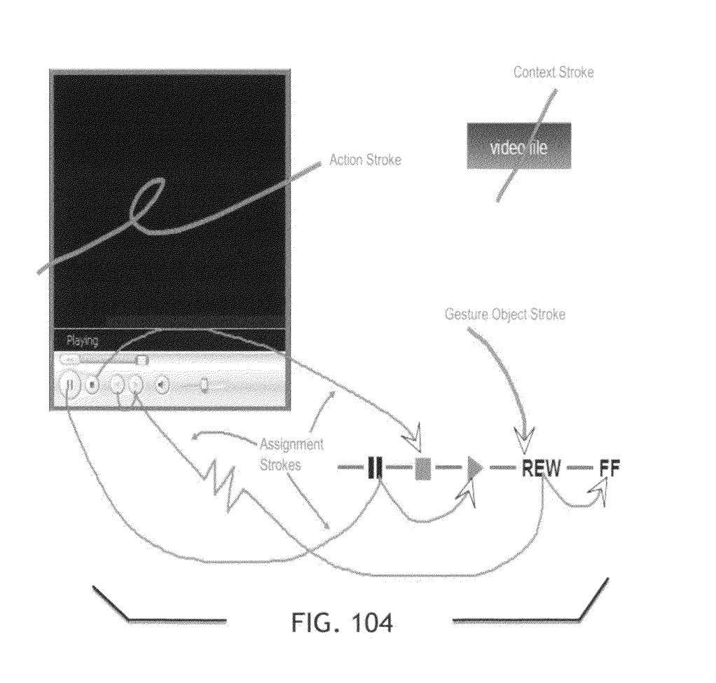

In the video environment example of FIG. 104, there is illustrated a video player with its basic controls, a button labeled “video file”, and a line style comprised of basic video controls. The Context Stroke is drawn to intersect the video file. Thus when the gesture line impinges a video file, or its equivalent, the action(s) programmed for the gesture line will be applied to the video file.

The Action Stroke intersects the action object, in this case a video player. User drawn arrows extend from the video player's controls to graphic object (device) segments in the gesture line being programmed. The pause control in the video player is assigned to two separate graphics (a pause and a play graphic)—this would require some thought and some careful rules, as it is taking one type of software switch, namely a pause that turns into a play and replacing it with two controls, one for pause and one for play. Also there is a single arrow that intersects the rewind and fast forward controls and assigns them to two consecutive text objects, “REW” and “FF” which become the equivalents for these video controls. Notice the recognized scribble “M” shape in the arrow. This graphic device denotes the demarcation between source objects for the arrow to target objects for the same arrow. Finally the user draws an arrow stroke for the program gesture object red arrow. It is pointing to a line that consists of horizontal blue lines and video play control graphics, that have functionality (actions) assigned to them from the video player which is the action object. Note: the Context Stroke, Action Stroke and Gesture Object Stroke can be made in any order. When the white arrowhead or its equivalent of the red gesture object stroke is clicked, the video player controls are assigned to the gesture line controls as set by the assignment arrows.

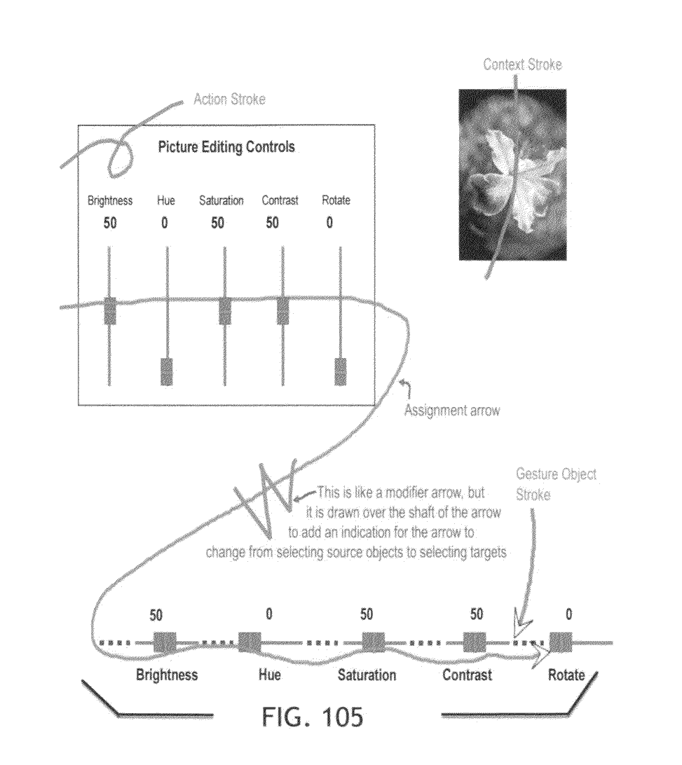

The gesture tools may likewise be used for displaying pictures. With reference to FIG. 105, there is illustrated a Picture Editing Controls display, a picture, and a gesture line comprised of fader control segments and dotted line segments therebetween. The Context Stroke may be impinged on any digital image. The Gesture Object Stroke points to the gesture line that contains four faders devices as its segments. An Assignment arrow is drawn to impinge on a row of picture editing fader controls in a left to right sequence in the Controls display. The same arrow continues and impinges (in the same order) on the four fader segments in the line being programmed to be a gesture line. A scribble “M” shape has been drawn to impinge on a medial portion of the Assignment line, equivalent to having this recognized shape drawn integrally in the assignment line: it modifies the Assignment arrow to determine which part of the Assignment arrow's shaft selects source objects and which part selects target objects. When the white arrowhead of the red gesture object stroke is clicked, the video player controls are assigned to the gesture line controls in the order set by the assignment arrow.

Although the gesture environment described herein is extremely flexible in providing methods for the user to set actions, contexts, and associations, there could be a need for a series of default settings for context, action and gesture object. One default for a context object is that any category of object that is used may be applied to all objects of that category. In the picture display task, using a picture as a context object means that any picture impinged on by a gesture object will invoke the action for that gesture object on or in that picture context.

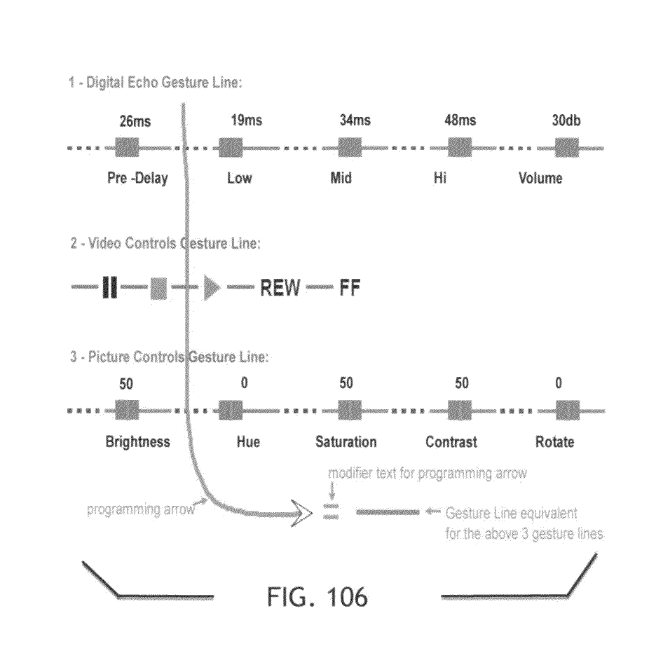

With regard to FIG. 106, there is illustrated a method for creating an equivalent for one or more gesture objects. There is displayed the digital echo gesture line, the video controls gesture line, and the picture controls gesture line, all developed in the examples above. A programming arrow is drawn through all three gesture lines to terminate in a white arrowhead. At the arrowhead, modifier text is entered or spoken to establish the equivalence to a gesture line comprised of a continuous green line. Note: the programming arrow could be pointed directly to the green line, not requiring modifier text. Once programmed by clicking on the white arrowhead of the programming arrow, the green gesture line will have three different actions and appearances which will be called forth according to context in which the green gesture line is drawn. There are two ways to approach this equivalent programming:
1) Create multiple contexts for the same gesture line, like the green line, and then create multiple equivalents of different gesture lines for that one line.
2) Create multiple gesture lines and then create one new equivalent gesture line for those lines—in this case a simple green line. The example of FIG. 106 illustrates the first approach. Multiple gesture lines were created for audio, pictures and video. Then a new gesture line (a green line) was made the equivalent of the other three gesture lines. Rather than use a red (any color or line style can be used) arrow as shown above, a replace arrow could be used to create an equivalent gesture line for multiple gesture lines. When this green, gesture line impinges a valid context object, two things happen:

a) The green gesture line changes into a different gesture line, e.g., with embedded devices and any other properties, actions or behaviors that were programmed for said different gesture line for said valid context.

b) The action for said different gesture line is applied to the object(s) impinged by the green gesture line. By example, if the green gesture line is drawn to impinge on a sound file, it applies a digital echo to that sound file according to controls in a digital echo gesture line for which the green gesture line is the equivalent. If the green gesture line is drawn to impinge on a picture, it applies a compilation of settings according to the faders in a picture controls gesture line for which the green gesture line is the equivalent. If the green gesture line is drawn to impinge on a video, it applies video controls to that video according to a video gesture line for which it is an equivalent.

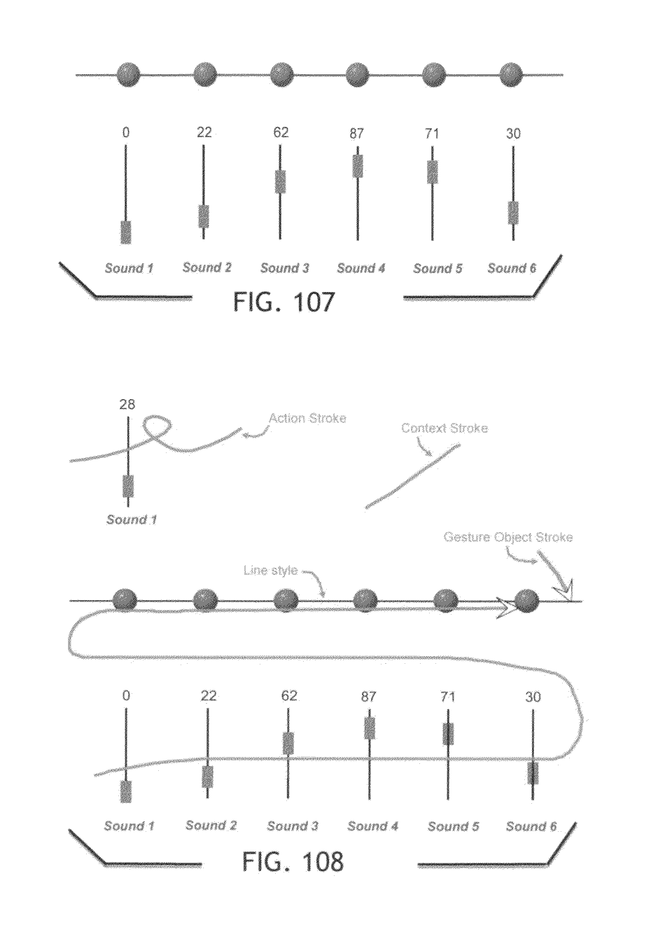

As a further example of user-created line styles employed as gesture lines, reference is made to FIG. 107. A line style has been constructed or recalled that consists of a plurality of green spheres connected by black line segments in a continuous line. Below the line style is a row of faders, one under each green sphere. Each fader is provided with a label identifying the at least one sound file controlled by it. Above each fader is a numeral that changes in value as the fader's cap is moved up or down on its track.

To program the green sphere line style as a gesture line, the process shown in FIG. 108 may be used. The Gesture Object Stroke, a non-contiguous red arrow, points to a line style with multiple green spheres and is drawn to impinge on the line style and convert it to a gesture line. The Context Stroke is in blank space and does not impinge any object. This means that the programmed gesture line can be drawn anywhere in a computer environment where it does not impinge an object and that will be a valid context for the gesture line. The Action Stroke (note looped shaft) is drawn to impinge a fader with an audio input. A second arrow has been drawn from the left through the row of faders and then turns 180° and goes to the left to engage the left end of the line style. This line style is being programmed to become a gesture line but, unlike previous examples herein, no recognized shape has been employed in the shaft of this arrow to designate which part of the arrow's shaft selects source objects and which part of the arrow's shaft selects target objects. Instead, this is determined by context. The context can be comprised of these things: (1) the first impinging of a group of line segments (in this case six green spheres), (2) a change in direction in the line style that extends for a minimum required distance—in this case the change of direction is quite long, over four inches, but a minimal required distance could exist as a user-setup in a preferences menu or the like, and (3) the impinging of a group of devices.

In a preferences menu or as a default, the association of a fader with each green sphere, as programmed above, would result in having each fader assigned to the green sphere directly above it. This assignment could be part of the recognized context just discussed or it could require a modifier being added to the second red arrow. If a modifier is used, if could be modifier line or arrow, a verbal utterance, a dragged object that impinges the second arrow or the like.

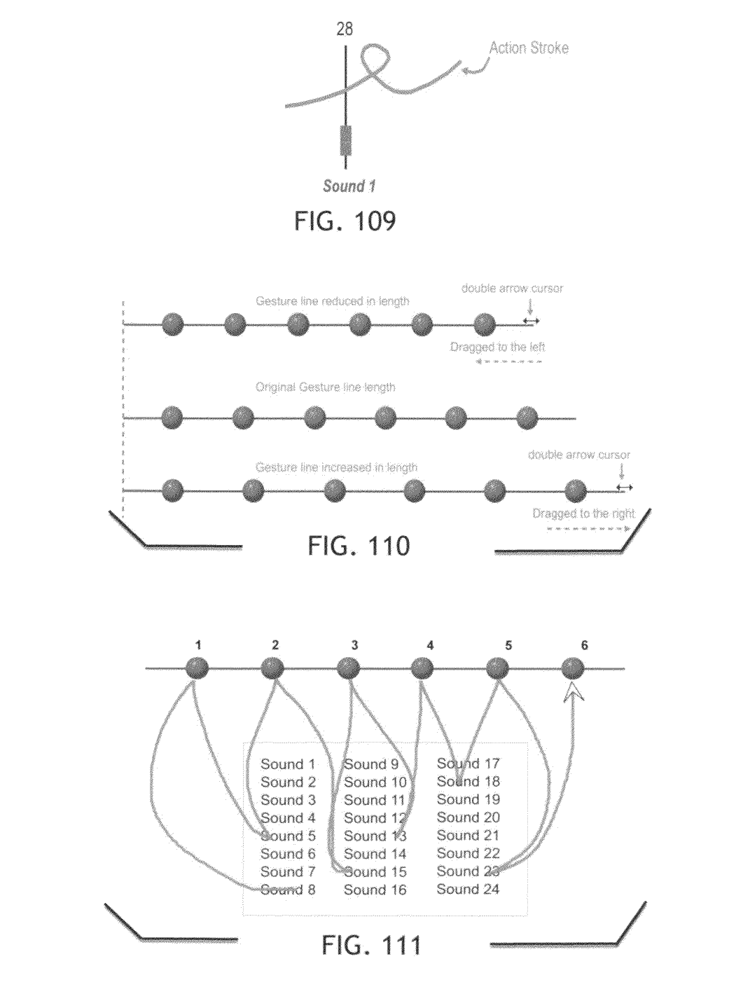

Referring again to FIG. 108, it is noted that the audio fader impinged on by the Action stroke of the gesture programming arrow, as shown in isolation in FIG. 109. This gesture may be interpreted to set various actions that may occur with the drawing of this action stroke. Some of the possible actions are:
1) Control the volume of a sound file.
2) Control DSP for a sound file.
3) Associate a sound file with a gesture line segment.
4) Play the sound file via a user input to the gesture line segment.
   a. Click on a gesture line segment (in this case a green sphere).
   b. Double-click on a gesture line segment
   c. Click on a connecting line between two gesture line segments.
   d. Double click on a connecting line between two gesture line segments
   e. Select the gesture line and then make a vocal utterance or vice versa.
5) Include the name of the sound file as part of the properties of the gesture line and/or one or more of its gesture line segments.
6) Show the fader cap's position and associated level by having a numeral change as the fader cap moves up and down.
7.) Save, update and play back automation data for changes made to digital data.

These possible actions and many more may be presented to a user in a menu or its equivalent such that the user may select one or more actions that are desired to be programmed to a line style as part of the action stroke for the programming arrow used to program the gesture line.

1) A blank console with no setups and no audio. This is a mixer (in this context a mixer is the same as a console) with only its default settings. There are no user settings presented and no audio input into any of the console's channels.

2) A console with channel setups, but no audio. This is an audio mixer “template” but with no audio files present—thus there are no complete audio channels. What is here is a set of controls with setups. These controls include faders and other DSP devices, if applicable, whose setups are the result of user input or of programmed states that do not present the mixer in a purely default state. But no audio is inputted into any of the mixer's channels.

3) A console with channel setup, with audio inputted into its channels. This is the same as #2, but here audio files exist as inputs to the mixer channels. As is the case with category #2, this is a full mixer setup with EQ, compression, echo settings, etc., with proper gain staging, fader positions, groupings and the like, and with audio inputs into the mixer channels. It is a console ready for automated mixing.

With regard to FIG. 110, if a user desired to extend a gesture line that has been drawn or recalled (here the six green sphere segments joined with black line segments), the user may float the cursor, over the right end of the line (or use multi-touch or its equivalent) and evoke a double arrow cursor extending horizontally, as shown in the top line of the figure. In the middle line, the user has clicked and dragged the gesture line to its original length; in the bottom line, the gesture line has been dragged to the right in increase the line length.

FIG. 111 depicts the 6 segment green sphere gesture line and a sound file list in proximity. To assign audio files to the gesture line's segments, a user may employ drag and drop to drag an audio file such that it impinges on a segment (sphere) of the gesture line. There is no need to see the fader or audio channel controlled by the segment. The audio content is automatically inputted to the audio device assigned to and/or controlled by the respective gesture line segment. If multiple audio channels are controlled by a single gesture line segment, then the dragging and dropping of multiple audio files onto the single segment will result in the multiple audio files being inputted into the multiple audio channels in the order that the multiple audio files were dragged to the single segment.

As illustrated in FIG. 111, stitching audio files to gesture line segments with lines or arrows is another technique for associating sound files and the audio devices of the line segments. In this embodiment, a single line or arrow may be drawn between multiple audio files and multiple gesture line segments to assign the audio files to the gesture line segments respectively. This stitching works by having the software recognize the vertices of the drawn arrow. Each sound file and each gesture line segment that is impinged by a vertex of the drawn arrow is selected by that arrow. The assignments or associations of the sound files in the browser list to the gesture line segments are made in consecutive order. In other words, the first impinged sound is assigned or associated with the first impinged gesture line segment and so on. Accordingly, in the illustration below, Sound 8 is assigned to gesture segment 1, Sound 5 is assigned to gesture segment 2, sound 15 is assigned to gesture segment 3, and so on.

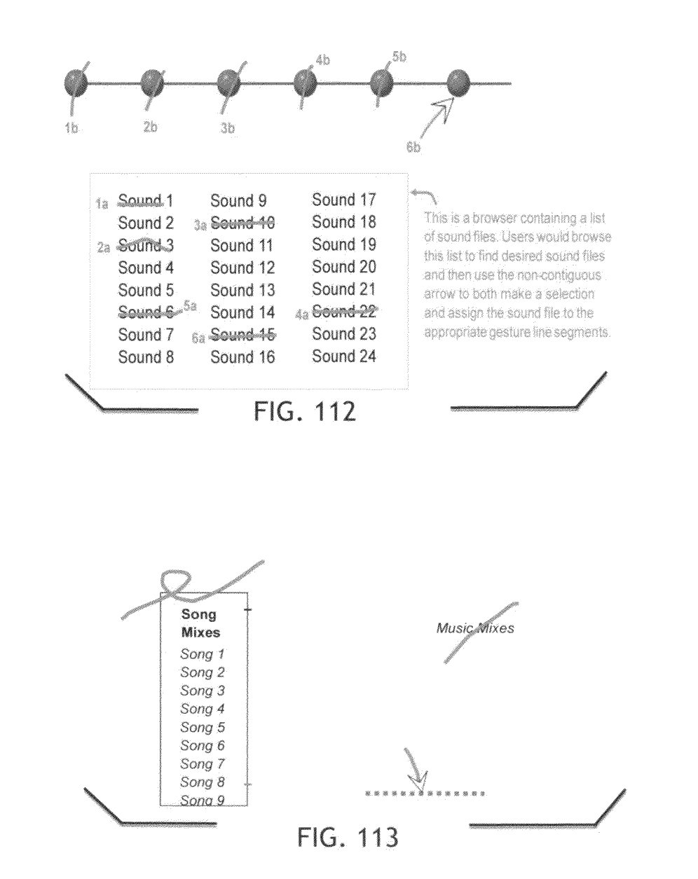

In the embodiment illustrated in FIG. 112 a non-contiguous arrow is drawn to both select and assign (or associate) multiple sound files to multiple gesture line segments. These assignments are made in sequential order, unless otherwise provided for by user input, software default, context or the like. A red line (1a) is drawn to intersect a sound file (the source for the arrow), then a line (1b) is drawn to intersect a gesture line segment (the target for the arrow). This method is continued, e.g., another red line (2a) is drawn to impinge a second sound file (source) followed by another red line (2b) which impinges a gesture line segment (target) and so on. The last line drawn (6b) is hooked back to create an arrowhead. When recognized it is turned into an arrow with a white arrowhead. When the white arrowhead (6b) is clicked on, all of the assignments (1a-6b) are made.

Among the many onscreen elements that can be used to play sound files controlled by, assigned to, or associated with one or more gesture lines, there is the play switch, which has been portrayed in the Figures. Likewise, a verbal command, such as “play” may be spoken and then the user selects one or more gesture lines or vice versa.

A gesture line may act as a sub-mixer for a larger piece of audio. A user may draw a number of gesture lines that each control one or more audio files that comprise a different submix for the same piece of music (“submix gesture line”). The channels controlled by each submix gesture line may be used to adjust the total submix output of each submix gesture line. Then all of these gesture lines may be played simultaneously in sync to create one composite mix.

The opposite of this process would be where a user has more than one gesture line in an environment and each gesture line controls audio that is dissimilar or is not part of a cohesive whole. In this case, activating a play switch that plays all of the gesture lines' audio simultaneously would not be desirable. In that case, a user wants a way to play the audio, controlled by each gesture line, one at a time.

One method to accomplish this is to associate a play switch with just one gesture line that is controlling audio. This may be accomplished by dragging a play switch to impinge on such a gesture line. The result of this dragging is the creation of a unique play switch just for that gesture line. Invoking this unique play switch will only play the audio for the gesture line for which it is associated.

Another method may be to apply a user input directly to an audio gesture line to invoke the action “play.” Such actions could include: single or double clicking on the connecting line between segments on the gesture line itself, using a verbal command. i.e., “play” after selecting the gesture line or vice versa, dragging another object that impinges an audio gesture line, using multi-touch to invoke the action: “play.”

In the following series of examples, a simple gesture line is being programmed to invoke three different actions according to three different contexts. These three gesture lines and their three contexts present a logical order, like a thought process. With reference to FIG. 113, there is illustrated a list of music files (here, numbered song files). A context stroke is drawn to impinges the text “Music Mixes”, and the Gesture Object Stroke points toward a dotted green horizontal line, the line that is being programmed as a gesture line. The Action Stroke is drawn to impinge on the list of song mixes.

Continuing to FIG. 114, the same gesture line (dotted green horizontal) is programmed with a second context. The Context Stroke impinges on a song mix (“Song 2”) entry in a list or browser. The Action Stroke impinges on the audio mixer for the impinged song mix. The Gesture Object Stroke points to the same dotted green line, which is being programmed with this second context and associated action. One additional action has been programmed above. The action stroke has been modified with the text: “load but don't show onscreen.” This indicates that the software is to load the mixer and all of its elements for Song 2, but not show the mixer or its elements onscreen; rather, have them ready in memory or parts of them properly cached so they can be played as coherent audio upon command.

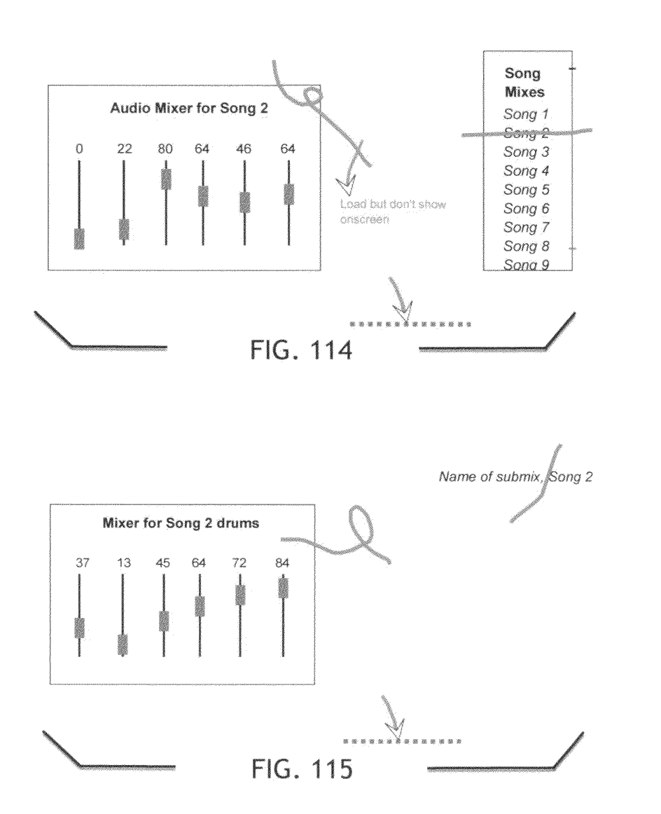

The programming of the third context for the gesture line of the previous example is illustrated in FIG. 115. The Context Stroke impinges the name of a submix, “Name of submix, Song 2.” This text describes a set of mixer elements, which include one or more of the following: faders, DSP controls, sends, returns, and audio files and mix data. The Action Stroke impinges the set of mixer elements for the drums for Song 2. In this case, the user wants to see these mixer elements so they can adjust them. So they are not hidden as in the programmed action for Context 2 where the audio mixer for the entire Song 2 was loaded but not shown. The Gesture Object Stroke points to the same dotted green line, which is being programmed with this third context and associated action.

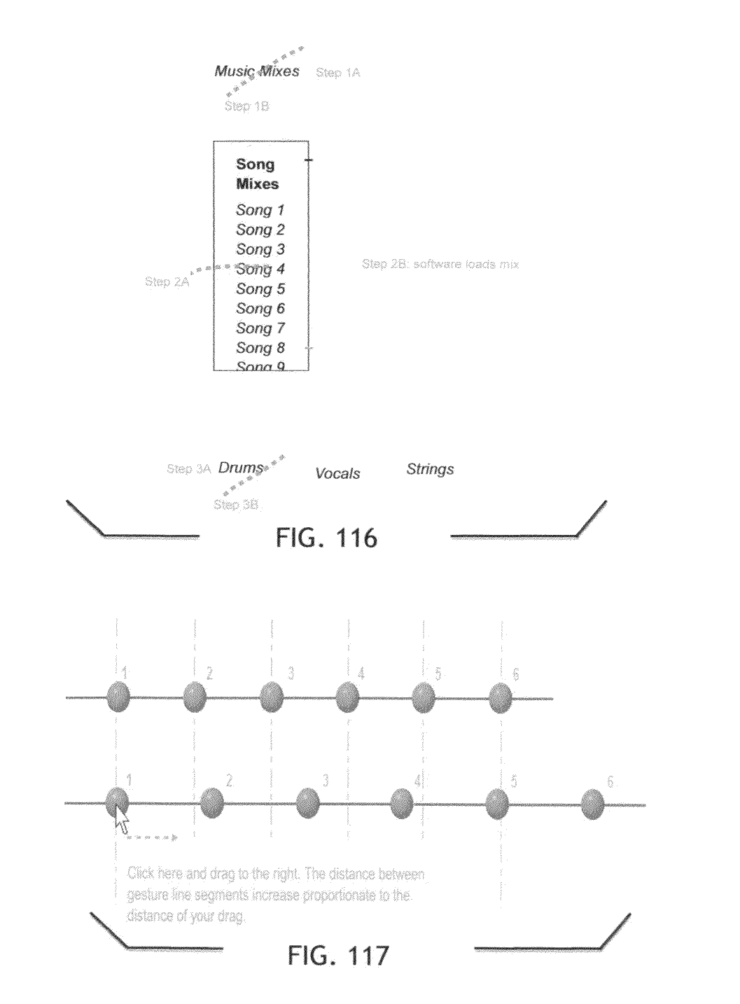

At this point a simple green dotted gesture line has been programmed to invoke three different actions when drawn to impinge three different types of Context Objects. The following example shown in FIG. 116 illustrates how this green dotted gesture line may be used.

Step 1A. The user types a category, such as Music Mixes. Any number of equivalents could be created for the text “Music Mixes.” However, for the purposes of this example, this “Music Mixes” text is a known phrase to the software. In other words, when it is presented in a computer environment, it is recognized by the software. The software then responds by showing one or more browser(s) containing music mixes. A music mix could be all of the elements and their settings, used to create a mix for a piece of music. This could include the settings and even automation data for all channels of a mixer that were used for mixing a piece of music.

Step 1B. The user draws their green dotted gesture line to impinge the text “Music Mixes.” This is the first context for the green dotted gesture line, as illustrated above. Once the green dotted gesture line impinges the Music Mixes text, a list of available song mixes appears in a browser.

Step 2A. The user draws the green dotted gesture line to impinge Song 4 in the list of songs that appeared as the result of Step 1B. Note: in the programming of this context for the green dotted gesture line, Song 2 was used. But this denotes a category of items that comprise a context, not a single named mix file.

Step 2B. The software loads the mixer and all of its elements for Song 4, but keeps them invisible to the user. The necessary elements are cached in memory as needed, such that if the user engages the Play function he/she will hear the mix correctly play back. So with Step 2B, nothing new appears visually in the computer environment.

Step 3A. The user wants to work on just a part of the mix for Song 4. So the user types or otherwise present the words, “Drums, Vocals, Strings,” in the computer environment. These words represent submixes that are part of the full mix for Song 4.

Step 3B. The user draws the dotted green gesture line in its third context, namely, to impinge the word “Drums” in a computer environment. Note: the user could have drawn the green dotted gesture line to impinge the name of any existing submix for Song 4. As an alternate, the user may view a list of the submixes for Song 4 and draw the green dotted gesture line to directly impinge one of the entries in this list.

As a result of impinging “Drums” (or its equivalent) by said green dotted gesture line, the software presents a Drums submixer and all of its associated elements (DSP, routing, bussing controls, etc.) in the computer environment. The user can then make adjustments to this submix via the submixer's controls. To have a Strings submixer presented, the user would draw said green dotted gesture line to impinge the entry “Strings” in a browser listing various submixes for Song 4. As an alternate the word “Strings” could be presented (typed, spoken, hand drawn, etc.) in a computer environment and then impinged by said dotted green gesture line. In the case of a spoken presentation, the impingement would be also caused by a verbal utterance.

The example above is a viable use of context as a defining element for the actions carried out through the use of a simple gesture line. At no time does the gesture line change its visual properties, as in previous examples herein. The gesture line remains a simple dotted green line, which is simply drawn to impinge graphical elements that present unique contexts and thereby define the action for the gesture line. These unique contexts enable the simple drawing of the dotted green gesture line three times to access increasingly detailed elements to aid the user in finishing an audio mix. This is a model illustrating the power and flexibility of contexts with gesture lines. This model can be applied to any gesture line.

Returning to the green sphere gesture line of FIGS. 107 and 108, it is clear that the software must know to make assignments to each green sphere rather than place the fader on top of the sphere or next to it, etc. This task is carried out by having preferences or defaults for the programming of gesture lines. Various preferences may exist for the programming of various types of actions for a gesture line and its segments. Users may just choose the preference that best suits what they wish to do. Certain preferences may apply to certain contexts; for instance, the preference for an arrow drawn as illustrated above could be “make an assignment.”

In the gesture objects environment the Blackspace assignment code is modified to allow assigned objects to appear in the same “relative location” as they had been to the object to which they were assigned at the time the assignment was made. In the case of the faders shown for example in FIG. 107, this means that as the line containing assigned-to green spheres is drawn in different locations in a computer environment, the faders assigned to those spheres will need to always appear directly under each sphere when that sphere is clicked on to see its assigned object. To accomplish this the software maintains the same relative positional relationship of the fader objects to the green spheres in the gesture line as the green gesture line is dragged or draw in a different location.

One of advantage of an audio gesture line is the ability gain quick access to a series of audio files without having to search through logs or audio file lists. Another advantage is to be able to add audio to visual media by drawing simple lines. Still another advantage stems from using audio gesture lines to control versioning of audio in documents, slide shows, and other digital media.

One approach to adding audio to a slide show in a gesture line is to line up an audio gesture line next to a slide show gesture line. If the audio segments and the slide show segments do not align a quick remedy is to adjust the relative spacing between audio segments in a gesture line with a single drag. Referring to FIG. 117, this action can be the same as that which is used to adjust the time represented by a timeline in Blackspace. This is done by clicking on a point in the gesture line and dragging to the right (to increase) or to the left (to decrease) the overall time that is represented along the gesture line.

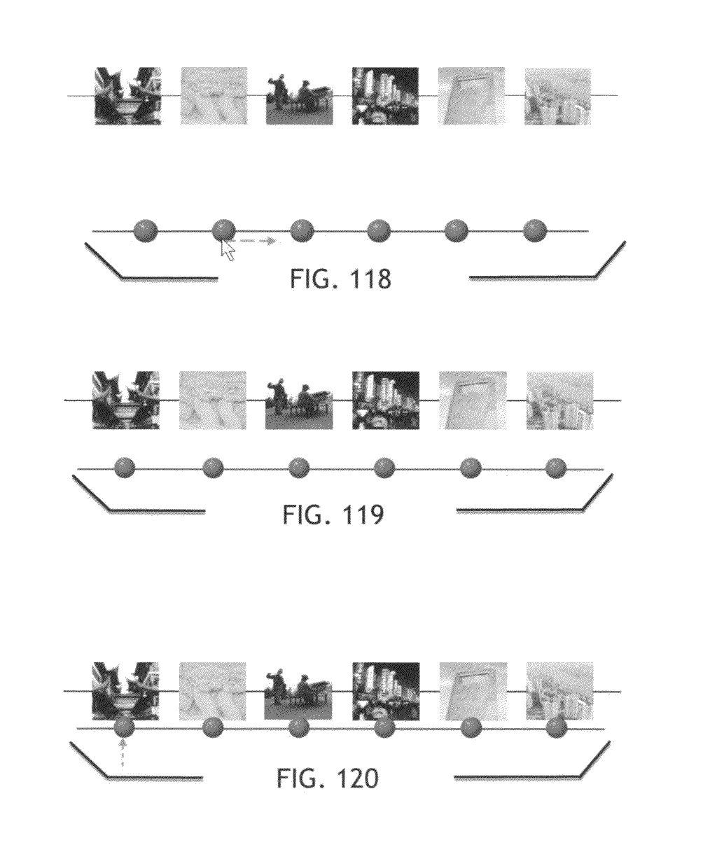

With regard to FIG. 118, there is illustrated a slide show gesture line wherein each line segment comprises a slide, and a green sphere gesture line in which each sphere is associated with a sound file; e.g. a different piece of background music. By clicking on any of the spheres and dragging to the right, the sound file gesture line is made to stretch laterally so that each of the green spheres is brought into alignment with a respective slide segment of the slide show gesture line (FIG. 119). Thereafter, as shown in FIG. 120, the entire audio gesture line is dragged upwardly to impinge on the slide show gesture line.

This user action may have several possible results:
1) Automatically assign each audio sound file represented by each green sphere to the slide show segment that each green sphere impinges. In this case each audio file for each green sphere that impinges a slide show picture segment would become the audio for that slide.
2) Provide for the operation described in “1” above, but additionally have a pop up menu appear asking the user if they want to have the audio files in the impinging green spheres be assigned to the slide show segments. In this case, it would be possible to have a green outline appear around each of the slide show segments. If a user does not want a particular slide to have audio assigned to it, the slide segment would be clicked on so its green outline disappears. The text “OK” or its equivalent may be clicked on in the pop up menu to complete the audio assignments to the slide show segments that have a green outline around them.
3) Prompt to user for a verbal confirmation. The user could just say: “OK” or “assign audio,” etc.

Through any of these procedures the user may assign the individual pieces of background music of the green sphere gesture line to respective slides of the slide show gesture line.

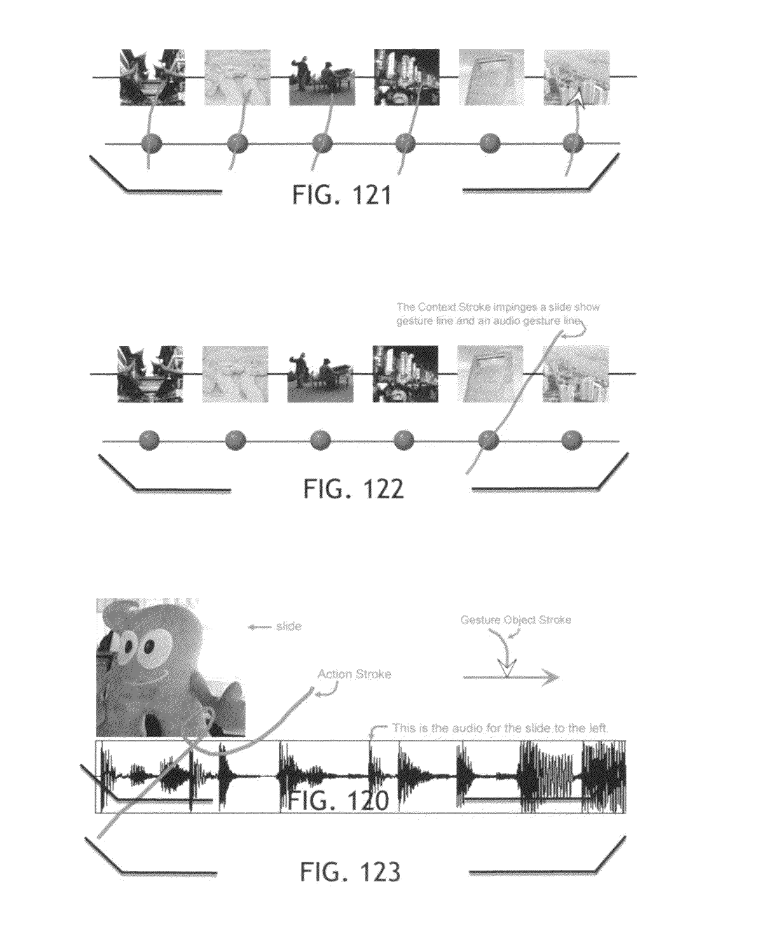

With regard to FIG. 121, any audio gesture line may have any one or more of its segments assigned to one or more segments in another gesture line by drawing lines. The slide show gesture line and green sphere audio segment lines of the previous example are displayed in proximity. A user may draw non-contiguous arrows between the sound file segments of the green sphere gesture line and the slide segments of the slide show gesture line to associate the sound files and slides as desired. Note that the fifth slide has no audio assignment, and will play without audio accompaniment. The conditions of the above assignments may be determined by user-defined preferences or default settings in the software or by verbal input means. The logical result of the assignments made in FIG. 121 is that the audio of each green sphere becomes the sound for the linked slide segment made by the red arrow.

With regard to FIG. 122, there is illustrated a technique for creating a gesture object that equals a red line or red arrow. Once again the slide show gesture line and green sphere audio gesture line are displayed in proximity. A context stroke is drawn to impinge on both the slide show gesture line and the audio gesture line. A preset preference or a verbal or text input may be required to clarify that this use of a context stroke commands that the audio segments are synced with the respective slides of the slide show gesture line.

The example of FIG. 123 continues the a previous development by illustrating a method for programming a red arrow to carry out the audio sync function described above. There is displayed a slide, and the audio waveform display that is associated with the displayed slide. The user draws an Action Stroke to impinge on a slide and the audio that is synced to it. Details as to how this action is to be invoked are derived from the current actions associated with the impinged slide and audio track synced to it. As an alternate, the Action Stroke may impinge known text, e.g., “sync audio to slide.” Details as to how this action is to be invoked may be presented in a list of defined operations where the user selects the desired action. This list may include things like: the method of the sync, e.g., the audio starts when the slide appears, and ends when the slide disappears, or how the sound file is to be presented visually, or whether an infade and outfade are automatically applied to the audio for the slide. The gesture object stroke points to the object that is to be programmed, in this case the red arrow. After the white arrowhead of the gesture object stroke is clicked, the red arrow may be drawn between sound file segments and slide show segments to sync the sound files to the slide displays.

With regard to FIG. 124 there is illustrated an example of the use of a stitched arrow to assign audio files to a slide show represented by a slide show gesture line. Here the stitched arrow is drawn to pass through one green sphere and one slide segment in a single arc, whereafter it changes direction abruptly at a vertex and forms another arc that passes back through the same green sphere, the next adjacent green sphere and a respective other slide segment, where another vertex is formed, and so on along the line. Upon clicking on the white arrowhead of the stitched line, the audio files are assigned to their respective slide segments.

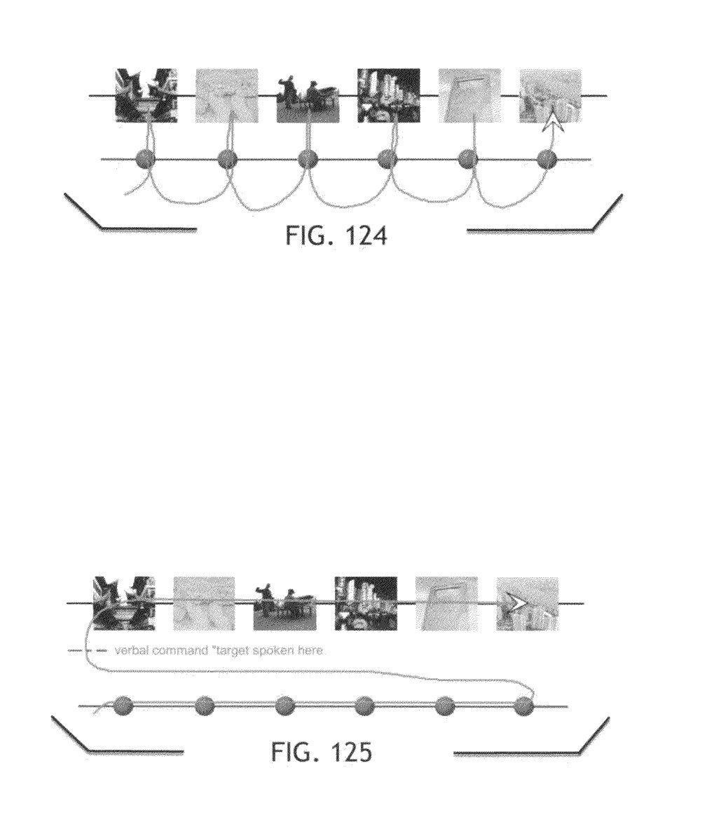

With reference to FIG. 125, a further example of associating sound files and slides is illustrated. The slide show gesture line and the green sphere audio gesture line are the same as the previous example. A single arrow has been drawn to assign each audio file controlled by each gesture line green sphere to each slide show gesture line segment respectively. When the white arrowhead is clicked on, impinged audio segments are assigned to the impinged slide show segments in the order that they were impinged as “source” and “targets”—first source is assigned to first target, second source is assigned to second target, etc.

Also shown is a modification of a previous example of assignment, namely, no recognizable shape has been used in the shaft of the arrow to designate which part of the shaft selects source objects and which part of the shaft selects target objects. This is because something else tells the software where the “source” objects end and the “target” objects begin. In this example a verbal command is utilized. This utterance is made after the last green sphere was impinged, but before the first slide segment was impinged by the drawing of the arrow. Another approach would be to use a context. Such a context could be that intersections of dissimilar objects change the arrow's shaft from selecting “source objects” to “target objects” automatically. This could also be determined by a default setting.

Various conditions can exist for the drawing of a gesture line. Below are some of these conditions:

1) Draw a portion of a gesture line and the entire line is drawn. This condition is similar to the recalling of a VRT list entry with rescale turned off. In this gesture line condition you can draw just a small portion of a gesture line, e.g., a few pixels—any distance that is set up as a default behavior or that is set as an on-the-fly behavior. When just a portion of the line is drawn, the entire length of the programmed line—including all gesture segments—will be drawn.

For instance, if the short portion was drawn in a vertical direction, the rest of the gesture line will appear in a vertical direction. The same applies if the short portion is drawn in a horizontal or angled direction. Furthermore, if a portion of a gesture line is drawn in a spiraling elliptical pattern, the rest of the gesture line would be presented as a continuing spiraled line.

2) What if the line is too long to fit on the screen? There are at least two possibilities.

Solution 1: The line can continue beyond the visible area of a computer environment, but remain as a continuous line. Then the ability to extend the visual area of a desktop (by dragging a pen or finger or mouse to impinge an edge of a screen space) would enable a user to access any part of the gesture line extending in any direction beyond the currently visible area of a screen.

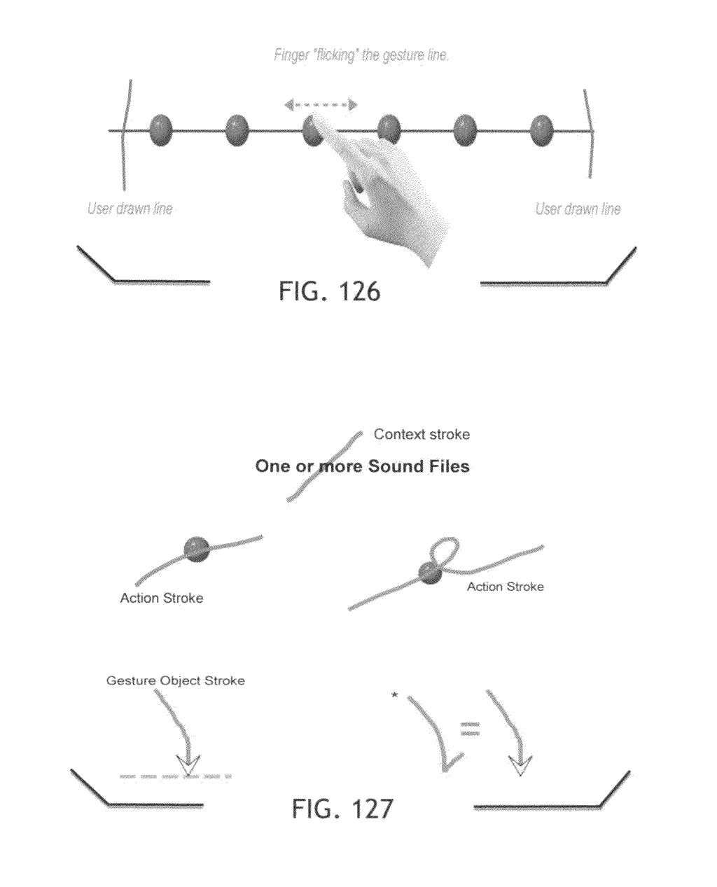

Solution 2: Using one's finger on a touch screen or the equivalent to “flick” a gesture line between two designated points. This technique is shown in FIG. 126, where the user's finger is shown “flicking” a green sphere to set up a gesture line between the user drawn lines that are horizontally spaced apart.

What is meant by “flicking?” This is a now familiar process of scrolling through graphical and text data on a mobile phone with a touch screen. The user places a finger on a graphic and drags in a direction with a certain speed and then lifts off the finger. The graphic moves forwards or backwards depending upon the direction the finger is dragged, as if the display had the inertia of a real moving object. Since a mobile phone has limited screen space, this method or some derivative of it is used to view longer objects, scroll through documents, and view picture and other graphical data that is too large to fit within the available screen space of a mobile phone or music/phone device.

This method can work well with gesture lines that are too long to fit within the viewing area of a computer environment. An example of such a gesture line is a gesture line that contains 100 slide show picture segments. Trying to draw such a line would be impractical and the horizontal or vertical viewing area required to view the line in its entirely is just too large. But drawing a part of the line and then designating a left and right boundary for the gesture line enables a user to “flick” through the gesture line to view any part of its contents. These boundaries may act as clipping regions where the gesture line disappears beyond designated points or areas. Designation methods could include: drawing lines that impinge the gesture line in a relatively perpendicular fashion, touching two points in a gesture line and making a verbal utterance that sets these points as “clipping boundaries” for the gesture line.

3) A collapsing gesture line. There are various graphical ways to present a collapsing gesture line. One way does not change the visible look of the gesture line but rather its graphical behavior. In this permutation a gesture line does not extend beyond the visible area of a screen, but rather it collapses when it hits (impinges) an edge of the screen. Then if the line is dragged away from the edge of the screen, more and more of it would appear as it is continually dragged away from that edge. If the other end of the line impinges the other side of the screen, it begins to collapse. The collapsing of either side of the line, simply hides any line segments that extend beyond the visible portion of the gesture line. So for instance, if one drew a gesture line on screen and then dragged it so its origin impinged on the left side of a screen and continued to drag the line in this direction, segments of the line would start to disappear.

It is also possible to collapse a gesture line without impinging the side of a screen space. It is possible to present a gesture line in a collapsed form as a behavior of the line which is set to a maximum linear distance. This can be set in a menu, verbally designated by a spoken word or words, drawn with graphical designations, determined by a context in which the gesture line is drawn and the like. One obvious use of a collapsing gesture line is that it can fit into and be utilized in a smaller space. This behavior of a gesture line is similar to the “flicking” described above, except that no user input would be required. The collapsing behavior would just be a property of the gesture line.

A user may also designate clipping regions as an inherent property of gesture line. In this embodiment, “clipping” is part of the object definition of a gesture line. In this case, the width of the left and right clipping regions may be automatically set by the length the original gesture line is drawn. Further modifications to a gesture line clipping object properties may be accomplished via verbal means, menu means or dragging means, i.e., dragging an object to impinge a gesture line to modify its object properties or behaviors.

It is also possible for a user to employ an existing action controlled by one or more graphics as the action definition for a gesture line. Defining an action for the programming of a gesture line does not always require the utilization of a known word or phrase. It may utilize an existing action for one or more graphic objects in a computer environment, like Blackspace. In this case, drawing an Action Stroke, e.g., a line with a “loop” or other recognizable graphic or gesture as part of the stroke, which impinges a graphical object that defines or includes one or more actions as part of its object properties, can be used to modify a gesture line's action.

In this case, one or more graphic objects, which can themselves invoke at least one action, can be placed, drawn or otherwise presented onscreen. Then by drawing a “loop” or its equivalent to impinge on one or more of these graphic objects, the action associated with, caused by, engaged by or otherwise brought forth by these graphic objects can be applied (made to be the action of) a gesture object, like a line.

An example of this method is shown in FIG. 127 with regards to programming the action “play audio” for a gesture object. The action strokes shown in FIG. 127 (one with a “loop” and the other without) impinge on an object that can cause an action. NOTE: it is possible to utilize an action stroke without a defining object or shape associated or applied to the action stroke, if the object impinged by the stroke contains, calls forth or otherwise invokes an action. In this case the object is a green sphere that causes audio to be played. The condition of the action of the object can be used to define an action for a gesture object. This use of the condition of the object is an option in the use of one or more objects to define an action for the programming of a gesture line. The option can be engaged or disengaged by many means, including: (1) verbal, (2) gestural—including but not limited to performing or drawing a gesture, (3) drawing one or more objects, (4) making a selection in a menu or its equivalent and the like. The Context Stroke shown in FIG. 127 is drawn to impinge a text object: “one or more Sound Files.” This phrase would exist as a “known phrase” to the software. This phrase may be the equivalent for a single sound or collection of sounds, which could include an audio mixer or the like. The action strokes shown below (one with a “loop” and the other without—only one of these strokes would be needed in this example) impinge an object that can cause an action. In this case the object is a green sphere that causes audio to be played. The condition of the action of the object can be used to define an action for a gesture object. This use of the condition of the object is an option in the use of one or more objects to define an action for the programming of a gesture line. The option can be engaged or disengaged by many means, including: (1) verbal, (2) gestural—including but not limited to performing or drawing a gesture, (3) drawing one or more objects, (4) making a selection in a menu or its equivalent and the like.

As noted in the description above, the Gesture Object Stroke is designated by drawing an arrow head line hooking back at the end of the line. The software recognizes such a hook back and places a white arrowhead (or its equivalent) at the end of this stroke. To carry out the programming of the gesture line (in this example, a dashed brown line) the user clicks on the white arrowhead. Once programmed as a gesture line, a user can draw the above brown dashed line to impinge any one or more audio files, audio mixers or the like and this will cause the audio for these objects to be played. Note: a “Selector” could be used as part of the programming of the brown dashed line as a gesture line. In this case, a user input would be required to cause the action ‘play’ after one or more objects were impinged by the brown dashed gesture line.

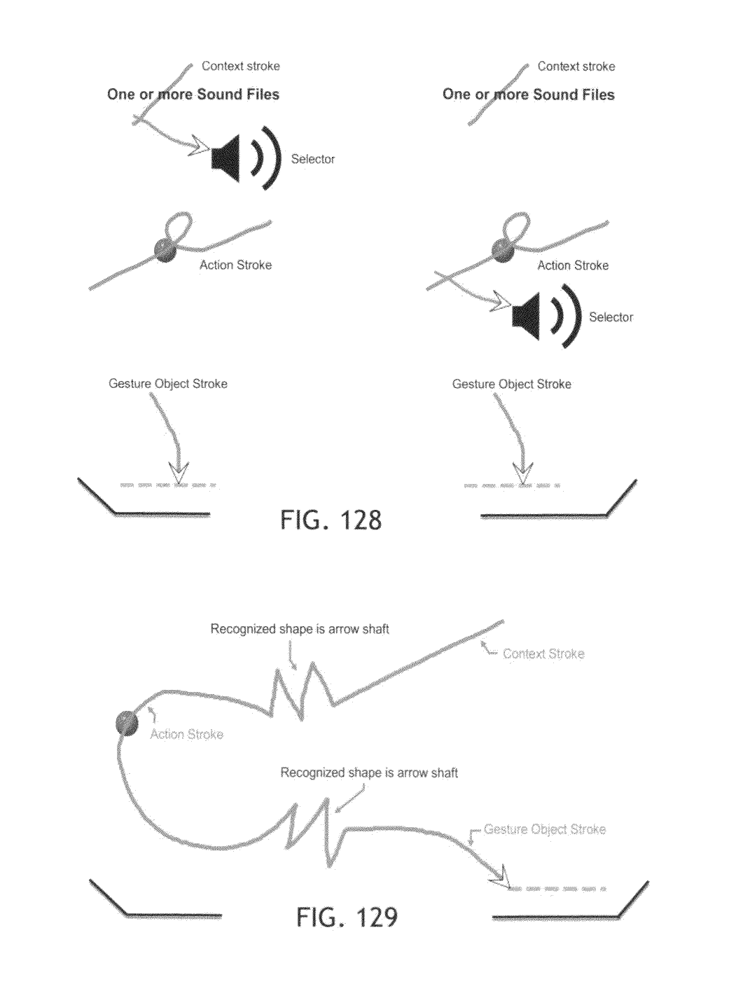

An example illustrated in FIG. 128 depicts two methods for programming a selector (to initiate the action play) for a gesture line. There is a display showing the Context Stroke, Action Stoke and Gesture Object Stroke for the programming of a gesture line. Newly introduced to this programming process is a “Selector.” As defined in the flow charts of FIGS. 1 et seq. A Selector is an optional Gesture which, when applied to the Context Object, is used to trigger the Action on the Context object. In this example, the context object is “one or more sound files.” A selector may be introduced by the modifier arrow from the context stroke to the selector object (as shown at the left in FIG. 128), or by the modifier arrow from the action stroke to the selector object, as shown at the right in the Figure (either technique will be sufficient). If a Selector is specified (when a Gesture Object/Line is programmed), the Action programmed for the Gesture Object (in this example a brown dashed line), is not invoked when the Gesture Object is applied to the Context Objects, e.g., is drawn to impinge one or more sound files or their equivalent. Instead the Action is postponed and applied when the Selector is activated, as by a user clicking on the selector symbol or object.

In the gesture example of FIG. 129, a single contiguous line is drawn to program a gesture object. Once again a recognized graphic element interposed in the line shaft is employed, except that in this instance it indicates a change in the type of stroke. That is, each occurrence of the graphic element (here, the scribble “M” element) is used to separate portions of the single line: the context stroke from the action stroke that impinges on green sphere, from the gesture object stroke that points to the brown dashed gesture line. The final step in programming the gesture line is to click on the white arrowhead, which appears on the mouse upclick when the single programming line is drawn.

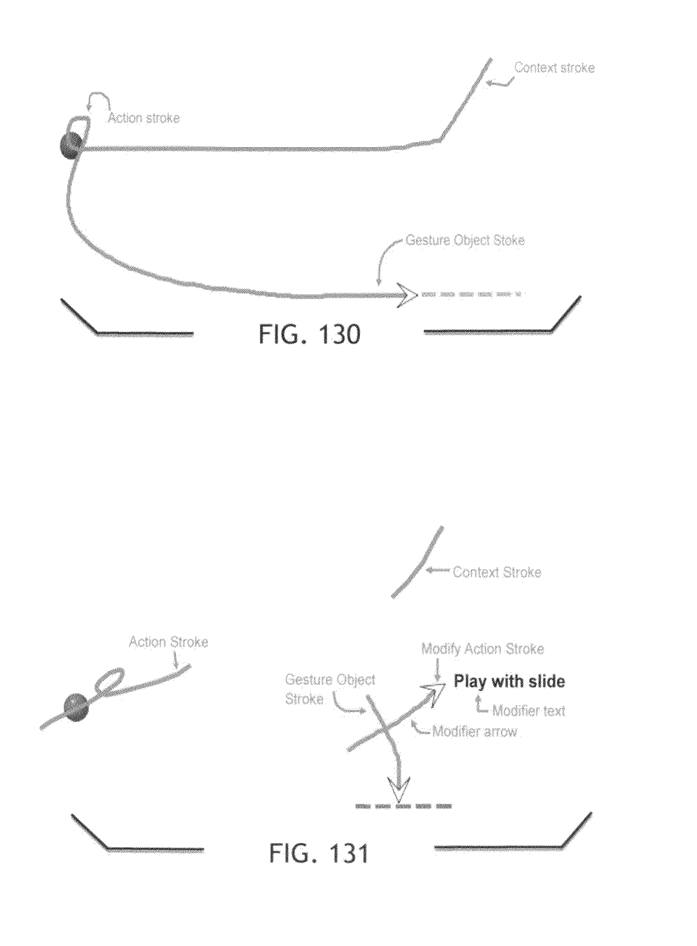

The next example illustrates employing a programming line without resorting to software-recognized shapes. As shown in FIG. 130, in this example “context” is used to define the operation of the drawn line below. This context includes the following: drawing a first part of a line that impinges a valid Context, then continuing to impinge a valid Action Object and finally to impinge an object that can be programmed to be a gesture object. The action for the green sphere (as programmed earlier as an audio element) may be to toggle its function on/off when it is clicked on; and to change its color when it is clicked on; and to cause either the starting or stopping of audio playback. In this instance it turns bright green and causes playback of audio and turns dark green when it is activated to stop playback.

A gesture line itself has an action. If the gesture line includes no segments, (that can themselves cause an action), then the action(s) invoked by the drawing or otherwise presenting of the gesture line to impinge on a valid context (for the gesture line) are the only action(s) for the gesture line. If a Selector is programmed for the gesture line, the activation of the Selector is required to invoke the action or actions for the gesture line.

But there are other conditions that can affect the action for said gesture line. This involves adding segments to a gesture line. There are aspects to these segments that must be considered for determining actions for a gesture line. A gesture line's segments can each invoke one or more actions. One method for determining an action for a gesture line segment is to use an object that invokes an action as part of its own object behavior and/or property or other defining characteristics. For instance, objects and devices, i.e., a knob or fader, can invoke the action “variable control.” What the variable control is, e.g., audio volume, picture brightness, hue, saturation, etc., can be determined by many factors. These factors can include the following:
1) An object that conveys an action, like “volume” or “hue”, etc. In this case an object or its equivalent can be presented (i.e., drawn or typed) or dragged to impinge something or be uttered verbally, and the action conveyed by said object will cause the device or object being impinged by said object to convey or exhibit the action conveyed by said object.
2) An object can be used to impinge another object in a certain context such that the impinged object is caused to create or convey or exhibit a certain action.
3) A verbal command. A spoken command can cause an action to be applied to an object.
4) An object can be dragged in a definable shape that can cause an action to be applied to an object.

Returning to the green sphere gesture line shown for example in FIGS. 110 and 111, the shade of green of each sphere may change from light to dark to indicate an On state (light green) and Off state (dark green). If a separate audio file were controlled by (or assigned to) each of the above spheres, then since all of the spheres are light green (indicating an “on” state) all of the audio files could start to play when the gesture line containing them is drawn. If it were desired to use these green spheres to link, assign or otherwise associate their audio files with various slide show slides or pictures, having the audio files play when the line is drawn could cause cacophony. Thus the gesture environment must provide some way to tell the green sphere audio gesture line to override the behavior of the green spheres (namely, to play audio) by applying a controlling behavior.

With regard to FIG. 131, a modifier arrow may be drawn to impinge on a programming arrow for the creation of a gesture line. The context stroke, action stroke, and gesture object stroke pointing to a brown dashed line are familiar from previous examples. After the user draws the gesture object stroke and before the white arrowhead is clicked, the user draws a modifier arrow to impinge on the gesture object stroke. Once the modifier arrow is drawn, a text cursor appears a small distance from its arrowhead. Then modifier text can be typed to further define the action presently defined by the object(s) impinges by the Action Stroke of the arrow's shaft or its equivalent. For example, modifier text “play with linked object” or “play from an assignment,” or “play with slide” may be typed. Then the sound files will not play when the gesture line is drawn. But the audio files will remain in an “on” state of play, waiting to be linked with an object, like a slide in a slide show or being assigned to an object, like a picture.

For instance, by creating such a link between a sound file and a slide in a slide show, playing the slide would also play the audio linked to it. Creating a similar link to a picture may result in clicking on this picture to play the audio assigned to it. If the audio files were “off”, clicking on objects to which they are linked would not cause the audio files to play. So they need to be assigned or linked in an “on” state and then have some other action (a “Selector) be required to cause them to play.

Another approach is to create a modifier arrow and type the text “turn audio files off.” This results in having all light green spheres set to dark green (an “off” state). In this way the drawing of the line would not result in the audio files assigned to the green spheres being played. That would be caused by some other action, like touching or clicking on an individual green sphere segment in the gesture line.

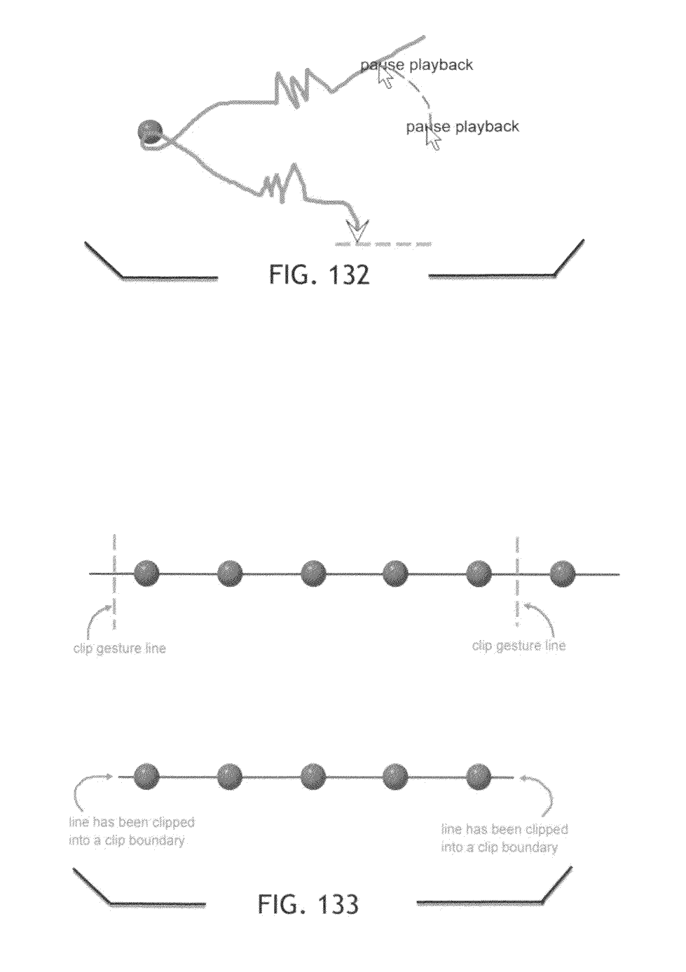

With regard to FIG. 132, there is illustrated an example of the use of drag and drop to modify a programming arrow for a gesture line. Here a single contiguous line is provided with software-recognized graphic elements to separate the context stroke, action stroke, and gesture object stroke portions of the single programming line. In addition, the user has typed or recalled a text object stating “pause playback” or the like. In this example, the action “play” (invoked by the green sphere which defines the action for the brown dashed gesture line being programmed) is modified to become “pause” by the user dragging the text object “pause playback” to impinge on the single contiguous gesture line.

One or more verbal commands may also be used to modify a programming arrow for a gesture line. Before touching (clicking on) the white arrowhead of a gesture programming arrow, a user may touch any part of the gesture arrow (either as a contiguously drawn or non-contiguously drawn arrow) and then utter a word or phrase to modify the programming of the gesture object. For instance, a user could click on the red gesture programming arrow in the above example and say: “play audio upon verbal command ‘Play’.” In this case when the user draws the gesture line in the context that produces audio playback, that audio playback will be governed by a verbal command: “play.” Without the utterance: “play” no audio will play. This acts as a verbal “Selector.”

The gestures environment also provides at least one method for updating a gesture line. Such updating includes, but is not limited to, adding, altering or deleting a context, action or changing the nature of the gesture object line itself. One example of updating a gesture line, shown in FIG. 133, reprises the green sphere segmented gesture line. If the line is too long to be displayed in a particular situation, it may be updated by establishing at least one clipping boundary. Given the line display at the top of the figure, the user may draw a pair of clip gesture lines, which truncate the display of the gesture line. The result is shown at the bottom of the figure, where the ends of the gesture line have been clipped beyond the positions of the clip lines. The line still exists beyond the clip boundary but is hidden by the boundary. Dragging the green sphere line to the right, for example, will cause more of the left end of the line to appear while the right end disappears beyond the right clip boundary.

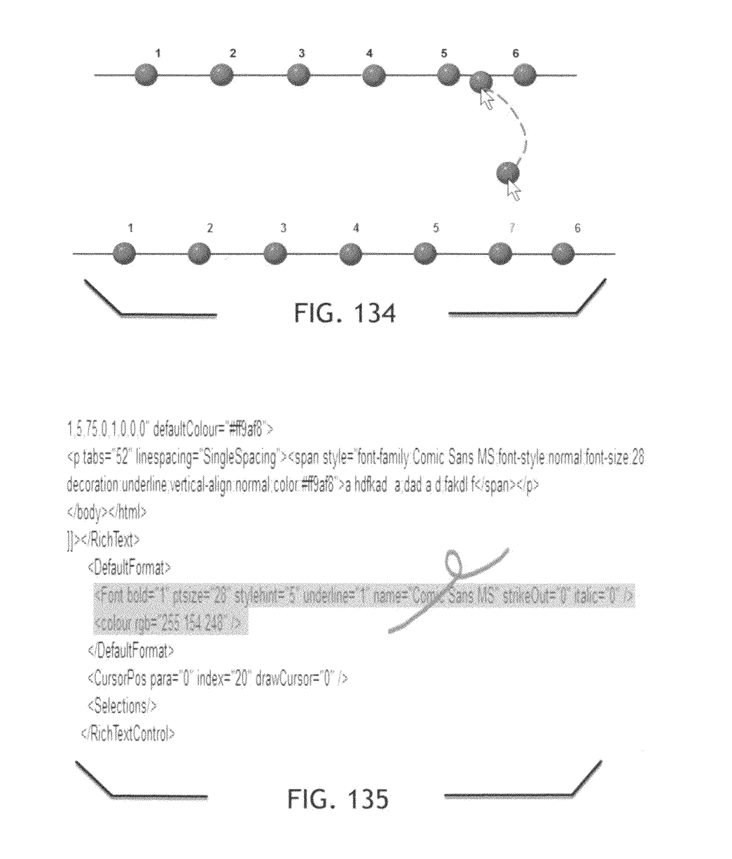

The user may also update a gesture line by adding segments to it. With regard to FIG. 134 and continuing with the green sphere segmented gesture line, it may be desirable to add one or more further segments to the line. A new sphere is shown being added to the line by dragging it to impinge on the line at the top. When the sphere impinges on the existing line, it is inserted at the point where it intersects the line. The insertion could occur upon a mouse upclick, or be an automatic operation, require a verbal command, e.g., “insert”, or any number of other actions. One possible result of such an insertion may be that the existing line is increased by one more audio segment and that the inserted segments have the same length line on each side of it as exists for each of the other green spheres in the original line. The augmented line is shown below in FIG. 134, and clearly has seven spheres rather than the six of the original gesture line.

The gestures environment also provides many methods of drawing to insert a segment into a gesture line. They indeed include all lines that embody a logic or convey an action as with gesture lines or arrows. For example, an insert arrow could be drawn from an object and then drawn to impinge on a point in a line style or gesture line. A line that does not convey an action or embody a logic could still be used to cause an insert by modifying the line on-the-fly. An example of an on-the-fly modification would be employing a verbal utterance (like “insert”) as the line is being drawn.

Likewise, a text object may be typed or otherwise created (i.e., by verbal means or by touching an object that activates a function or action or its equivalent). This text may then be dragged to impinge a line and that impinging will invoke the action conveyed by the text, like “insert.”

Another approach for creating a gesture object is to use one or more characters in software code to define one or more contexts or actions. In this approach, software code is presented in an environment such that it can be accessed by graphical means, like having it impinged by the drawing of a gesture programming line or arrow. As an example, one or more characters in software code would be impinged by the drawing a graphic, like a red arrow. Assuming the software code is used to define one or more actions, in this case the Action Stroke of the programming line for the creation of a gesture object would be drawn to impinge one or more characters in software code that define a desired action. Various lines of text or characters existing as software code would become the action object that defines one or more actions for a gesture line.

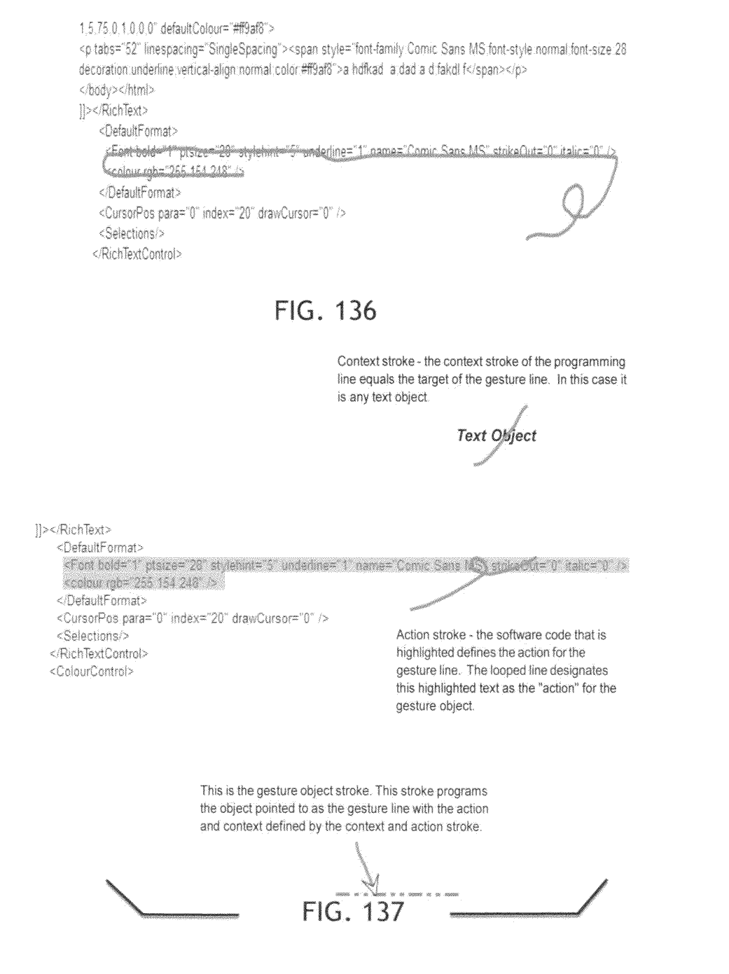

There are various ways of using graphical means to impinge on characters in source code. These include, but are not limited to, impinging text with a drawn line, highlighting text, encircling text and the like. With reference to FIG. 135, various lines of software code are presented in a VDACC. These lines of code may be presented as a text object sitting in Primary Blackspace or in any computer environment, like a desktop. An action stroke of a gesture object programming arrow has been drawn to impinge on a section of highlighted code text that defines a particular type of text style. In this case, it is bold, 28 point, underlined, comic Sans MS, non-italic text. This source code text defines the action for the gesture programming arrow and thus the action for the gesture object being programmed by the drawing of the gesture programming arrow. FIG. 136 also displays various lines of software code. Here characters in the software code have been intersected by a drawn line which ends as a loop, signifying that this is an action stroke for a gesture object programming arrow. The drawing of the line as shown in this Figure eliminates the need for highlighting source code text, as in the previous embodiment.

In FIG. 137 a listing of some software code is again displayed in a VDACC. These lines of code may be presented as a text object sitting in Primary Blackspace or in any computer environment, like a desktop. An action stroke of a gesture object programming arrow has been drawn to select a section of code that defines a particular type of text style. In this case, bold, 28 point, underlined, comic Sans MS, non-italic text. This text description will become the resulting action for drawing a gesture line to impinge any one or more text objects.

As illustrated in FIG. 138, the computer system for providing the computer environment in which the invention operates includes an input device 702, a microphone 704, a display device 706 and a processing device 708. Although these devices are shown as separate devices, two or more of these devices may be integrated together. The input device 702 allows a user to input commands into the system 700 to, for example, draw and manipulate one or more arrows. In an embodiment, the input device 702 includes a computer keyboard and a computer mouse. However, the input device 702 may be any type of electronic input device, such as buttons, dials, levers and/or switches on the processing device 708. Alternatively, the input device 702 may be part of the display device 706 as a touch-sensitive display that allows a user to input commands using a finger, a stylus or devices. The microphone 704 is used to input voice commands into the computer system 700. The display device 706 may be any type of a display device, such as those commonly found in personal computer systems, e.g., CRT monitors or LCD monitors.

The processing device 708 of the computer system 700 includes a disk drive 710, memory 712, a processor 714, an input interface 716, an audio interface 718 and a video driver 720. The processing device 708 further includes a Blackspace Operating System (OS) 722, which includes an arrow logic module 724. The Blackspace OS provide the computer operating environment in which arrow logics are used. The arrow logic module 724 performs operations associated with arrow logic as described herein. In an embodiment, the arrow logic module 724 is implemented as software. However, the arrow logic module 724 may be implemented in any combination of hardware, firmware and/or software.

The disk drive 710, the memory 712, the processor 714, the input interface 716, the audio interface 718 and the video driver 60 are components that are commonly found in personal computers. The disk drive 710 provides a means to input data and to install programs into the system 700 from an external computer readable storage medium. As an example, the disk drive 710 may a CD drive to read data contained therein. The memory 712 is a storage medium to store various data utilized by the computer system 700. The memory may be a hard disk drive, read-only memory (ROM) or other forms of memory. The processor 714 may be any type of digital signal processor that can run the Blackspace OS 722, including the arrow logic module 724. The input interface 716 provides an interface between the processor 714 and the input device 702. The audio interface 718 provides an interface between the processor 714 and the microphone 704 so that use can input audio or vocal commands. The video driver 720 drives the display device 706. In order to simplify the figure, additional components that are commonly found in a processing device of a personal computer system are not shown or described.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to-thereby enable others skilled in the art to best utilize the invention in various embodiments and with various modifications as suited to the particular purpose contemplated. It is intended that the scope of the invention be defined by the claims appended hereto.

1. A method for controlling computer operations by displaying graphic objects in a computer environment and entering user inputs to the computer environment through user interactions with graphic objects, the method comprising the following steps in no particular order:
displaying an object and drawing at least one action stroke to impinge on said object, said action stroke being definable to assign at least one action to a gesture object;
drawing a context stroke that can impart a context definition for said specific action assigned to said gesture object,
drawing a gesture object stroke having an arrowhead that points to a gesture target object, whereby said gesture target object becomes a gesture object having associated thereto said specific action and said context definition.

2. A method for controlling computer operations by displaying graphic objects in a computer environment and entering user inputs to the computer environment through user interactions with the graphic objects, the method comprising the following steps in no particular order:
displaying an object that conveys at least one action and drawing at least one action stroke to impinge on said object, said action stroke being definable to assign said at least one action to a gesture object;
drawing a context stroke to impinge on at least one further object that can impart at least one context definition to said at least one action assigned to said gesture object,
drawing a gesture object stroke having an arrowhead that points to a gesture target object, whereby said gesture target object becomes said gesture object having associated thereto said at least one action and said at least one context definition.

3. The method for controlling computer operations of claim 1, wherein said at least one action stroke includes an action graphic element recognized in the computer environment as designating an action stroke.

4. The method for controlling computer operations of claim 3, wherein said action graphic element comprises a shape formed in said action stroke.

5. The method for controlling computer operations of claim 2, wherein said shape comprises a loop formed in said action stroke.

6. The method for controlling computer operations of claim 2, wherein said action graphic element comprises a scribble “M” gesture formed in said action stroke.

7. The method for controlling computer operations of claim 1, wherein said gesture object stroke is drawn as a line extending toward said gesture target object, said line having a termination point adjacent to said gesture target object and having an arrowhead line extending from said termination point retrograde at an acute angle.

8. The method for controlling computer operations of claim 7, wherein said arrowhead line at the end of a stroke is a recognized graphic element that defines a gesture object stroke.

9. The method for controlling computer operations of claim 8 wherein said arrowhead line is replaced by a machine-rendered arrowhead when it is recognized, and a user touch on said machine-rendered arrowhead converts said gesture target object to said gesture object.

10. The method for controlling computer operations of claim 1, wherein said action stroke and said context stroke may be drawn to impinge on the same object.

11. The method for controlling computer operations of claim 1, further including the step of recalling said gesture object and imparting said specific action from said gesture object to a third displayed object.

12. The method for controlling computer operations of claim 9, wherein said imparting step includes dragging said gesture object to impinge on said third displayed object.

13. The method for controlling computer operations of claim 11, wherein said imparting step includes drawing an arrow from said gesture object to impinge on said third displayed object.

14. The method for controlling computer operations of claim 11 wherein said gesture object is a gesture line, whereby said gesture line imparts said specific action from said gesture line to said third displayed object.

15. The method for controlling computer operations of claim 14, wherein said gesture line comprises a complex line formed of a plurality of segments joined by line segments in contiguous fashion.

16. The method for controlling computer operations of claim 15 wherein each of said segments may be programmed to have an action and context assignment from said action stroke and context stroke.

17. The method for controlling computer operations of claim 16, wherein each of said segments may be programmed to display or play a digital content file selected from the group including: pictures, video, audio, text, media mixes, emails, network links.

18. The method for controlling computer operations of claim 16, wherein said gesture line may be drawn by a user to form any shape or path.

19. The method for controlling computer operations of claim 15, further including a personal tools VDACC for displaying a plurality of gesture lines, each having different actions and contexts, to enable a user to have quick access to many functions.

20. The method for controlling computer operations of claim 1, wherein said action stroke and context stroke and gesture object stroke are all portions of a continuous single line that includes a recognized graphic element incorporated therein between said action stroke portion, context stroke portion, and gesture object stroke portion.

21. The method for controlling computer operations of claim 1 wherein said gesture object is a data base gesture line having at least one database assigned thereto as an action.

22. The method for controlling computer operations of claim 21, wherein said database gesture line may be impinged on any other displayed object to transfer said database to said other displayed object.

23. The method for controlling computer operations of claim 1, wherein said gesture object comprises a folder display having a rectangular body portion for storing digital content and a tab portion extending from an upper edge of said rectangular portion.

24. The method for controlling computer operations of claim 23, wherein said tab portion includes an input portion for receiving an action to be programmed to be performed on said stored digital content of said body portion.

25. The method for controlling computer operations of claim 15, wherein said complex gesture line is assigned to a slide show, each slide of the show displayed in a respective one of said plurality of segments of said complex gesture line.

26. The method for controlling computer operations of claim 25, further including a user-drawn stitched action arrow having vertices each impinging on a selected segment of said complex gesture line to choose the slides associated with said selected segments for slide show viewing.

27. The method for controlling computer operations of claim 25, wherein a user may draw said slide show gesture line to circumscribe a play switch graphic object and invoke on/off control of the display of the slide show.

28. The method for controlling computer operations of claim 1, wherein said gesture object comprises a complex line formed of a plurality of segments joined by line segments in contiguous fashion, each of said segments comprising a control element that may be programmed to be an active audio/video control.

29. The method for controlling computer operations of claim 28, wherein said control element is selected from a group including: knobs, faders, pushbuttons, slide switches.

30. The method for controlling computer operations of claim 1, further including a selector object displayed in the computer environment, and a modifier arrow extending from said action stroke or context stroke to said selector object which is programmed to delay said specific action until a predetermined user input is received.

31. The method for controlling computer operations of claim 1, wherein said gesture object may be impinged on a programming code listing to do useful work on the listing.

32. The method for controlling computer operations of claim 1, wherein said gesture object includes an “inherited context” that is also programmed as part of the context for the gesture object.

33. The method for controlling computer operations of claim 1, wherein said gesture object can be drawn to impinge another object whereby said gesture object applies its action to said another object.

34. The method for controlling computer operations of claim 1, wherein said gesture object can be dragged to impinge another object whereby said. gesture object applies its action to said another object.
